(19) United States
(12) Patent Application Publication
(10) Pub. No.: US 2025/0234845 A1
(43) Pub. Date: Jul. 24, 2025

(54) SYSTEM FOR MONITORING AND RESEARCHING WELL-BEING OF LIFEFORMS USING TEXT ANALYTICS, AND TEACHING TOOL

(71) Applicants: Christopher Leslie Persaud, Winnetka, CA (US); Gwenevere Persaud, Winnetka, CA (US); Glenda Zuniga, Oxnard, CA (US)

(72) Inventors: Christopher Leslie Persaud, Winnetka, CA (US); Gwenevere Persaud, Winnetka, CA (US); Glenda Zuniga, Oxnard, CA (US)

(21) Appl. No.: 18/418,224

(22) Filed: Jan. 20, 2024

(51) Int. Cl. A01K 1/03

(52) U.S. Cl. CPC A01K 63/003; A01K 29/005; A01K 74/00

(57) ABSTRACT

The invention builds on the previous inventions of one of the inventors herein and includes a group of habitats connected to online databases and programs, where data from the habitats is used to update the databases and programs about the best conditions for the creatures, plants, and possibly other lifeforms inside the habitats. The invention also includes systems for helping students and others to learn, by examining the actions and well-being of the lifeforms inside a habitat, and writing research notes about those lifeforms. The invention also includes methods and systems by which research notes about a certain species, from many students or other observers, can be examined with text analysis tools, which will locate words or phrases that are common, and other information, within the research notes. This will help to discover the optimal ranges for measured parameters like temperature and Ph for the species inside the container.

### DESCRIPTION OF THE RELATED ART

This application claims priority to U.S. Nonprovisional application Ser. No. 16/995,797, filed Aug. 17, 2020, and which is hereby incorporated by reference in its entirety.

### WIRELESS CHARGING

In inductive charging, power is transferred, using electromagnetic induction between two devices that are not physically connected. Embodiments of the present invention allow for charging ports on the container ball (6), container connection device (5), handle, sectioned container (28), pocket ecosystem (25) and other locations, to receive power from nearby wireless stations, and use this power to charge any batteries located in the container, container connection device, or handle, or elsewhere in the apparatus. For example, each charging port can contain an induction coil that absorbs power from a magnetic field created by a second induction coil in a wireless charging station.

The mechanics of “Resonant inductive coupling”, which increases the range of wireless transmission, are also known in the prior art. The charging ports (20) in the invention can use resonant inductive coupling to receive electrical charge from charging stations over a longer distance. For example, a wireless charging port in the handle can be connected directly to a battery in the handle, and also connected to the main wire group, and indirectly connected, via the main wire group, with batteries located in an attached container connection device and container, which feed power to processors located in the container connection device and container, respectively.

All methods of wireless electrical charging known in the prior art can be used with the wireless charging ports of the present invention.

Some embodiments of the invention use “USB type C” charging ports as the charging ports (20). However, any component of the invention that uses an open USB type C charging port should not be immersed in water, which might damage the charging port. Therefore, embodiments that use an open “USB type C” charging port will have limited utility. Other embodiments of the apparatus will use a USB type “B” charging port, or another one of the charging ports known in the prior art. In some embodiments, the charging port will be covered by a cover which will keep water out, and which can be opened or closed. This protects the charging port from water damage. Versions of the invention using USB type “C” or type “B” charging ports, for example, might have this feature.

A combination of different types of charging ports, such as USB type “C” charging ports in some components and a USB type “B” charging port in one or more other components, is also possible. All types of electrical charging ports known in the prior art can be used as the charging ports of the present invention.

For this application's purposes, a user ID will be a unique ID assigned to a user. A container ID will be a unique ID assigned to a container, such as a container ball, sectioned container, or pocket ecosystem. A group ID will be a unique ID assigned to a group of users, or group of groups of users. A “group leader” will be a person who has power to manage a group of users. At a minimum, the group leader will have access to the user ID of each member of the group, the container ID of each container ball, sectioned container, pocket ecosystem, or other container about which any group member is sending online reports (26), the location of each PC (30) being used by a group member to send an online report (26) at the time that online report was submitted, and the location of each pocket ecosystem or other container, that was the subject of an online report (26), at the time that this online report (26) was submitted. For example, a teacher can be considered a “group leader” for a class of students, who would be the group of users. A sensor ID in some embodiments will be a unique ID assigned to a parameter influencer or detector. The sensor IDs, group IDs, user IDs, and container IDs can take any form known in the prior art, including, but not limited to, serial numbers or QR codes.

For this application's purposes, a lifeform type's “name” in some embodiments can be the lifeform type's scientific name (if the lifeform type is a species), common name, or another unique identifier for the lifeform type.

### SUMMARY OF THE INVENTION

The invention comprises a group of related apparatus and computer programs and methods that operate in tandem with the apparatus, and analyze results obtained with the apparatus. The handle in some embodiments also includes electronic components, such as the cord control and a container control. The handle can include controls for other components in embodiments which include other components that require controls. These controls do not need to be electronic in nature, but preferably should be.

In embodiments of the apparatus with multiple processors (19), those processors can communicate with each other by every method known in the prior art, unless otherwise specified.

Care should be taken that all parts of each apparatus embodying the invention, where it is necessary for the part to be waterproof to protect the part, the user, or the environment, should be waterproof or surrounded by a waterproof covering. Likewise, all parts of each apparatus embodying the invention, where electricity leaking from the part into the surroundings will be detrimental, should be electrically insulated.

The drawings of this patent application will show handles, long rods, main wire groups, external reels, container connection devices, control panels, sectioned containers, pocket ecosystems, container balls, and other physical components of a certain size, relative to the other components of the invention, but versions of the invention, including the embodiments herein, will function effectively if those components have a different size, relative to other components of the invention, than those portrayed herein. For example, an embodiment of the invention could include a main wire group and/or a long rod much longer than those portrayed herein.

The long rod (2) and the handle (1) should preferably be comprised of plastic, or another substance which does not conduct electricity and does not allow water to penetrate to the electric and electronic components of the invention.

Every component within the invention that is supposed to hold lifeforms can contain multiple lifeforms of multiple species at the same time.

The light (9) mentioned herein should be a small, waterproof, light.

It is important to note that multiple components of computer programs that are not shown in the drawings as being run on the same PC (30) can be run on the same PC (30). For example, the viewing interface (37), the faraway program (11) and the note-taking app (31) can be run on the same PC (30). In principle, the viewing interface (37), the faraway program (11) and the note-taking app (31) can all be part of the same program. The viewing interface (37) can also be combined with the faraway program (II)'s viewing interface.

### Term Numbers

These components are discussed in a previous patent application to which this application claims priority.

Handle (1). Long rod (2). Main wire group (3). External reel (4). Container connection device (5) Container ball (6). Control panel (7). Wire holding rings (8). Light (9). Detector (10). Faraway Program (11). Parameter influencer (12). Battery (13). Solar cell (14). Food compartment (15). Receiver (16). Transmitter (17). Linking mechanism (18). Processor (19). Charging port (20). Container ball latch (21).

Other components discussed in this application are the below.

Alert light (24). Pocket ecosystem (25). Online Report (26). Sectioned container (28). Container balls are a variation of sectioned containers. Language processing module (29). PC (30). Note-taking app (31). Research processing module (32). Research corpus (33). Artificial neural network (34). Artificial neuron (35). Statistical investigation module (36). Viewing interface (37). Automatic report (38). Container latch (39). Subsidiary corpus (41). Local statistical investigation module (44). Local language processing module (45). Central observation collection (46). Local observation collection (47). Memory (48). Auto-sensor (49). Central comparison module (50). Central lifeform database (51). Nutrient balancing hole (53).

A lifeform, for purposes of this application, is a living thing. For example, animals and bacteria count as lifeforms. Animals would also be “creatures”.

Container balls are a subset of sectioned containers, described below. Sectioned containers are a subset of containers, also described below. A container is a hollow vessel comprising an interior space configured to contain at least one lifeform and a covering creating a continuous wall surrounding the interior space. A sectioned container is a hollow container comprising an interior space configured to contain at least one lifeform and a covering creating a continuous wall surrounding the interior space, said covering defined by moveable sections connected to each other in at least one location. The moveable sections are why the sectioned container is called a “sectioned container”.

An idea behind this application is that it is possible to keep small creatures and other lifeforms alive in a container that is operationally connected to a computer program that receives information about the conditions inside that container directly or indirectly from the measured parameter detectors inside that container. This can be improved if the computer program also can influence the conditions inside the container through parameter influencers (12) that influence the values of measured parameters inside the container. It can further be improved if the computer program has information about the species of the lifeforms located inside the container, and the optimal and tolerance values for that species. And it can be improved even more if the computer program has access to information (preferably being received in real time) from the detectors located inside a large number of containers, so that the computer program can use statistical analysis to determine what the optimal and tolerance values for lifeforms of a certain species or strain based on the information the computer program has received (Or is receiving) about the optimal and tolerance levels of measured parameters in which lifeforms of that species or strain survive better, or be more active, or perform better according to some other decision criterion.

People can potentially carry with them the “detachable” container balls and other “detachable” sectioned containers and other containers. Thus, it is possible, for example, to have a necklace with a sectioned container that has a living plant, or a living fish, or group of tadpoles or frog eggs, inside. A receiver within this sectioned container would be in operative communication with a program module connected to a central database, or a program module connected to a database that is part of a specific user's faraway program, that will tell the measured parameter influencers that influence the measured parameters in the sectioned container about how to create the best conditions for the lifeform(s) inside the sectioned container.

Gwenevere Persaud, one of the inventors herein, would like to thank her mother, Paloma Rodriguez, and her father, Christopher Persaud, for supporting her throughout the application processes for the application to which this application claims priority.

The inventors herein want to thank Professor Alex Tuzhilin of New York University's Stern School of Business for his lectures on artificial intelligence, in particular about the structure and functioning of artificial neural networks, and some important concepts concerning text analysis, and Professor Foster Provost, also of New York University's Stern School of Business, and Tom Fawcett, Ph.D. for their authorship of the book “Data Science for Business”, which provided further information about the concepts of text analysis. The inventors also want to thank Professor ChengXiang Zhai, author of a YouTube series entitled “Text Mining and Analytics”, for his explanations of various text analytics concepts.

The inventors would like to thank Canterbury Elementary and Sutter Middle School, California State University Northridge (CSUN) and California State University, Los Angeles, (CSULA), University of Miami Herbert Business School, Ave Maria Law School, and New York University Stern School of Business for the prior art ideas that the inventors learned there.

The COVID-19 pandemic has created a need for students to continue education at home, when they would previously have been able to do the same education at school. Even when in-person school has resumed, student absenteeism is higher than it was before.

There is also a youth mental health crisis in the U.S., and possibly other countries. The youth mental health crisis will be somewhat reduced if young people feel they are a part of something “important”, which is “larger than themselves”, especially something which helps preserve Earth's biodiversity or helps species to survive climate change. The present invention helps young people who participate in crowd-science programs related to the invention to feel this way, and to be a part of something “important” which is larger than themselves. Humanity needs more information about the conditions that species, especially aquatic species, need to survive, so that we can plan effective conservation measures to keep these species (especially rare or endangered species) alive, preferably at minimal cost to humanity.

An idea behind this application is that students and others can take kits home, including one or more lifeforms and a container with measured parameter influencers (12) and/or detectors, and then place the lifeforms inside the container and take notes about the lifeforms and therefore learn about them, and the students can then improve their scientific skills. A related idea is that the students or others can send the notes over the internet to their teachers, or to a centralized research corpus, or both.

Another idea behind this application is that students or others can catch creatures or other lifeforms, put them in one or more of the containers discussed in the paragraph above, and then monitor the lifeforms' wellbeing, behavior, or other characteristics of the lifeforms, and take notes about them and send the notes to their teachers or to a centralized research corpus, or both. The students or others could also monitor how the lifeforms react to changes in the values of the measured parameters. The notes can be placed into programs, such as “apps” on the students' phones, that automatically send the notes to the centralized research corpus.

This invention also seeks to reduce the costs of certain types of research.

The researchers do not need to be students; They can be researchers of another type. Researchers of any type may work to observe a plurality of containers, such as pocket ecosystems (25) and take notes on the lifeforms in them, to learn about those lifeforms' species, and then forward the notes to a research corpus, so that text analysis can be performed on the research corpus. This is a relatively cost-effective way of prospectively learning about how changes in conditions affect species, as opposed to retrospectively learning about how changes in conditions affect them in the wild, after conditions in their native environments have already changed. Climate change is one such change in conditions.

It is important to note that an “apparatus” for this application's purposes, does not need to only be the assembly involving a main wire group and long rod seen in some drawings. The term “apparatus” can include other things as well, including assemblies that do not include a main wire group or long rod.

The sectioned container or other containers of the present invention can be closed to allow the user to catch wild fish or other aquatic creatures, or land creatures, without harming them, which is useful to a person trying to harvest living wild fish to display in an aquarium. It can also be useful to enthusiasts trying to capture other aquatic creatures, such as tadpoles, without harming them, or to move fish eggs, amphibian eggs, or the eggs of other aquatic or semiaquatic creatures without harming the eggs. The sectioned container or other container of the present invention can also be used to capture land creatures or other lifeforms via waiting till a lifeform is inside a sectioned container or other container and then closing the sectioned container or other container.

The invention can also be used to learn more about how lifeforms react to changes in measured parameter values (See below) by observing the lifeforms without hurting them.

How a lifeform type is affected by measured parameter value changes might be a complicated question, and might be affected by many factors such as how the lifeform type's metabolism changes, and how the lifeform type may or may not become more vulnerable to diseases. These factors might also be interrelated. The invention can be used to examine many questions about lifeform types, to better understand these complicated questions.

### More Information about Measured Parameters

The “value” of a measured parameter is the amount of that measured parameter. For example, 770 mm Hg and 750 mm Hg are “values” of air pressure, and 30 degrees Celsius and 71 degrees Fahrenheit are “values” of temperature. The invention will work with both the Celsius and Fahrenheit temperature scales.

Measured parameters include, but are not limited to, temperature, salinity, Ph, fluoridation concentration, oxygen concentration, and nitrate and nitrite levels. Other measured parameters for which detectors can be included in some embodiments of the invention are water pressure, air pressure, humidity in air, concentration of various minerals including, but not limited to, magnesium and iron, calcium, phosphorus, zinc, copper, manganese, iodine, and selenium, sodium and cadmium in water, oxygen concentration in air, CO₂ concentration in air, concentration of other gases in air, concentration of pollutant compounds, concentration of various organic compounds, and light absorption (Which may be a proxy for presence of plankton in water, and can be determined by comparing the amounts of light detected by light detectors at different points in a sectioned container or other container. The difference in amount of light detected is a proxy for the amount of light absorbed by the substances between the two light detectors). For example, some specific compounds' concentrations can be measured parameters that are taken as an indication of a higher possibility that a disease-causing organism or parasite is present in specific species. Note that such a compound can show a disease-causing organism or parasite is clearly present, or can simply be correlated, with or without causation, with the parasite or disease-causing organism's presence, such as a situation where presence of a certain easy-to-detect compound is associated with a 30% chance of a parasite being present but the parasite does not cause the compound's presence, or vice versa. Some specific compounds' concentration can be measured parameters that are taken as indications that water in a sectioned container or other container needs to be changed, or that a sectioned container or other container needs to be cleaned or otherwise maintained.

Detectors for other measured parameters can be included in other embodiments of the invention. Measured parameters are a subset of “conditions”.

For every measured parameter, the range for that measured parameter in which a lifeform type can live is called the tolerance range, and the smaller range, the optimal range for that measured parameter, for that lifeform type, is the part of the tolerance range that is optimal for that lifeform type. A lifeform type, for this application's purposes, will, in most cases, be a species, but can also be a subgroup within a species. In some embodiments, “lifeform types” will include groups of species and individual species. For example, a certain fish species may need water in the range of 24-32 degrees C. (the tolerance range), but may prefer water in the range of 28-31 degrees C. (the optimal range). The phrase “optimal or tolerance” range(s) or level(s) means either the optimal or tolerance range(s) or levels, respectively. For example, if a measured parameter's value is outside a lifeform type's optimal or tolerance range, it is either outside the optimal range or outside the tolerance range for that lifeform type. Likewise, the phrases “optimal, goal, or tolerance”, “optimal, tolerance, or goal”, or “goal, optimal, or tolerance” range(s) or level(s) mean any of the goal, optimal, or tolerance ranges or levels, respectively.

For this application's purposes, a “combination” of measured parameter values, or measured parameter value combination, or group of measured parameter values or measured parameter value group, means a value of one measured parameter, simultaneously happening, with a value of one or more other measured parameters. For example, a “combination” of measured parameter values could be a temperature level of 35 degrees C. and a salinity level of 30 g/L happening at the same time in the same container.

Likewise, a combination of measured parameter value ranges, or measured parameter value range combination, or group of measured parameter value ranges, or measured parameter value range group, would be a range of values of one measured parameter, simultaneously happening, with ranges of values of one or more other measured parameters. A measured parameter value combination or measured parameter value range combination does not need to include values or ranges, respectively, for every measured parameter.

In other embodiments a measured parameter value range combination that is correlated to specific actions, traits, or behavior by a lifeform type within the container(s), or correlated to other results the user desires, is saved within the lifeform database. This range combination will be called a “goal range combination” or “combination of goal ranges” in this application. Each measured parameter value range within the “goal range combination” will be called a “goal range”. The “goal” is the result the user desires. Each lifeform type can have multiple goal ranges and goal range combinations for different user goals. The upper and lower bounds of a goal range are called “goal levels” herein. Each goal range, for a measured parameter for a lifeform type would be equal to, or a subset of, the tolerance range for that measured parameter for that lifeform type. It may not be the same as, or within, the optimal range for that lifeform type. The user may desire to keep the measured parameter values in one of the sectioned containers or other containers within one of a lifeform type's goal ranges, to encourage desired goals like desired behavior by the lifeform type. For example, the user may want to encourage individuals of the lifeform type to breed more often, so the user may want to keep the measured parameter values in a container containing individuals of that lifeform type in a narrow range that mimic the time of year when the lifeform type breeds the most, or mimics the lifeform type's ideal conditions for breeding. The comparison module can be commanded by the user, using the viewing interface (37), or by another method, to retrieve one of these goal range combinations from the lifeform database (Including, but not limited to, a central lifeform database). Then, when one of the measured parameter values in a sectioned container or other container in communication with that comparison module moves out of the goal range, the comparison module will send a command to the parameter influencer in the relevant sectioned container or other container that controls that measured parameter, to move the measured parameter back into the goal range.

The user may wish to keep the measured parameter values in a sectioned container or other container within a goal range combination for many other reasons. For example, the user may wish to help juvenile survival, by, for example, keeping measured parameter values in a sectioned container in a goal range combination that is exceptionally good for juvenile members of a lifeform type, or good for them to attach to rocks, or otherwise better for them.

A user may also keep the measured parameter values in a sectioned container or other container within a goal range combination that is within the tolerance range for a lifeform type but bad for one or more types of parasites or diseases for that lifeform type, or bad for transmission of one or more types of parasites or diseases for that lifeform type.

For example, chytrid fungus infection has decimated hundreds of amphibian species worldwide. A user keeping members of a toad species in a sectioned container or other container may keep the measured parameter values therein within a combination of goal ranges that are all within the tolerance ranges for the toad species, but which, in combination, reduce amphibian mortality from chytrid fungus infection (either directly, or indirectly, such as reducing transmissibility of the infection), so that the members of the toad species in the sectioned container or other container do not die of chytrid fungus.

Such a method may also be useful for combatting disease organisms or parasites that may have spread further because of climate change. A user may keep the measured parameter values in a sectioned container or other container within a goal range combination that is within the tolerance ranges for a lifeform type but bad for one or more types of parasites or diseases for that lifeform type, where the parasites or diseases have been spread further by climate change.

In some cases, a user may mathematically conclude that the benefits from keeping away disease or parasites outweigh negative effects on a group of organisms from being kept in measured parameter values within a goal range combination that differs from the optimal range combination for the organisms' lifeform type. For example, there could be a scenario where diseases “normally” kill 20% of an aquacultured clam population, so the user uses the invention to keep conditions for the aquacultured clam population in a goal range combination that reduces disease transmission and disease-caused loss is reduced to 2%. However, the clams grow to an average of 95% of the weight they would if they were kept in the optimal range combination. The 18% gain in percentage of clams that survived, from lack of disease, likely more than compensates for the 5% decrease in average clam weight, from the user's viewpoint.

Likewise, a user may mathematically conclude that other benefits from keeping organisms in measured parameter values in a goal range combination outweigh negative effects from keeping the organisms in measured parameter values in the goal range combination.

Not every sectioned container or other container will include a detector for every measured parameter, or a parameter influencer that can influence every measured parameter. This application should be read with the understanding that when a program or other component is described as directly or indirectly receiving information about measured parameter values from detectors, the program only receives information about those measured parameter values that the detectors with which the program or other component is communicating are able to detect. Likewise, when a user or program is described as commanding a parameter influencer to change a measured parameter's value, in a container, the user or program only commands a parameter influencer that influences that specific measured parameter to influence that measured parameter, and the user or program does not make the command if there is no parameter influencer that influences that specific measured parameter in the container in question.

If goal ranges for a lifeform type exist, and have been saved in a user's lifeform database, or the central lifeform database, the comparison module or central comparison module (whichever is being used) will ignore any goal range unless commanded or programmed to use the goal range. For example, in some embodiments, the user can input a command to use a goal range into the faraway program's user interface. In some embodiments, the central comparison module can be programmed to use a goal range once it has discovered that goal range.

A measured parameter value combination does not need to include a value for every measured parameter.

Every container will not necessarily have a detector for each measured parameter, or a parameter influencer for each measured parameter. If a container does not include a detector for a measured parameter, that measured parameter simply will not be detected in that container, and information about that measured parameter's value will not be sent out from that container. Likewise, if a container does not include a parameter influencer for a measured parameter, that measured parameter will not be influenced.

Many lifeform types may presently inhabit measured parameter ranges combination in their natural habitats, but may be capable of inhabiting wider measured parameter ranges (The tolerance ranges). If one of the measured parameters moves out of a lifeform type's tolerance range in an area that the lifeform types inhabits, the individuals of the lifeform type will suffer, and perhaps go extinct in that area. However, in many cases, humans do not know about a lifeform type's tolerance ranges (Ranges in which the lifeform type can live). Humans might know, at most, about the measured parameter ranges where the lifeform types does live, and often, not even that. If climate change or other factors cause the naturally occurring range of a measured parameter in an area where a lifeform type lives to move out of that lifeform type's tolerance range, this can lead to population decrease or extinction for that lifeform type. Therefore, humans should learn about the tolerance ranges of difference lifeform types, to understand how they might be impacted, and perhaps driven into extinction, if measured parameter ranges such as the temperature range change in the lifeform types' natural environments.

The optimal measured parameter ranges for a lifeform type might be different from the measured parameter ranges where the lifeform type lives in the wild now. The lifeform type may live in the area where it happened to evolve, but the measured parameter range combinations prevalent in the area where a lifeform type evolved may not be the “best” measured parameter range combinations for that lifeform type. The present invention helps us to discover the optimal measured parameter range combinations for a lifeform type.

### Text Analysis

The conditions which help a species to survive best are not always obvious, because all living species are complex. Therefore, it is often unclear how a change in conditions such as humidity and temperature will affect a species' survival, or survival at different stages of its lifespan. Many species have specific ranges of conditions which they can tolerate, or which are optimal for them. These conditions can limit a species' range of habitats. A change in conditions can also affect a species in other ways that indirectly impact its survival. For example, the time of year that a frog species' eggs will hatch might indirectly impact that frog species' survival. Large animal species such as dolphins in the ocean or river dolphins in rivers might also directly or indirectly be impacted by the health and survival of smaller animal species, or non-animal species. Humanity needs to better understand the effects of climate change, and the effects of changes in conditions more generally, such as changes in humidity, on the many species that inhabit Earth, and, if possible, be able to quantify those effects so we can decide on the best solutions.

Humanity will also benefit by being able to calculate, and quantify, the effects of specific actions, such as specific development projects, on organisms in and near the area where a project is taking place.

Local and global climates also change naturally, in addition to current or future human-caused climate change, so humans should be prepared to help species survive climate change, by knowing how the species respond to changes in conditions such as temperature and humidity. Even if humanity somehow eliminates any present human-caused climate change, the issue of future natural climate change, and its impact on species and ecosystems, will simply never go away. Humanity must therefore be prepared to help Earth's other species to survive climate change, whatever the cause, and also as more insurance for ourselves against ecological collapse.

Text analysis is the process of sorting and analyzing data contained in text for research purposes.

A Corpus is the complete body of documents the user would use as inputs for a given natural language or text analysis application.

Text analysis, combined with observation, can help us to discover some of the ways a measured parameter value change will affect a lifeform type. Text analysis is the automated process of understanding and sorting unstructured text, making it easier to manage. Text analysis tools, are often used to unearth valuable insights in social media conversations, survey responses, online reviews, and more. Text analysis can also be particularly useful here because the written description of the issues a species faces may vary significantly between species, or have a big variety even for one species. For example, there can be many important issues related to the growth of a fish species, such as how quickly the fish mature, how fast they grow, their color, and how energetic they are, and others. Different issues will have different written descriptions, and observers may create new written descriptions of some issues. A larger variety of written descriptions of issues facing a species means a larger variety of observations about those issues, including possibly answers to questions that nobody knew needed to be asked. Text analysis can help to sort through a large body of such observations.

Once a “machine”, or computer model, has enough examples of tagged text to work with, algorithms are able to start differentiating and making associations between pieces of text, and can even sometimes begin to make predictions. Some techniques of text analysis include collocation, word frequency analysis, and concordance.

Word frequency analyzes the frequency of words within a body of text.

Tagged text, for data analysis purposes, is text for which tags or annotations have been added, as a step in preparing such data for analysis.

Collocation is the habitual juxtaposition of a particular word with another word or words with a frequency greater than chance. Collocation identifies words that commonly co-occur.

Collocation can be helpful to identify hidden semantic structures and improve the granularity of insights by counting bigrams and trigrams as one word. Bigrams are pairs of consecutive written units such as letters, syllables, or words. Trigrams are groups of three consecutive written units such as letters, syllables, or words. Collocation can also be useful, in the present invention, as a technique to detect words that commonly occur together in notes. For example, “green insect” is a bigram that might be relevant to a student who is studying a group of insects, and how in measured parameter value changes affects them. “Dead insect” might be another relevant bigram. “Flying ladybug” might be a relevant bigram to a student studying a group of lifeforms that includes ladybugs.

An n-gram is a group of “n” words. For example, a bigram is a group of two words.

Concordance helps identify the context and instances of words or sets of words. A concordance is a list of all words in a document along with how many times each word occurred in the document.

One of the ideas behind this application is that text analysis programs can be used to determine the best ways to care for small creatures and other lifeforms in a container ball or other container through using techniques such as collocation, concordance, and text analysis to detect patterns within a large body of notes collected by researchers such as students and forwarded to a central research corpus. The language processing module (29) can perform these analyses on the material in the online reports (26) in the research corpus. Statistical analysis of various kinds can be used to determine things like when the lifeforms are more active, the particularly measured parameter ranges that cause them to be more active, that cause them to survive longer, grow bigger, or to behave differently. The lifeforms can be categorized by species or otherwise.

This invention can be useful in deciding what is the best way to care for members of a species, such as a newly discovered species. In many cases, the best ways to care for newly discovered species, and for members of those species in different stages of life (Such as tadpoles in the case of many specialized frog species) can potentially be discovered using this invention.

This invention can also be used to save endangered species, and prevent their extinction, by providing habitats for them, where the measured parameters in the habitats are monitored and kept within ranges in which the specific endangered species can survive, or can breed better (Thus hopefully producing more juveniles or juveniles that survive better) or can do other things better. The present invention can also be used to discover the conditions or measured parameter range combinations which are best for the endangered species to survive. In some cases, the present invention can help to overcome problems associated with lack of money or time to find the conditions or measured parameter range combinations that are best for an endangered species to survive. This is especially useful in situations where a species' physical environment has been destroyed or reduced (Such as species that might live in areas of the Amazon rainforest that have been targeted for development, or axolotls in Mexico).

The present invention can also help species with natural areas of habitation that are physically small, such as a moss species that might live on trunks of a specific tree species, which itself only lives on a few specific mountains. The present invention can help these species by, essentially, providing additional areas for them to live, where measured parameter values match those of their native areas, or where measured parameter values are such that the species find optimal or can tolerate, thus expanding these species' total areas of habitation. The additional areas for the species to live are the sectioned containers, pocket ecosystems, and other containers where members of the species have been placed.

For example, the “Lord Howe Island Stick Insect”, which existed on a few volcanic islands in the Tasman Sea, was thought to have been driven into extinction by invasive plants and predators. A few Lord Howe Island Stick Insects were rediscovered in 2001 on a small, uninhabited island called Ball's Pyramid. Their habitats are limited to Ball's Pyramid, and to a few zoos where they are being bred. The present invention can provide additional habitats for Lord Howe Island Stick Insects, with the right measured parameter values for them to survive and be healthy, and which are not dependent on zoo funding.

The present invention can also provide additional areas of habitation for lifeform types with original habitation areas that have become uninhabitable to them, because of conditions in their original habitation areas changing. For example, if a lifeform type's original habitation area became too hot because of global warming, or new diseases or parasites entered the lifeform type's original habitation area because of global warming, reducing the lifeform type's population, the present invention can provide additional habitation areas where measured parameter values are controlled so that the lifeform type can survive and avoid extinction.

The present invention provides a lot of “small” environments (pocket ecosystems, sectioned containers, and other containers), some of which will have different conditions, and documents how the species reacts to measured parameter value changes in those small environments. The “small” environments are funded by the individuals, school districts, etc. that purchase them. By finding out how the species reacts to the measured parameter values in those small environments, we can find out which measured parameter values the species reacts to in the best way. These would be the measured parameter values that are best for the endangered species to survive. Then, we can provide one or more pocket ecosystems, or containers of another kind, where conditions are optimized for the species to survive.

Another idea behind this invention is that crowd-science can provide useful scientific information and, separately, can also show researchers areas where more formalized scientific studies can be helpful. For example, if crowd-science documents an unexpected effect, then perhaps a more formalized scientific study of this unexpected effect should be made. The present invention can therefore provide direction to which formalized scientific studies should be made, and funded. Results from the present invention can also be used by researchers to provide arguments for funding of more formalized scientific research.

A related idea is that this invention can be used to gather a large amount of research notes, from many individual researchers, about different species. These research notes can then be analyzed for more information about these species. It is important to create a lot of reports, with a lot of researchers, to create a large corpus of reports to perform text analysis and measure the impact of environmental changes upon species.

This invention can also provide specially optimized habitats for members of endangered species, so that, for example a species which has a very specialized habitat in nature can be given more habitat, in sectioned containers, pocket ecosystems, or other containers, that are optimized with the measured parameter values best for that species.

Another idea behind this invention is that by using word-vectors, we can learn about what words go together and find instances where positive words in online reports occur with reference to members of a species. Then, we can find what conditions, such as measured parameter values, correlate to these positive words. This will help us to learn the conditions that are best for that species, or best for it to do certain things (For example, the conditions that are best for a species to lay eggs may be different from the conditions that are best for that species in general).

Use of word-vectors is also useful because a species might act in many different ways, and it is important to get a complete picture of the species' activities in different combinations of measured parameter values, so as to note important information about those activities. What constitutes a “good” or “bad” action for a species may not always be obvious, and so it is important to describe as many of the species' behaviors as possible in notes.

If there are members of more than one species inside a pocket ecosystem or other container, then this might make reporting about these species more difficult, because conditions that are good for one species may be bad for another species. This is another reason why analyzing a large corpus of notes would be helpful in overcoming this issue to some degree and learning how measured parameter changes affect different species.

Word vectors, or word embeddings, or vector-space embeddings, capture info about word meaning and location. They can be used here to find information about what words are often used together, for example, “The fish always swims upward at 3 PM”.

When creating word vectors, we would want to assign each word within the corpus being analyzed to a particular meaningful location in multidimensional space called a vector space.

Each target word is relevant to the words around it, its context words. As target words shift, context words shift. The context words' order is irrelevant. Words that tend to appear in similar contexts are gradually assigned to similar locations in vector space.

Common misspellings of a given word, and synonyms, should have nearly identical context words and therefore nearly identical locations in vector space.

One way to find words' locations in vector space is to place each word at random in latent space. Then, for each target word, find its contexts and estimate the word's new location based on its context words. Then, repeat this process until convergence.

Movements that represent relative particular meanings between words are an efficient way for relevant word information to be stored in the vector space.

Using the concept of a latent space, we can draw conclusions about combinations of measured parameter values that are likely to be “good” for a lifeform type using a process based on arithmetic: For example, we might conclude based on initial data that low temperature+a specific salinity level=good conditions for survival of a certain fish species. We may then choose to focus our efforts to find which measured parameter values are really good for the fish species on measured parameter values around that temperature and salinity level.

Tokenization is use of characters like periods, commas, and spaces to assume where one word ends and another word begins. Tokenization helps with text analysis.

There can be multiple species in each of the pocket ecosystems (25) or other containers, and the users, such as students, may describe the behavior and characteristics of each of the species. The users may also describe the species' behavior and characteristics in a complicated fashion (For example, explaining how a species of fish guards its eggs, which may affect chances of those eggs' survival). The users will be describing more complicated things than whether a lifeform is alive or dead; users will also be writing about the lifeform's wellbeing and possibly behavior. This is why use of vector-related text analysis techniques, and other text analysis techniques, is useful to analyze the data that the users are providing.

This is also a reason why large numbers of human observers are useful, regarding the current invention. Human observers can observe things such as animal behaviors that might not be as easily detectable or understandable by remote sensors.

Human observers can also observe lifeforms in a sectioned container, pocket ecosystem, or other container, without disturbing or damaging the lifeforms, which can be important for learning more about the lifeforms.

Natural language applications can also be used to determine patterns within data. Here, the natural language applications would be used to determine how best to care for lifeforms, their behavior, and other characteristics of those lifeforms.

Every text analysis technique discussed herein that works when a lifeform type's name is a single word will also work when the lifeform type's name is two words (Such as the scientific name), or more than two words. For example, the 5 “context words” on both sides of the lifeform type's name, when Continuous Bag of Words is used, would be the five words before the first word of the lifeform type's name, and the five words after the lifeform type's name. In every case herein where a lifeform type's name is listed as a “word”, the lifeform type's name can also be multiple words. Likewise, an n-gram including the word(s) in a lifeform type's name can include all the words in the lifeform type's name plus whatever other words are needed to reach the total of “n” words in the n-gram.

Likewise, all the text analysis techniques discussed herein that work when a lifeform type's name is used as the identifier for that lifeform type will also work when another type of identifier, also composed of letters, symbols or numbers, is used for the lifeform type, instead of the name. For example, the text analysis techniques discussed herein will work with a species if the species' scientific name is used to identify it, or another identifier such as “X” where X is a number.

An alert light (24) is a light that flashes when something goes sufficiently wrong with the pocket ecosystem or other container (sectioned or otherwise) to which the alert light is operatively connected. In most embodiments, the alert light (24) will flash when one of the measured parameters in the pocket ecosystem or other container has varied sufficiently from the tolerance levels for one of the species within the pocket ecosystem that the members of that species within the pocket ecosystem or other container are in danger of dying, and/or that the members of one of the species within the pocket ecosystem or other container have not been given nutrition within a recommended period of time, and/or have not been taken care of, in another required way, within a recommended period of time.

### More Information about the Components

The alert light (24) does not need to be physically connected to the pocket ecosystem or other container. The alert light can be located somewhere else, and can be connected to a receiver that receives a signal that the alert light should light up from a transmitter that is operatively connected to the pocket ecosystem or other container. The alert light (24) is intended to light up when the value of one of the measured parameters inside the pocket ecosystem (25) or other container moves outside the thresholds for optimal or tolerance levels for a species with members inside the pocket ecosystem (25) or other container. In some embodiments, a processor that commands the aforementioned transmitter, can be programmed to cause the transmitter to send the signal when one of the measured parameter values moves out of a goal range, or a processor that is connected to both the aforementioned receiver and the alert light, can be programmed to cause the alert light to light up when one of the measured parameter values moves out of a goal range.

Container balls are a subset of containers, but containers can be of any shape. For example, a group of large tanks placed in niches in a cliffside could be considered “Containers” for this application's purposes.

A pocket ecosystem (25) is a system designed to sustain one or more lifeforms, preferably multiple individual lifeforms of multiple species, and which includes, at a minimum, detectors (10) to monitor the measured parameters within the pocket system, and also a transmitter (17), to send information about the values of the measured parameters inside the pocket ecosystem to the research processing unit (32). Pocket ecosystems will often be small because of cost reasons, but can also be larger. For example, researchers could use a network of large tanks as pocket ecosystems, to find out more about a species.

A group of universities or schools can also collaborate to apply for a grant, share the grant money to each acquire pocket ecosystems, and each use one or more pocket ecosystems to collect data on the lifeforms inside. Then, the universities or schools will each send the data to the research corpus in the method described below. The schools or universities may be able to get valuable or publishable results from the data they collect. Because they jointly applied for the grant, their chances of jointly getting the grant will presumably be higher than if they had individually applied, therefore the universities or schools would each get some grant money and would each be part of a valuable or publishable study. The present invention allows the universities or schools to combine their efforts more easily than they would be able to otherwise.

For example, one of the authors herein, while an undergraduate, heard a professor complain about how National Science Foundation (“NSF”) grants were “impossible to get these days”. While the professor's comment was not exactly true, then or now, the fact remains that there are more applicants who want NSF grants than there are grants available. The present invention provides a potential way for institutions to “get around” this problem by combining their efforts to get a grant, and then working together to do the research which was the reason for awarding of the grant, and share any benefits from the results.

Ideally, pocket ecosystems should be easily moveable and the lifeforms in them should be easily observable. In some embodiments, the transmitter in the pocket ecosystem will be connected to a processor, and each pocket ecosystem will have a container ID, the identity of which will be transmitted from the processor to the transmitter. The transmitter in the pocket ecosystem will broadcast this container ID, along with the values of the measured parameters inside the pocket ecosystem.

In some embodiments, the processor in the pocket ecosystem will also be able to connect to the global positioning system (GPS) and will discern the GPS position of the pocket ecosystem. The processor in the pocket ecosystem will transmit the pocket ecosystem's location to the transmitter, which will broadcast the pocket ecosystem's location along with the pocket ecosystem's container ID, time, and values of the measured parameters inside the pocket ecosystem.

An example of a pocket ecosystem (25) is in FIG. 6. The pocket ecosystem in FIG. 6 includes guppies, plants, and detectors (10) and parameter influencers (12), and at least one transmitter and at least one receiver. The transmitter is transmitting the information collected from the detectors about the values of the measured parameters inside the pocket ecosystem.

The pocket ecosystem in FIG. 6 contains multiple species, and the measured parameters inside the pocket ecosystem are being controlled so that the species in the pocket ecosystem survive and contribute resources (such as carbon dioxide and oxygen) to each other.

The guppies produce carbon dioxide for the plants to breathe, and the plants produce oxygen, for the guppies to breathe. The user (A student in this case) can observe how the oxygen and carbon dioxide concentrations in the pocket ecosystem change, and reach equilibrium, and how the equilibrium within the pocket ecosystem (25) changes. This helps the student to learn.

There may be members of multiple species in each of the pocket ecosystems (25), and the users, such as students, may describe the behavior and characteristics of each of the species' members. They may also describe the species' behavior and characteristics in a complicated fashion (For example, explaining how a species of fish guards its eggs, which may affect those eggs' chances of survival).

An online report (26) is a report made on a PC, including the date and time the online report was started and submitted (electronically sent to the research processing module (32)), and, if possible, the PC's physical location, when the online report was submitted, or, alternatively, the PC's physical location(s), between the times the online report was started and submitted. The dates and times the online report is started and submitted can be acquired from the PC's internal clock and date function. The PC's locations between the times the online report was started, and submitted, can be acquired using the GPS function on the PC. Alternatively, the note-taking app (31) can access a function such as Mapquest.com or Google Apps to learn the location(s) of the PC sending the online report, between the times the online report was started and submitted. In some embodiments, the notetaking app (31) will access this function automatically and add this information to each online report (26). The online report should include the observations of the user writing the online report, with regards to the pocket ecosystem (25) or other container that the user is observing. The user is supposed to write the observations in the online report. A user “submits” an online report by causing the online report to be sent over the internet to the research processing module (32). The online report should also preferably automatically include the user ID for the user who made the online report, any group IDs for groups that the user is part of, and a container ID for the pocket ecosystem or sectioned container that the user observed to make the online report.

The online reports, when they arrive in the research corpus, will be considered “unstructured” data, because they will not necessarily have the structure one would normally expect for data. This is because the online reports' formats and the types of words that users (Some of whom may be students) will use in the online reports, and the types of things the researchers will notice and record about the species they are observing cannot be predicted. The flexibility of the online reports' potential format also encourages researchers to note down, in the online reports, everything they observe about the containers that are the online reports' subjects, even if there are not specific “categories” for some pieces of what the users observe. The system is also designed to work with a very large variety of lifeform types, so flexibility of the online reports' potential formats is also needed, to accommodate the very large number of lifeform types that users might mention in online reports. These are also some of the reasons why application of text analysis techniques to the online reports is useful. Another reason is that the research corpus's total combined size will be very large, making it difficult for a researcher to examine all the online reports that mention a species. A related reason is that, in many cases, the total number of mentions of a species will be large, again making it difficult for a researcher to examine all of them. Other reasons are that a lot of the researchers' observations will not be easily “quantifiable”, and that a lot of the researchers' observations of pocket ecosystems and/or other containers might be situation-dependent, or dependent on a species interacting with other species, and therefore might have an unpredictable format. Text analysis might therefore be needed to turn the researchers' observations into other kinds of data. These are not the only reasons why text analysis of the online reports is useful.

A language processing module (29) is a program module or a program with the capability to perform text analysis on the text in the research corpus and subsidiary corpuses, and to find patterns in this text and statistical information about the patterns in this text. At a minimum, the language processing module (29) should be capable of calculating the lift of combinations of words that represent lifeform types' characteristics, calculating the similarity of words based on the similarity of the words' contexts, calculating syntagmatic relationships and conditional entropy concerning words in the research corpus, and sending the results of all these calculations to the viewing interface. The language processing module should preferably be able to calculate “aspect ratings” and “aspect weights” for the online reports.

The language processing module should also have the ability to change the definition of the “context” of a word that the language processing module is using, for example, by changing the number of words before and after a word that are counted as part of that word's context. The language processing module should also be able to then calculate the similarity of words based on similarity of their redefined contexts.

The language processing module (29) should also be able to calculate word frequency of words, and concordance of words within the research corpus (33), or a subsidiary corpus (41), or an online report, and to identify the most common bigrams and trigrams (Either overall or including a lifeform type's name) in a single online report, or in the research corpus (33), a subset of the online reports in the research corpus (33) or a subsidiary corpus (41) or a subset of the online reports in a subsidiary corpus (41).

In some embodiments, the local language processing module can use all forms of text analysis known in the prior art to analyze the research corpus and subsidiary corpuses.

In some embodiments, the language processing module can use all forms of text analysis known in the prior art to analyze the research corpus.

The language processing module (29) should be accessible via the internet or cloud to numerous users, so that all of these users can perform text analysis using the language processing module (29).

A PC (30) is a personal desktop or laptop computer, smartphone, similar instrument, or the following: a computing system including at least the following five components: A processor for processing digital data, a memory for storing digital data coupled to the processor, an input digitizer for inputting digital data coupled to the processor, a display device coupled to the processor, and a memory for displaying information derived from digital data processed by the processor. As those skilled in the art will appreciate, the PC may include an operating system (e.g., Windows, OSX, iOS, UNIX, Linux, MacOS, Android, etc.) as well as various conventional support software and drivers typically associated with computers or smartphones.

A note-taking app (31) is a program, which will usually run on the PC, and which allows the user to record his/her notes about the pocket ecosystem (25), sectioned container (28) or other container that the user is observing, in online reports (26) which can be placed in the research corpus (33). The user can use the note-taking app (31) to create an online report, and the online report will include a record of when the online report was started and submitted. In some embodiments, the user will have to enter into the note-taking app (31) and include in the online reports the user's user ID, the group IDs of any groups of which the user is a part (Such as classes of which the user is a part), and the container ID of the pocket ecosystem or other container on which the user is taking notes. In some embodiments, the notetaking app (31) which the user uses to create the online reports will include this information automatically in each online report, once the user has inputted this information into the notetaking app (31) once.

The user's notes can be turned into an online report (26) either by the note-taking app (31) when the notes are entered into the note-taking app (31), or, in some other embodiments, by the research processing module (32) when it receives the notes.

A research processing module (32) is a program or program module that places the online reports (26) into the research corpus (33) and, in some embodiments, places copies of the online reports into subsidiary corpuses (41). The research processing module (32), in some embodiments, may place copies of online reports (26) from specific sources (Such as specific schools) into specific subsidiary corpuses (41). The research processing module (32) also places, into the research corpus (33), the measured parameter values being broadcast from the transmitters operatively connected to, and/or transmitters in, each pocket ecosystem, sectioned container, or other container, for which a user has registered a container ID with the research processing module. In some embodiments, such registration can happen, among other ways, by a user submitting an online report with a pocket ecosystem, sectioned container, or other container with that container ID as the online report's subject, or by a user sending the container ID to the research processing module ahead of time, using the note-taking program (31), or using another method. The research processing module also saves these container IDs, and the user IDs of the users who registered them, in the research corpus (33). In some embodiments, the research processing module (32) will also associate each online report (26), in the research corpus, and also the copies of the online report (26) in any subsidiary corpuses, with the measured parameter values broadcast during the time between the time when that online report was started and the time it was submitted, by the transmitters operatively connected to, and/or in, the container that was that online report's subject. In some embodiments, the research processing module may make this association upon receiving the online reports (26), and in other embodiments, the research processing module may make this association later, such as at a time when a user decides to do text analysis on the online reports.

The research processing module (32) should also associate the following pieces of information (among others) with each online report: The user ID of the user who made the online report, and the container ID for the container, that was the online report's subject. The online reports themselves should include these two pieces of information. In some embodiments, the research processing module may make this association later, such as at a time when a user decides to do text analysis on the online reports (26).

The research corpus (33) is a repository, available online or on the cloud, that, at a minimum, includes all the online reports (26) and material converted into online reports (26) that have been received by the research processing module (32), and all the measured parameter values broadcast by transmitters in, or operatively connected to, the pocket ecosystems, sectioned containers, and other containers with container IDs registered with the research corpus (33).

In some embodiments, a user will be able to view online reports (26) that are in the research corpus (33), but will not be able to view the user ID of the user who wrote the online report (26), any other unique IDs that are in the online report (26), or the exact locations of the PC on which an online report was written, at the time the online report (26) was started, was submitted, and the time in between, unless the user who wants to view this information has special permissions to view this information relating to online reports from the user who wrote the online report. These embodiments will include the ability for users to give other users such special permissions, regarding online reports they have written.

In most embodiments, a user can register, in the research processing module, the container ID of a pocket ecosystem, or other container that the user plans to submit online reports about, when that user acquires the pocket ecosystem, or other container, or later, up until the time when the user sends in the first online report about that pocket ecosystem, or container. These registrations can be saved in the research processing module or research corpus. The inventors recommend that the research processing module be programmed so that an online report simply not be accepted by the research processing module without a container ID for the pocket ecosystem, sectioned container, or other container which is the online report's subject.

The artificial neural network (34) that is part of this invention, also referred to herein as the “neural network”, shall be a network of programs (The artificial neurons) organized into multiple layers. Inputs based on researchers' observations of containers will be run through the first layer, then the results of this are run through the second layer, etc., until the last layer is reached, and an output from the last layer is generated.

The artificial neurons (35) that are part of this invention, each of which shall be referred to herein as an “artificial neuron”, are the “nodes”, connected programs that are part of the artificial neural network.

The statistical investigation module (36) is a program, or module of another program, that is used, in some embodiments of the invention, to investigate patterns concerning the distribution of how online reports (26) are sent, and other information about distribution of the online reports (26) (As opposed to the content of the data included in the reports). For example, the statistical investigation module (36) can be used to investigate which users, within a group, created online reports (26) during a certain time period (As opposed to what was in the online reports). The statistical investigation module (36) is able to do the following, at a minimum. First, when examining a group of users, the statistical investigation module (36) can find the percentage of group members who have submitted online reports, by dividing the number of group members by the number of group members who have submitted online reports, and can also find the user IDs of those group members who did or did not submit online reports. The statistical investigation module (36) can also find the percentage of group members who have submitted online reports within a certain time period, or within multiple time periods, and the user IDs of group members who submitted online reports or did not submit online reports during that time period or periods. The statistical investigation module (36) can also find a distribution of the points, during a time period, when group members submitted online reports.

One example (Not the only example) of how the statistical investigation module (36) can execute these functions is as follows: The statistical investigation module (36) receives a command from a group leader of a group of students via the viewing interface, to find the percentage of a group of students who submitted online reports during a certain time period, which we will call “Period A” for simplicity. The command will include an identifier for the group (Such as a group ID), and an instruction defining which time period(s) to search. The statistical investigation module (36) will, first, search the research corpus for user IDs associated with that group ID. These are the group's members. The statistical investigation module (36) will then search the research corpus (33) for online reports, submitted during Period A, and associated with one or more of the user IDs associated with that group ID. The statistical investigation module (36) will then divide the number of user IDs in the group associated with at least one online report (26) during Period A by the total number of user IDs in the group to get the percentage of group members who submitted online reports during Period A.

The viewing interface (37) is a program, or module of another program that researchers, who are also users, use to interact with and view the results of the text analysis the language processing unit has performed on the research corpus. For example, researchers can use the viewing interface to display the lift of word combinations that mention a certain lifeform type. These may be combinations of words that the researcher has entered into the language processing module, for the language processing module to calculate the combinations' lift. The viewing interface should also, at a minimum, be able to display the similarity of words, based on the similarity of their contexts, that the language processing module has calculated. The viewing interface will also be able to display syntagmatic relationships and conditional entropy concerning words in the research corpus, calculated by the language processing module, and also display “aspect ratings” and “aspect weights” for the online reports calculated by the language processing module.

In most embodiments, researchers should also be able to use the viewing interface to examine and search the contents of the central association collection, and, if a researcher has a local association collection, the researcher should be able to use the viewing interface to view and search its contents.

The automatic report (38) is a report of what the auto-sensors (49) have detected, and is transmitted from a transmitter in a pocket ecosystem or other container. Automatic reports (38) are generally created by one or more of the processors in a pocket ecosystem or other container. In most embodiments using auto-sensors, the auto-sensors in a pocket ecosystem or other container will be sending information about what they detect, continually, to a processor in that pocket ecosystem or other container. The processor will then create the automatic report (38), including the information about what the auto-sensors have detected. For example, in a pocket ecosystem where the auto-sensors are a motion sensor and a sensor that tracks the movement of specific color patterns on creatures, the automatic report will include a record of the motion detected by the motion detector, and a record of the movements of those color patterns, which presumably indicates movement of the lifeforms with those color patterns.

The processor will transmit the automatic report (38) to an attached transmitter, and then the transmitter will broadcast the automatic report (38).

The automatic report (38) may cover what the auto-sensors observed during a specific period of time, such as 1 minute, 1 hour, or 1 second. An automatic report (38) can also be transmitted continuously, sending a continuous stream of information about what the auto-sensors observed as they observed it, in some embodiments.

A Container latch (39) is a latch in some embodiments of the sectioned container, or other container, which interlocks with a latch on a container connection device. The container latch (39) performs the same function for a sectioned container or other container that the container ball latch (21) performs for a container ball.

The container latch can be attached to the container by flexible hinges. The hinges allow the container latch to be latched to other latches on the container connection device. The hinges can rotate, so the container will open and close, while keeping the container latches connected to the latches on the container connection device.

In some versions of these embodiments, the container latches (39) will fit into specialized grooves inside the container connection device, and inside the grooves will be additional nodules that the container ball latches will “catch” on, locking the sectioned container or other container to the container connection device. The container latches may have two sections, with the second section being connected to the first by a flexible hinge, wherein this flexible hinge can be “locked” and prevented from rotating when necessary. Methods of making the hinges lock are known in the prior art.

Alternatively, a version of the container latches where each latch has one section, connected to the container by a hinge which does not lock, are possible.

Versions of the container latches where each latch has two sections, connected to each other by hinges which do not lock, and also connected to the sectioned container or other container by a hinge which does not lock, are possible.

Most versions of the embodiments that use container latches will use at least two container latches, spaced evenly around the top of the sectioned container or other container. More container latches can be used, and they should preferably also be spread evenly around the top of the sectioned container or other container.

A sectioned container or other container can be connected to the container connection device by any of the methods by which a container ball can be connected to the container connection device, and by any of the methods known in the prior art.

A combination of methods of attachment can also be used, along with any other method or combination of methods known in the prior art.

Any method of attachment between the container and the container connection device, where the sectioned container or other container is detachable, should allow for information to be interchanged between any transmitter in the sectioned container or other container and any receiver in the container connection device, and between any receiver in the sectioned container or other container and transmitter in the container connection device.

The fact that the sectioned container or other container may be attached and detached from the container connection device means that a sectioned container or other container can be taken, possibly with lifeforms inside, and used for other things, such as being used as part of a piece of jewelry, or attached to clothes, with the components used to attach the sectioned container or other container to the container connection device being used to attach the sectioned container or other container to other things. For example, a sectioned container or other container with container latches (39) can be detached from a container connection device and connected to the user's clothes through the container latches being latched onto a user's clothes.

An auto-sensor (49) is a sensor that detects something about the lifeforms in a pocket ecosystem, sectioned container, or other container directly, as opposed to a detector (10) that detects the value of a measured parameter (Measured parameters are kinds of environmental conditions that may affect the lifeforms in the container). Some examples of auto-sensors are movement detectors, infrared sensors that monitor the amount of heat being produced by an infrared image that looks like a lifeform, ultraviolet sensors, sensors of light absorption, noise level sensors, and sensors of various compounds produced by specific species (Note that the last three could also be detectors, and additionally fulfill the role of detectors in the invention described herein).

Auto-sensors are supposed to be used to learn about how organisms respond to measured parameter value changes. For example, if an organism responds to a change in the value of a measured parameter by moving more, this movement can be detected by a movement sensor. This, probably positive, change in the organism's behavior might be a response to a change in the measured parameters where the organism is kept.

The inventors herein believe that human observation is preferable to use of auto-sensors, partly because humans can observe a wider variety of things than sensors can, partly because the use of the invention as a teaching aid is only effective if humans are being taught (Such as observers) and partly for other reasons. However, some applications may be executed better with use of auto-sensors, or with a use of a combination of auto-sensors and human observers.

A subsidiary corpus (41) is a subset of the online reports in the research corpus, and the subsidiary corpus also includes, for each online report in the subset, the measured parameter values in the container that was the online report's subject, during the time between when the online report was started and when it was submitted, the container ID of the container which was the subject of that online report (This container ID should have been recorded by the user who created the online report), user ID of the user that made the online report, and times associated with that online report, including when the online report was started and submitted. In some embodiments, the subsidiary corpus (41) will also include other characteristics associated with the online reports in the subset, if information about these other characteristics is available. For example, a subsidiary corpus (41) can be created, which includes all the online reports (26) that have a certain quality in common, or have more than one quality in common. For example, a subsidiary corpus (41) can be created of all the online reports (26) that mention a certain species, or that both mention that species, and were created between 6 A.M. and 10 A.M. A subsidiary corpus can be created of all the online reports (26) that were created by users who attend a certain school, who were in a certain class, or who attended schools in a certain school district. One way to do this is that online reports can be given unique report IDs that include some information about the way in which the online reports are grouped; For example, online reports that are part of the same study can have part of their report IDs in common.

A local language processing module (45) is a program or module of a program that is accessible to one user or a subset of users (Unlike the central language processing module (29), which is accessible to all users), and which has the capability to perform text analysis on the research corpus, and subsidiary corpuses. The local language processing module should be capable of using text analysis techniques to find patterns within the text in the research corpus and subsidiary corpuses. At a minimum, the local language processing module (45) should be capable of calculating the lift of combinations of words that represent species' characteristics, calculating the similarity of words based on the similarity of the words' contexts, calculating syntagmatic relationships and conditional entropy concerning words in the research corpus and the subsidiary corpuses, and making the results of all these calculations available to the user(s) with access to the local language processing module (45). The local language processing module should preferably be able to calculate “aspect ratings” and “aspect weights” for the online reports.

The local language processing module (45) should also be able to calculate word frequency of words, and concordance of words within a subsidiary corpus (41), and to identify the most common bigrams and trigrams in a single online report, in the research corpus (33) or a subsidiary corpus (41).

The local language processing module, ideally, should be able to perform all forms of text analysis on subsidiary corpuses (41) or subsets of the online reports in subsidiary corpuses (41) that the language processing module (29) can perform on the research corpus (33) or a subset of the online reports in the research corpus (33). In some embodiments, the local language processing module can use all forms of text analysis known in the prior art to analyze the research corpus and subsidiary corpuses.

A central association collection (46) is a collection of the results of text analysis performed by the language processing module on the research corpus, subsets of the online reports in research corpuses, and on subsidiary corpuses, and subsets of the online reports in subsidiary corpuses. A central association collection (46) can also include the results of researchers' analysis using their local language processing modules (45), wherein the researchers who performed the analyses have sent the results to the central association collection (46). An example of the sort of information that would be stored in the central association collection (46) is the lift of multiple combinations of words involving a certain species, as found by a researcher with a specific user ID at a specific time using a certain method. The central association collection (46) would effectively provide a repository of the analyses that have been done so far, and their results, so that researchers can review the analyses' results and learn from them, and also can learn what analyses have been done so far, and when. The central association collection (46) can be searched for specific information, using known techniques for searching online repositories, in some embodiments.

A local association collection (47) is a collection of the results of text analyses of the research corpus (33) or subsidiary corpuses (41) by a local language processing module (45). A local association collection (47) is stored on computer storage controlled by an individual user (Such as a local user's hard drive, or a part of the cloud to which that user controls access, for example). Unlike the contents of a central association collection (46), the contents of a local association collection (47) would only be visible to the researcher(s) who own/control the local association collection, unless those researchers make the contents available to others. The local association collection (47) would effectively provide a repository of the analyses that a specific user or group of users has done so far, and their results. The local association collection (47) can be searched for specific information, using known techniques for searching online repositories, in some embodiments.

Some users might choose to use the local association collection (47)'s ability to store information about the analysis that a specific user has done, as a source of competitive advantage.

A memory (48) is a computer memory, including, all the forms of computer memory known in the prior art, and also specifically including all cloud-based methods of computer memory storage.

The central comparison module (50) is a program module or program. It can be stored on a specific processor, on the cloud, in a “distributed” configuration, or in any of the other methods known in the prior art. In the first group of embodiments, the central comparison module (50) receives, over the internet, the measured parameter values broadcast by transmitters (17) that are connected to, or are part of, the containers in a group of containers. These values are transmitted over the internet and reach the central comparison module (50). The central comparison module also retrieves the optimal and tolerance values for the lifeform types in each of the containers from the central lifeform database (51). The central comparison module (50) will continually compare the actual values of the measured parameters in each of the containers to the optimal and tolerance levels for those measured parameters retrieved from the central lifeform database. If the actual value of a measured parameter in a container is outside the optimal or tolerance range for the lifeform type in the central lifeform database, and there is a measured parameter influencer in that container that affects that particular measured parameter, the comparison module will send a command for this measured parameter influencer to change the measured parameter's value, until this measured parameter's value is back within the optimal or tolerance range for that lifeform type (whichever is desired).

The central comparison module (50) can also retrieve information about the proper intervals between feeding for lifeform types, and compare the measured parameter values being broadcast by transmitters in communication with the detectors to the tolerance ranges for the measured parameters for the targeted lifeform type, a member(s) of which is inside each sectioned container or other container.

The central lifeform database (51) is a database, which includes the optimum and tolerance levels for each measured parameter, for as many different lifeform types as possible. In some embodiments, the “lifeform types” will be subdivided by species of lifeform, in other embodiments, a variety, within a species, can be listed in the central lifeform database (51) as a “lifeform type”, and in other embodiments, “lifeform types” will include varieties, within a species, groups of species, and individual species. For example, the central lifeform database (51) can include the optimal and tolerance levels for each of multiple species of mussels, for many measured parameters, including concentrations of magnesium, iron, and other minerals, temperature, Ph, salinity, and all the other measured parameters listed herein.

The central lifeform database (51) also can include information about the appropriate feeding times for lifeform types, and other characteristics of lifeform types.

A nutrient balancing hole (53) is a hole in a pocket ecosystem (25) or other container with the purpose of enabling easier exchange of compounds with the outside of the pocket ecosystem (25) or other container. For example, a nutrient balancing hole (53) can have the purpose of enabling easier exchange of oxygen and carbon dioxide with the outside. Nutrient balancing holes can be used as teaching aids, because, in some embodiments, the size and number of the nutrient balancing holes in each pocket ecosystem can be indicated by part of that pocket ecosystem's container ID. When a student or other user observes the lifeforms in the student's or other user's pocket ecosystem, the measured parameter value levels, and, indirectly, the actions of the lifeforms inside that pocket ecosystem, and other observable information about those lifeforms, may be influenced by the size of the nutrient balancing hole(s) in that pocket ecosystem. Therefore, researchers examining the research corpus, or a subsidiary corpus including the online reports (26) that a student(s) made about that pocket ecosystem (28), and the measured parameter measurements from that pocket ecosystem may be able to learn about how different levels of ability to exchange compounds with the outside affect the values of the measured parameter values inside that pocket ecosystem, and the actions and characteristics of the lifeforms inside that pocket ecosystem.

Nutrient balancing holes can also be used by entities wanting to keep an organism or population of organisms alive, or ensure that they have certain characteristics, by ensuring that the organism(s) have a certain level of exchange of compounds such as specific nutrients with the outside of a pocket ecosystem or other container containing the organism(s), or by ensuring that the organisms have a certain level of exposure to desired compounds. The level of exposure can be influenced by the size of the nutrient holes. An entity might want to ensure that the organisms have a certain exposure level to certain compounds for many reasons, such as to ensure that the organisms are healthy, or to ensure that they taste a certain way.

### Use of the Central Lifeform Database, Central Comparison Module, and Faraway Program to Optimize for Other Characteristics

In some embodiments of the invention, the central lifeform database and central comparison module can be used to find a measured parameter range combination, in which to keep lifeforms of a lifeform type, while also optimizing another characteristic of those lifeforms. For example, a user could use the central lifeform database and central comparison module to optimize the lifeforms' taste when eaten, as follows: First, the user can track groups of organisms of that lifeform type raised under different measured parameter value range combinations. The user could do this by raising the organisms under different measured parameter value range combinations. Then, the user can offer the groups of organisms to consumers to eat, while surveying the consumers about the organisms' taste, and the user can create and import a database of the consumers' responses from the survey of the organisms' taste. The user would have to track the source of the organisms offered to each consumer, to make sure that the user is able to match each consumer's response to the combination of measured parameter value ranges in which the organisms offered to that consumer were raised. The user can then find the combination(s) of measured parameter value ranges that produce the best-tasting members of that lifeform type, based on the survey, by matching the group(s) of the organisms that the survey claimed tasted the best, to the combination of measured parameter value ranges where those organisms were raised. The user can then program the combination of measured parameter ranges that produce organisms of that lifeform type with the best taste into the user's lifeform database. The user can use the user's user interface to program this combination of measured parameter value ranges (a type of “goal range combination”) into the user's lifeform database, and command the user's comparison module to cause the parameter influencers in the containers, which contain the targeted lifeform type, keep the measured parameter values in those containers within that “goal range combination”. The user will thus keep the measured parameter values in the “goal range combination” that produces members of that lifeform type that have the best taste (Based on the survey).

The user can also make the above methods more effective if the user's faraway program includes a program module that continually keeps track of the measured parameter values in the sectioned containers or other containers where the user is keeping the lifeforms for consumption. That way, the user can more easily track the measured parameter range combinations in which the user is keeping the lifeforms for consumption. In some embodiments, the faraway program will include such a module.

A user can also use a similar combination of methods to produce lifeforms that are optimized for another goal. The user would have to raise the lifeforms under different measured parameter range combinations, and find the measured parameter range combination under which lifeforms of the selected lifeform type are raised, which best fulfills the goal.

Embodiments using a research corpus can also be used more easily to find a combination of measured parameter ranges which is optimized for a targeted lifeform type's taste when eaten, or another quality of the targeted lifeforms, because in embodiments using a research corpus, the measured parameter values in the containers are being saved in the research corpus (33) continually, as they change. The user will not have to make any online reports if the user does not wish to do so.

### Wireless Charging of the Handle and Other Components

The handle, in some embodiments, can have a charging port, which will be operatively connected to the battery in the handle, by a wire internal to the handle, or by other means. The charging port will be able to feed power to the battery in the handle, to recharge the battery.

Other components, such as a sectioned container (28), or a pocket ecosystem (25), can also have charging ports, that will charge the electrical components inside the sectioned container (28) or pocket ecosystem (25), respectively.

The charging port(s) (20) can be a plug-in port, a USB type C port, another type of USB port, or can be another one of the types of charging ports known in the prior art.

The charging port can also be a wireless charging port, by which electrical power is received into the charging port via inductive charging.

Alternatively in other embodiments, the charging port in the handle can be operatively connected to multiple batteries, in the handle and other locations. These connections may be via the main wire group, especially with batteries located outside the handle, or may be via a more direct connection, especially with batteries located inside the handle. This way, electric power received through the charging port can charge all the batteries to which the charging port is connected, including the battery in the handle and other batteries.

Likewise, charging ports on other components of the invention can each be connected to one or more batteries located in other components of the invention, and can charge those batteries.

The charging port can also be operatively connected, by the main wire group or by other means, to batteries located outside the handle.

The compartment containing the battery, within the handle, can also be opened and closed, with the battery itself being removable, in some embodiments, so that the battery can be easily replaced if needed. Compartments containing batteries in other parts of the invention, such as containers, including pocket ecosystems, and sectioned containers, can also be opened and closed, with the battery itself being removable, in some embodiments.

Detectors, linking mechanisms, and parameter influencers, and other components that use electricity, can theoretically be directly connected to the charging port in the handle and/or another charging port, so that power flows directly from the charging port(s) to the components that use electricity.

A charging port in a sectioned container, pocket ecosystem, or other container can also be connected to a battery in the sectioned container, pocket ecosystem, or other container, respectively. Other electrically powered components in the sectioned container, or pocket ecosystem, or other container would draw power from that battery.

### Some Components of One Inventor's Previous Inventions that have Uses in this Invention

The detectors each detect the value of one or more measured parameters inside the sectioned container, or pocket ecosystem, or other container. The parameter influencers each influence the value of one or more measured parameters inside the sectioned container, or pocket ecosystem, or other container, for example, a temperature control (A temperature parameter influencer) inside a container ball can cause the temperature inside a container ball to rise until it reaches a desired level.

A sectioned container, or pocket ecosystem, or other container that includes some, but not all, of the specific kinds of detectors listed herein is possible, as is a sectioned container, or pocket ecosystem, or other container that includes all, of the specific kinds of detectors listed herein and other kinds of detectors not specifically listed herein. The same detector can detect more than one measured parameter.

The detectors will be attached to the interior of one or both halves of the container ball, or the interior of the sectioned container, or pocket ecosystem, or other container, and will draw power from wires that are within the wall of the container ball, pocket ecosystem, sectioned container or other container, or the detectors can be charged via inductive (wireless) charging.

Alternatively, in some embodiments of the invention, these instruments can be attached to the container connection device, and can read the temperature and other conditions inside a container ball, sectioned container, or other container when it is attached to the container connection device.

Some of these embodiments will include small holes in the top of the container ball, sectioned container, or other container, which are directly below the container connection device, and which the detectors will reach through, to monitor conditions inside the container ball, sectioned container, or other container. The small holes will be pressed against the container connection device, and water from the outside will not be able to get in through the small holes, when the container ball, sectioned container, or other container is closed and attached to the container connection device.

A receiver receives wireless transmissions, and a transmitter makes wireless transmissions.

A battery can be included in, among other places, the handle (1), long rod (2), main wire group (3), external reel (4), container connection device (5), the wall and other parts of the container ball (6), control panel (7), wire holding rings (8), linking mechanism (18), container ball latch (21), the wall and other parts of the pocket ecosystem (25), the wall and other parts of the sectioned container (28), and the container latch (39). A battery can also be kept in a compartment that can be opened or closed by hand in each of those components, with the battery itself being removable.

A charging port (20) can also be in one of the group of components where a battery can be located. In some embodiments, a charging port in one of those components can be connected to one or more batteries in one of the components that is part of the same apparatus. In some embodiments, these connections may be via the main wire group, if it is present, or via a different connection.

In some embodiments, a processor, receiver, or transmitter can also be in one of the group of components where a battery can be located. In some embodiments, a processor in one component in this group can be connected to a receiver or transmitter in another component in this group that is part of the same apparatus. In some embodiments, a transmitter in one component in this group can broadcast information that is received by a receiver, in another component in this group, in the same apparatus. This receiver can be connected to a processor, and can transmit the information it receives to that processor.

Some parts of some embodiments of the invention will be coated with solar panels, or thin-film solar cells, which will provide power to the electrically powered parts of those embodiments of the invention. A solar panel, or group of solar panels, can be directly connected to one or more electrically powered parts, and can send power directly to them, or the solar panel or group of solar panels can be connected to one or more batteries, and send power to the batteries, which will then send it to electrically powered parts, or the solar panel or group of panels can be directly connected to both one or more electrically powered parts and one or more batteries.

### The Handle

In some embodiments of the invention, the handle contains an internal reel, on which is wound the main wire group. This internal reel is necessary in these embodiments so that the user can extend or retract the main wire group when needed. The internal reel should generally be controlled via a reel control, which can be comprised of buttons, in the handle, or may take another form. In some embodiments, the user can use these controls to tell the internal reel to wind in either direction and retract or extend the main wire group, thus increasing or decreasing the portion of the main wire group that is extended away from the reel.

The handle will also usually contain a power source for the handle, and this power source may be connected to other parts of the device. This power source may be a battery, or may be solar panels, on the outside of the handle, connected to a battery, or may be a charging port for an electrical cord, or another power source. The handle may also contain a battery and one or more other power sources, such as solar panels or a charging port, that preferably recharge the battery. Wireless charging of the battery in the handle, via a charging port capable of wireless charging, is possible.

In some embodiments, the battery and/or other power sources will connect to the internal reel, the controls, the main wire group, and any other components that require electrical power to operate, including, in some embodiments, a container connection device with the ability to wirelessly charge sectioned containers or other containers with wireless charging capability.

Alternatively, the other power sources will connect to the battery, which will connect to the internal reel, the controls, the main wire group, and any other components that require electrical power to operate, including, in some embodiments, a container connection device with the ability to wirelessly charge electricity-using components of sectioned containers or other containers with wireless charging capability.

In other embodiments, the other power sources will connect to the internal reel, the controls, the main wire group, and any other components that require electrical power to operate, and the battery will separately connect to the internal reel, the controls, the main wire group, and any other components that require electrical power to operate.

In some embodiments, the internal reel will be controlled manually by a hand lever which is attached to the outside of the handle, or the internal reel can be switched between manual and electronic control.

Some embodiments of the handle will include an external reel (instead of an internal reel), on which the main wire group will be wound. In some embodiments, the user can hand-wind this external reel, the same way that a reel is wound (on normal fishing rods. In other embodiments, the external reel can be controlled by an electronic reel control, in the same manner that an internal reel is controlled by an electronic reel control in other embodiments.

In some embodiments, the controls in the handle, including the reel control, will be connected to a processor in the handle, and the processor will control a small motor that turns the internal reel either clockwise or counterclockwise, as the user desires. The main wire group will be wound on the internal reel. The processor and buttons will also be connected to a battery, and the battery will be connected with a charging port.

The drawings will largely show handles of a certain shape, but the handle can be of a different shape. The drawings will also show control panels of a certain shape, but control panels can be of a different shape, and each control panel can have more or less than four buttons, or other controls. In addition, the handle can have screens, digital gauges, charging ports, or other features in some embodiments. The control panel can also have screens, digital gauges, charging ports, or other features in some embodiments that include the control panel.

### The Controls in the Handle

The handle may include a reel control, cord control, container control(s), and possibly other controls, depending on the embodiment of the invention being used. For example, in some embodiments, there may be a light control, alert light control, temperature control, controls for the parameter influencers (12), food compartment control, and an external reel control. The measured parameter controls can include, but are not limited to, controls for temperature, Ph, fluoridation, oxygen, and salinity, and nitrate and nitrite levels, and controls for the other measured parameters listed herein.

The reel control, container control, and cord control and other controls can each also include multiple buttons, dials, or other types of components known in the prior art to have satisfactory characteristics to serve as controls or parts of controls.

One example comprises an apparatus with buttons for “close”, and “open” on the container control, and buttons for “clockwise” and “counterclockwise” on the reel control, and buttons for “close”, and “open” on the cord control. The buttons for the container control, in this example, would be connected by wires to a processor which controls the electromagnets, the buttons for the reel control would be connected by wires to the reel, and the buttons for the cord control would be connected by wires to a processor that controls the linking mechanism (probably the same processor that controls the electromagnets). This processor can be in the handle or elsewhere.

In one group of embodiments, which includes the reel control, cord control, and container control(s), these controls are all buttons that each operatively connect to a processor in the handle. The connection may be made via any means known in the prior art, including wires between the reel, cord, and container controls and the processor in the handle. The processor is also connected to a small motor which controls the reel, and connects to the main wire group, through which the processor sends electrical impulses to any sectioned container or other container that is directly or indirectly connected to the container connection device. When a user presses the reel control in this embodiment group, the reel control sends an impulse to the processor, which causes the reel to spin clockwise or counterclockwise, increasing or decreasing the part of the main wire group wound around the reel, and increasing or decreasing the length of the part of the main wire group that extends beyond the handle. When the user presses the cord control, in this embodiment group, the cord control sends a message to the processor, which sends an impulse via the main wire group to the linking component. This message causes the linking component (18) in the container connection device to close any attached container. When the user presses the container control, in this group of embodiments, the container control will send an impulse to the processor, which in turn sends power via the main wire group to the container connection device, where this power is distributed to the electromagnets in any attached sectioned container, causing that container to close. The processor can also send an impulse via the main wire group to the container connection device, causing those electromagnets to lose power, so that the sectioned container or other container including the electromagnets can open.

In some versions of the main wire group, the processor in the handle will send commands, in the form of impulses, via the main wire group, to another processor in the container connection device or the sectioned container or other container (or processors in both the container connection device and the sectioned container or other container). The processors in the container connection device, sectioned container, or other container will then send these commands to the components within the container connection device, sectioned container, or other container that are supposed to fulfill these commands. For example, the processor in the handle may send an impulse to a processor in the container connection device, saying that the electromagnets should be activated to close a container ball or other container attached to the container connection device. The processor in the container connection device will then activate the electromagnets, closing that container ball or other container.

In theory, the reel control could connect directly to the reel, and/or the container control could connect directly to a wire within the main wire group, which in turn would connect the container control directly to the electromagnets, and the cord control could connect directly to a wire within the main wire group, which would connect the cord control to a mechanism (The linking mechanism) within the container connection device that will mechanically open and close an attached container when desired. This will fulfill the functions of some embodiments, but is not preferred.

Alternatively, the container control and cord control could be directly connected, without an intervening processor, to wires within the main wire group, which, in turn, will be directly connected to a processor elsewhere, such as a processor within the container connection device, or attached sectioned container or other container. This processor would then tell the relevant components (usually the electromagnets) to open or close the sectioned container or other container in the way desired by the user, in the manner described in this patent application.

The container control, and the cord control, can be designed to open and close the sectioned container or other container quickly, or to open and close it at a speed controlled by the user. For example, the container control and cord control may be dials, that the user turns as he or she wishes to allocate more power to the tasks these dials control. The processor that controls the power flowing to the electromagnets in any attached sectioned container or other container can also increase the amount of power flowing to those electromagnets gradually, if the container control is designed with the ability for the user to gradually increase or decrease the amount of power being allocated to those electromagnets (For example, if the container control is a dial).

The controls are part of the control panel, in the first group of embodiments.

The handle, can also include an alarm, operatively connected to the processor in the handle so that this processor can activate the alarm. In some embodiments, the processor in the handle is programmed with a feature that causes the alarm to make noise when an event happens: For example, when the value of one of the measured parameters exceeds the tolerance range, or alternatively the optimum range, for a measured parameter for a type of lifeform currently within the sectioned container or other container, or when one of these measured parameters exceeds a certain absolute point, as measured by the detectors.

The processor in the handle, after receiving input from the detectors (10) would determine when the conditions for the alarm to make noise have been met.

In another embodiment group, when the user triggers a control for a component located in the sectioned container, other container or container connection device, the processor in the handle will send a wireless impulse to a second processor, in the container connection device and/or the sectioned container or other container (Whichever is being used), and this second processor will cause the component that the triggered control controls to act. The second processor should be closer than the first processor to the component controlled by the triggered control. For example, the processor in the handle can send a wireless impulse to a receiver in the container connection device, which is connected to a processor in the container connection device that will control the electromagnets in any attached sectioned container or other container directly and be able to send power to the electromagnets to cause them to close when desired.

In some embodiments, the processor in the handle will be connected to a receiver and a transmitter, and processors in the container connection device and any attached sectioned container or other container will also be connected to receivers and transmitters. The processor in the sectioned container or other container will also be connected to detectors and measured parameter influencers, located in the sectioned container or other container, respectively. The processor in the handle will send commands wirelessly, using the transmitter to which it is connected, to the processors in the container connection device and any attached sectioned container or other container. These commands will include commands from the controls, telling each of the measured parameter influencers to change the measured parameters it influences, such as telling a temperature influencer to raise or lower the temperature in a container ball, or other sectioned container or other container. The processors in the container connection device and any attached sectioned container or other container will use the transmitters to which they are connected, to send information to each other, and to the processor in the handle. This information will include the values of the measured parameters, that the detectors are detecting. Each processor will be connected to a receiver, so each processor will receive wireless signals broadcast by the other processors.

Multiple processors, in different areas of the apparatus, can communicate with each other by every other method known in the prior art.

A Light (9) is a small waterproof light.

### The Long Rod

The long rod (2) protrudes out of the handle, and wire holding rings (8) are attached to the long rod in some embodiments. Other embodiments might not have wire holding rings attached to the long rod. The main wire group (3) is a group of insulated electrical wires. In most embodiments, these wires will be separately insulated to prevent signals from being accidentally transferred between them, and then the combined group of wires will be bound by another set of insulation so that the electrical wires together form one cord, which is the main wire group, and is bound together by the second set of insulation. The main wire group extends out of the handle, along the long rod, and in the first embodiment, the main wire group is threaded through the wire holding rings. The main wire group then extends beyond the end of the long rod, so that the user can hold the apparatus by the handle, allowing the portion of the main wire group beyond the end of the long rod to be pulled down by gravity.

### The Main Wire Group

The main wire group is an electrically insulated cord, containing a group of one or more wires. The main wire group, in most embodiments that use a handle and long rod, starts in the handle, moves out of the handle, and continues along the long rod (2), and then continues beyond the end of the long rod (2), and connects to the container connection device (5). The main wire group, in embodiments that use a handle and long rod, transmits electrical impulses, commands, and power, from the handle to the container connection device, and any sectioned container or container connected to that container connection device, and also to a light inside the sectioned container or other container, in those embodiments which possess such a light.

In most embodiments the main wire group shall be configured to receive and transmit commands, in the form of electrical impulses, from each electronic component inside the handle which commands a component in the container connection device or any connected sectioned container or other container, and also from the light control that commands the light in some embodiments. The main wire group will transmit each command to the component that is supposed to execute this command. For example, in the first group of embodiments, the main wire group can transmit the command to activate the electromagnets in a sectioned container, to close that sectioned container, from the processor to the container connection device connected to that sectioned container, and the container connection device can then transmit power to the electromagnets in that sectioned container, causing them to become attracted to each other, which will close the sectioned container.

In embodiments where information and/or power is supposed to be transmitted back from a container connection device, or sectioned container, connected to the container connection device, to the handle, along the main wire group, the main wire group will have the ability to transmit this information and/or power, as well.

The main wire group should have the ability, in each embodiment where it is present, to transmit power and/or information from any of the components, connected to the main wire group, where this power and/or information is created, to any component, also connected to the main wire group, where the power and/or information is supposed to be received.

The main wire group can be configured in any of the ways known in the prior art. For example, the main wire group can be configured with a separate wire extending from each control, to the component that this control is supposed to direct; e.g., the main wire group can include a wire extending from a light control on the handle directly to a light. The wires extending out of the various controls will each be insulated and will be brought together in the handle, and will emanate out of the handle together in the same insulated cord, which will be the main wire group. Each wire will then communicate from one control to one component.

The main wire group can also be configured to begin at a processor (13) in the handle, and to comprise multiple wires, which emanate out of the handle together in one insulated cord, and end at different components. One or more wires begins at the processor in the handle and ends at the light, one or more wires begins at the processor in the handle and ends at each of the detectors, and one or more wires begins at the processor and ends at the electromagnets, and other wires begin at the processor in the handle and extend to any one of the parameter influencers that is present, or to another component that is part of the container connection device, any attached sectioned container or other container, or another component that branches out of an attached container connection device, or sectioned container or other container. Each wire can therefore communicate with one component. The component wires of the main wire group will therefore begin at the processor in the handle, and each component wire will end at one component. In this configuration, the controls in the handle will each have a connection to the processor in the handle, to send commands to this processor, so that the commands can then be sent along the main wire group.

In theory, in this configuration and other configurations, components outside the handle could also have a connection to the processor in the handle, to send commands to this processor, which would then be transmitted along the main wire group.

The main wire group can also extend from the processor in the handle to a processor in the container connection device (or elsewhere in the apparatus). The processor in the container connection device will be connected with components that are part of the container connection device and any attached sectioned container or other container, and will be programmed to send each message received from the processor in the handle to the appropriate component, which is supposed to execute that message. In this configuration, the controls in the handle will each have a connection to the processor in the handle, to send commands to this processor.

Alternatively, in embodiments where a sectioned container or other container can be connected to or detached from the container connection device, but this detachable sectioned container or other container has transmitter(s) that can communicate with receiver(s) in the container connection device, or receiver(s) that can communicate with transmitter(s) in the container connection device, the main wire group can end in the container connection device, and can receive any information that is transmitted directly or indirectly to it by those receivers in the container connection device, and/or the main wire group can directly or indirectly transmit instructions from processor(s) to transmitter(s) in the container connection device. These transmitter(s) can then transmit the instructions to receivers in a detachable, sectioned container or other container that is connected to the container connection device.

The main wire group can also extend from the processor in the handle to a processor in any sectioned container or other container, permanently attached to the container connection device. The processor in the sectioned container or other container, will have a direct connection to certain components such as the parameter influencers. When the user uses the temperature control in the handle to change the temperature inside the sectioned container or other container, an impulse will travel from the temperature control to the processor in the handle, then the processor in the handle will send an impulse along the main wire group to the processor in the sectioned container or other container, which will then send an impulse to the temperature influencer to change the temperature. In this configuration, the controls in the handle will each have a connection to the processor in the handle, to send commands to this processor.

The apparatus, in embodiments using the long rod, can also utilize more than two processors, for example, a processor in the handle, with direct connections to some components such as the controls, a processor in the container connection device, with direct connections to other components such as a light, and a third processor in a permanently attached sectioned container or other container, with direct connections to still other components such as a temperature control. In this configuration the main wire group can connect to all three processors and transmit commands between them, and send power to the processors in the container connection device and sectioned container or other container if necessary. All three processors will be programmed to determine which component each command is intended for, and which processor that component most directly connects to, so that commands intended for components with direct connections to the processor in the container connection device will be sent, by that processor, to those components, and commands intended for components with direct connections to the processor in the sectioned container or other container will be sent, by that processor, to those components.

Alternatively, the main wire group can be designed with other configurations known in the art.

In some embodiments, the main wire group will comprise one insulated wire.

In other embodiments, the main wire group will comprise one insulated wire that starts at the processor in the handle, but, which, when it reaches the container connection device, has a branch that connects to each component that is supposed to receive commands, such as separate branches heading to the detectors and the linking mechanism in an attached sectioned container.

In other embodiments, the main wire group will comprise an insulated wire that does not start at the processor in the handle, but connects to that processor.

In some embodiments of the invention, such as those using detectors, information may need to be transmitted from detectors in the container connection device or a sectioned container or other container attached to the container connection device, to the handle, so that the information can be displayed on digital gauges. For example, information about the Ph or temperature inside the sectioned container or other container may need to be directly or indirectly (via a processor in the sectioned container or other container or container connection device) transmitted from the detectors that measure Ph and temperature to the main wire group. The main wire group will then convey this information directly to the digital gauges in the handle, or to a processor in the handle, which connects with and transmits this information to these digital gauges. The information the detectors gained will then be transmitted from the detectors to the main wire group, and ultimately to the digital gauges where the information will be displayed. This can be done using the wire configurations listed in this application or known in the prior art.

The types of detectors listed in this patent application are not the only possible types of detectors. Other types of detectors are possible.

The end of the main wire group in some of the first group of embodiments includes a container connection device (5), which connects all sections of an attached sectioned container, and also connects to the main wire group.

A container ball latch (21) is a latch in some embodiments, positioned around the container ball's top, which interlocks with a latch on the container connection device.

The container ball latch can be attached to the container ball by flexible hinges. The hinges allow the container ball latch to be latched to other latches on the container connection device. The hinges can rotate, so the container ball will open and close, while keeping the container ball latches connected to the latches on the container connection device.

In some versions of these embodiments, the container ball latches (21) will fit into specialized grooves inside the container connection device, and inside the grooves will be additional nodules that the container ball latches will “catch” on, locking the container ball to the container connection device. The container ball latches may have two sections, with the second section being connected to the first by a flexible hinge, wherein this flexible hinge can be “locked” and prevented from rotating when necessary. Methods of making the hinges lock are known in the prior art. Alternatively, a version of the container ball latches where each latch has one section, connected to the container ball by a hinge which does not lock, are possible.

Versions of the container ball latches where each latch has two sections, connected to each other by hinges which do not lock, and also connected to the container ball by a hinge which does not lock, are possible.

Most versions of the embodiments that use container ball latches will use at least two container ball latches, spaced around the top of the container ball. If there are two container ball latches, they will be spaced 180 degrees apart from each other, if three, 120 degrees apart, etc.

Each container ball can be attached to, and detached from, the container connection device using any of the methods known in the prior art.

A container may also be attached to the container connection device via “snap-fits”, where the snap-fits on top of the container snap onto the parts of the bottom of the container connection device. The container also may be connected to the container connection device via a threaded portion on top of the container, which can be threaded into a threaded portion of the bottom of the container connection device, placing receivers and transmitters in the container and container connection device, in close enough proximity that information can be interchanged wirelessly between the transmitter(s) in the container and receiver(s) in the container connection device, and between the receiver(s) in the container and transmitters) in the container connection device even when the container and container connection device are submerged in water. The container may also theoretically be attached to the container connection device by adhesives, and pulled off of the container connection device when desired. Friction rings on the top of the container and/or the bottom of the container connection device may also theoretically be used to attach the container to the container connection device.

Magnets on the top of the container and bottom of the container connection device may also theoretically be used to attach the container to the container connection device. Combination locks between the container connection device and container, key fits between the container connection device and container, hub joints between the container connection device and container, keys between the container connection device and container, metal hooks between the container connection device and container, and designing the container and container connection device so that they interlock with each other, can also be used to attach the container to the container connection device.

A combination of attachment methods can also be used, along with any other method or combination of methods known in the prior art.

Any attachment method which is used, between the container and container connection device, where the container is detachable, should allow for information to be interchanged between the transmitter(s) in the container and receiver(s) in the container connection device, and between the receiver(s) in the container and transmitter(s) in the container connection device. This reduces the chances that the apparatus will become unable to perform all its functions.

The container may also be attached to the container connection device by a locking mechanism, but this can be unlocked, and the container removed.

The fact that the container may be attached and detached from the container connection device means that the container can be taken, possibly with lifeforms inside, and used for other things, such as being used as part of a piece of jewelry, or attached to clothes, with the components used to attach the container to the container connection device being used to attach the container to other things. For example, a container ball with container ball latches (21) can be detached from a container connection device and connected to the user's clothes through the container ball latches being latched onto a user's clothes.

### The Container Ball

A container ball is a substantially spherical hollow container comprising an interior space configured to contain a creature and a covering creating a continuous wall surrounding the interior space, said covering defined by moveable sections connected to each other in at least one location.

In some embodiments, the container ball includes electromagnets, which the user can activate. The user will activate the electromagnets, using a container control in the handle, and commands will travel over the wires in the main wire group to the container connection device. The electromagnets will then be activated, causing the two halves of the container ball to snap together.

The electromagnets, by themselves, are sufficiently powerful, when activated, to cause the container ball's two halves to snap together, but in some embodiments, the electromagnets are also helped by a mechanical component, within the container connection device. This mechanical component can also cause the two halves of the container ball to snap together. The linking mechanism (18) is one example of such a mechanical component. A linking mechanism can utilize a slider-crank mechanism, gear drive, ratchet mechanism, cam mechanism, or Geneva wheel, among other methods, and can use one of the methods known in the prior art. A linking mechanism can also be comprised of small rods emanating out of the container connection device, with a small rod pressed against the outside of each part of a sectioned container or other container that is supposed to be moved for that container to be closed. The small rod will press against the part of the container and move it, when the container is being closed.

Other methods of causing the two halves of the container ball to snap together, on command, are also possible, and are also part of the present invention.

It is important to note that, in every embodiment, designs may be placed on the container ball, and the other parts of the apparatus, changing the visual appearance of these parts of the apparatus. For example, the container ball may be painted to look like a “pokeball” from the Pokemon franchise. Designs can also be placed on a container of another type.

Some components, such as the detectors, and parameter influencers, can be connected directly to a processor in the container ball in some embodiments, and a processor in the container connection device in other embodiments.

### The Container Connection Device

In some embodiments, the container connection device will be pulled below the main wire group, by gravity, while the apparatus that includes the container connection device and main wire group is in use. The main wire group will have one connection to the container connection device, and, in some embodiments with a container ball, the of container ball (6)'s two halves will be connected to, and will open below, the container connection device. In other embodiments, the container ball (6)'s two halves will be connected to, and will open to the side of the container connection device. In some of these embodiments, the main wire group will be connected to the container connection device at multiple points, so that the container connection device, and container ball, will not hang directly below the main wire group, but will hang at an angle to the main wire group.

When another type of sectioned container is used, instead of a container ball, and a main wire group is also used, the container connection device can, in some embodiments, be connected to the main wire group and to some or all of the sections in the sectioned container, with the sectioned container opening below or to the side of the container connection device.

Likewise, when another kind of container is used, and a main wire group is also used, the container connection device can, in some embodiments, be connected to the main wire group and to the container. In some embodiments, the container can open below or to the side of the container connection device.

Receivers and/or transmitters in a sectioned container or other container in one of these embodiments can be placed close to the top of the container, so that they will be close to transmitters or receivers in the container connection device, respectively.

In some embodiments, wires can reach down from the container connection device into a sectioned container or other container, to interact with components in the sectioned container or other container, in the way that these wires would reach down from the container connection device into a container ball, to interact with components in the container ball.

### The Wire Holding Rings and Control Panel

The wire holding rings are mounted on the long rod (2), in some embodiments. The main wire group is threaded through the wire holding rings in some embodiments. This is to make the main wire group easier to use. Embodiments of the invention involving the long rod can use as many, or as few, wire holding rings as desired. A variation of the invention is also possible, where the wire holding rings can be attached to, and detached from, the long rod, meaning that the number of wire holding rings can be varied to suit the user's tastes.

The control panel is present in some of the embodiments of the invention that use a handle. The control panel is a panel on the handle that contains controls (which may be buttons or configured a different way), that control the reel, the main wire group, and the container ball, and possibly other components. For example, in some of the first group of embodiments of the invention, the control panel contains a button (container control) that the user can press to activate the electromagnets in the container ball, a button that the user can press to wind the reel, extending the main wire group, another button that the user can press to retract the main wire group (these two buttons comprising the reel control), and a button (cord control) that the user can use to activate the mechanical component within the container connector device, pushing the two halves of the container ball together.

Embodiments of the invention using a handle and long rod will function without a control panel, as long as these embodiments include another method of controlling the reel, and of controlling the components that cause the container ball, sectioned container, or other container to close. For example, an embodiment of the invention could use controls that are buttons, mounted on the handle, to control these components, without these controls being part of a specific control panel.

Other controls can be located on the handle, in some embodiments. All of these controls can be located on the control panel, if there is a control panel, and if there is not a control panel, these controls can be located on the handle. For example, if an embodiment includes parameter influencers (12), controls for the parameter influencers (12), may be located on the handle. These controls will enable a user to decide, for example, that the user wants to alter the conditions inside a container attached to a container connection device, which is attached to the main wire group. If an embodiment includes a food compartment (15), a control for the food compartment can be located on the handle. If an embodiment includes a light, a control turning the light on or off, or specifying a brightness level for the light, can be located on the handle.

These controls can be dials, or buttons, or parts of a touch-sensitive screen(s). These controls may also take one of the other forms known in the prior art. For example, a control for the food compartment can be a button which the user presses whenever he or she wants the food compartment to open. The handle and control panel may be protected by a waterproof membrane, or have an outer layer that is otherwise waterproof, to protect them from water.

All digital gauges and all controls, and all touchscreens should be protected by a waterproof outer layer, regardless of whether the rest of the handle is so protected. The handle can function, but will be more vulnerable, if the digital gauges, controls, and touchscreens are not protected by a waterproof outer layer. Digital gauges and controls can theoretically be located in various parts of the invention, with some controls and/or digital gauges located on the handle, and some controls and/or digital gauges located on other parts of the invention, as long as A. Every digital gauge is able to receive information, either directly or indirectly, from the detector that detects the measured parameter that the digital gauge measures, and B. Every control is able to communicate with the item(s) it is supposed to control, for example, every control for a measured parameter influencer can communicate with the measured parameter influencer for that measured parameter.

The controls can operate, by being connected with the processor (13) located in the handle. When the user manipulates one of the controls, that control will communicate with the processor, and the processor will be programmed to use the main wire group to communicate, either directly or indirectly, with the component of the invention controlled by the manipulated control, and to command that component of the invention to execute the desired task. For example, if a container ball attached to the container connection device contains a food compartment, the user desires to open the food compartment, and the food compartment control is a button, the user can press the button, and the food compartment control will send a message to the processor (13) located in the handle. This processor will then send a message, via the main wire group, to the processor in the container connection device. This processor will then relay the message to the processor in the container ball. The processor in the container ball will then open the food compartment.

In addition, the handle can contain gauges, including analog or digital gauges that are in direct or indirect communication with the detectors. Digital gauges are more likely to be used. Each of these digital gauges may be in communication with one detector, and will display the current value of the parameter that this detector measures. These digital gauges can be simple displays. For example, the digital gauge in communication with the thermometer (the detector measuring temperature) will display the temperature measured by the thermometer.

The digital gauges can also be part of the control panel.

### The Faraway Program

The faraway program (11) is a computer program that can be used to view, and, in some cases, control, the measured parameters' values inside one, or a group of, containers. The containers can be in different locations, but all operatively connected to receivers and transmitters that are communicating with the faraway program.

Versions of the faraway program (11) are downloadable programs that can be used on a user's computer, tablet, cellular phone or other computing device in the manner of an “app”. Computers, tablets, cellular phones, and other computing devices are herein called “PCs” for short.

Versions of the faraway program can also be stored on any of the processors or memories within the invention, or any apparatus thereof (Such as a processor in a handle connected to a touchscreen in the handle, where the user interface will display information, or a processor in another type of assembly that includes containers, connected to a monitor that is also part of the assembly), or can be stored on a combination of those processors or memories in communication with each other, or on the cloud or internet, or any of the other methods present in the prior art. The faraway program can also be stored in a distributed fashion, wherein the resources of the PCs of multiple users are combined to execute the functions of the faraway program, especially the functions of updating the central lifeform database (50) and executing the functions of the central comparison module (51) when those are used.

Embodiments of the transmitters that directly or indirectly receive information from the detectors in containers and/or sectioned containers in the invention can communicate with whatever wireless network is available, and the wireless network will relay the message to the PC or other computing device(s) that is running the faraway program. The PC can also use the wireless network to communicate with receivers that transmit information directly or indirectly to parameter influencers that influence measured parameters in sectioned containers and other containers in the invention.

A command received by a receiver in one component of the invention and intended for a component with which that receiver is in direct or indirect communication will be transmitted (via wires, or wirelessly), to the appropriate component to execute that command. The commands can also direct for a measured parameter to be altered in a sectioned container or other container, for example, the commands can direct for the temperature control to be turned on, raising or lowering the temperature. A command can also direct for a food container to be opened, releasing food into a sectioned container or other container.

In most cases, a command will be transmitted from a receiver to a processor which can then cause the relevant components to act and fulfill the user's commands. For example, the processor can command the temperature control to start raising the temperature to a specific temperature level, which the user has indicated.

The faraway program will have at least the following components: A lifeform database, a sending module, a receiving module, and a comparison module. Most versions of the faraway program will also have a user interface.

The faraway program can be configured to communicate with only the receivers and transmitters in a specific individual apparatus of the present invention, or a specific sectioned container or other container, or a specific group of containers or sectioned containers, or a specific group of apparatuses that include sectioned containers or other containers. For example, the user can be required to enter the container ID, such as a serial number, for a sectioned container or other container into the user interface to allow the faraway program, after downloading, to communicate with that sectioned container or other container. Each transmitter in any apparatus can also be programmed to only emit transmissions that identify the serial number of that apparatus, or other characteristics such as an ID unique to that apparatus. A transmitter associated with a certain container can also be programmed to only emit communications that identify the serial number or other characteristics such as the container ID of that container. The invention can also use methods known in the prior art to ensure that each individual apparatus, sectioned container, or other container obeys only a specific user's commands, coming from that user's PC, that user's user II), or coming from a specific copy(s) of the faraway program.

The faraway program downloaded on a specific PC can also be programmed to only transmit communications that include an identification of a unique characteristic (such as a serial number) of each of the individual apparatuses that the user desires to communicate with, when the user desires to communicate with that individual apparatus, or only transmit along a certain frequency which is received by the receivers in one of those apparatuses. The faraway program downloaded on a specific PC can also be programmed to only transmit communications that include an identification of a unique characteristic, like a container ID, for each container that the user desires to communicate with, when the user desires to communicate with that individual container, or only transmit along a certain frequency which is received by the receivers in one of those containers.

For this application's purposes, a lifeform type which a user wishes to “target” is a lifeform type for which the user wants a range(s) of values to be retrieved (the optimal and/or tolerance ranges or range combination, or a goal ranges or range combination) for measured parameters for that lifeform type from the lifeform database, and the user also wants the comparison module or central comparison module to perform an action when one of the measured parameter values moves out of an optimal, tolerance, or goal range or range combination (whichever range combinations are retrieved and applied) for that lifeform type, in one of the containers with which the user's faraway program, and/or the central comparison module, is communicating. A user can target multiple lifeform types for multiple sectioned containers or other containers, by which the user retrieves the measured parameter goal, optimal, and/or tolerance ranges or range combinations for multiple lifeform types from the lifeform database, and the user commands the comparison module to perform an action when one of the measured parameter values moves out of different lifeform types' goal, optimal or tolerance ranges (whichever apply) in at least one container. In some embodiments, to be discussed later, a user can target multiple lifeform types for the same sectioned container or other container. These lifeform types should have at least parts of their tolerance ranges in common, or they will not be able to live in the same place, meaning they will usually not be able to live in the same container.

The receiving module will receive information broadcast by the transmitters in communication, directly or indirectly, with the detectors in the containers. The receiving module sends this information to the comparison module, and user interface, if present.

The sending module will send commands from the user, inputted into the user interface, and any commands from the comparison module or central comparison module (where used), to the receivers in the containers. The sending module will receive these commands from the user interface, comparison module, and central comparison module, respectively, and use wireless communication to send them, unless there is a wired connection between a component on which the sending module is running and these receiver(s). The sending module will send commands using a PC's wireless capabilities in many embodiments where it is running on a PC or group of PCs.

The user interface, in most embodiments will include the following, in versions of the invention where it is present. The user interface will include controls for each of the following measured parameters that is being measured by a detector, in each container with a transmitter communicating with that specific individual faraway program: Temperature, oxygen level, salinity level, nitrate and nitrate levels, chlorine level, and fluorine level. The user interface can include controls for, in some embodiments of the invention, these additional measured parameters measured by a detector, in each container with a transmitter communicating with that specific individual faraway program, and a detector measuring one of these additional measured parameters and communicating with the transmitter: Water pressure, air pressure, humidity in air, concentration of various minerals including, but not limited to, magnesium and iron, calcium, phosphorus, zinc, copper, manganese, iodine, and selenium, sodium and cadmium in water, oxygen concentration in air, CO₂ concentration in air, concentration of other gases in air, concentration of pollutant compounds, and concentration of various organic compounds, and light concentration. These controls will allow the user to broadcast commands for the parameter influencers in a specific sectioned container or other container to change the measured parameter values in that sectioned container or other container. The user interface in most embodiments will also include the ability to display the current value of each measured parameter being broadcast by a transmitter, and measured by a detector directly or indirectly connected to that transmitter, in each container with which that specific individual faraway program is communicating. It is important to note that these controls will only display the current value of a measured parameter in a container if there is a detector measuring that measured parameter's value in that container and the detector is connected to a transmitter that broadcasts the measured parameter's value. Likewise, these controls will only allow a user to command a parameter influencer in a container to change a measured parameter's value in that container if that parameter influencer is connected to a receiver that can receive the command, and the parameter influencer can influence that specific measured parameter.

The user interface in most embodiments also will also include controls for the food compartments in the containers with receivers, with which that specific individual faraway program is communicating. Each of these controls for a food compartment is a program component that will allow the user to electronically send commands to open or close that food compartment. Any such command to open or close a food compartment will be sent from the user interface to the sending module, and then to the receiver(s) connected to processor(s) that directly control that food compartment, or to receivers that directly control the food compartment.

The user interface in most embodiments can also include the following program components, for each apparatus communicating with that particular faraway program: A reel control for each apparatus with which the faraway program is communicating, that includes an internal or external reel, a cord control for each apparatus with which the faraway program is communicating, that includes a linking mechanism that can open or close a container directly or indirectly connected to a main wire group, and a container control for each apparatus with which the faraway program is communicating, that includes a sectioned container or other container that is opened or closed by electromagnets. The user interface in most embodiments may also include information the faraway program has received about whether motion sensors in apparatuses communicating with the user interface are detecting any nearby movement. Each time transmitters in an apparatus including a sectioned container or other container begin communicating with that particular copy of the faraway program, the particular faraway program will display the appropriate controls and current values of measured parameters for that apparatus and the containers that apparatus includes, using methods known in the prior art.

The user interface will allow the user to select a lifeform type presently inside each sectioned container or other container for which at least one transmitter is in communication with the faraway program, perhaps from a list of lifeform types in the lifeform database. The lifeform database will contain information about any known measured parameter optimal ranges, tolerance ranges, and/or goal ranges for the lifeform types on this list.

The user interface in most embodiments will also be able to show the known optimal and tolerance ranges, known goal ranges, length between feeding times if a lifeform type has known feeding times, and possibly other information for different lifeform types that the comparison module has retrieved from the lifeform database. The user interface can retrieve this information from the comparison module. In some embodiments, the user interface will only retrieve this information for a container after the user has selected the lifeform type(s) that the user wishes to target for that container. Alternatively, the user interface may query the lifeform database directly, and this information will be sent from the lifeform database to the user interface.

In some embodiments, the user may use the user interface to program the comparison module to send alerts to the user at certain times, such as “in 2 hours” or “at 6 PM”. In some embodiments, the comparison module may be able to utilize the timekeeping capabilities of the PC to know when to send alerts to the user. The user may use the user interface to program the comparison module to send an alert to the user when a measured parameter's value in one of the containers in apparatuses in communication with the faraway program moves out of the optimal, tolerance, or, if applicable, a specific goal range for one or more targeted lifeform types inside that container, or (in cases where this can be discerned), where one of the detectors in a container indicates that a measured parameter value is out of, the goal, optimal or tolerance (Or just optimal and tolerance) range for a targeted lifeform, type in part of that sectioned container or other container. Some versions of the faraway program will allow the user to select whether the alert will be sent when one of the measured parameters' value is outside the optimum range for that measured parameter, or whether it is outside the tolerance range for that measured parameter, or a specific goal range for that measured parameter, or both the optimal range and a specific goal range, or both the tolerance range and a specific goal range.

The commands that the user inputs into the user interface, which are to be executed in the future, can be sent to the comparison module, and each such command can be executed when the conditions precedent for that command have happened. The commands that the user inputs into the user interface, to be executed immediately, can be sent directly to the sending module to be sent to the apparatus containing the container(s) where the commands are to be executed, or, alternatively, can be sent to both the comparison module and the sending module, so that the comparison module has a record of the commands that the user has made via the faraway program.

The faraway program can then display the commands that were sent from the comparison module and/or sending module in the user interface.

Alerts may be auditory alarms, may be visual, or a combination of these, and/or of other attention-getting actions by the PC, or one of the other methods known in the prior art. The comparison module may also send a signal to a physical alarm device or alarm light to activate. The alarm device or alarm light may be located in one of the apparatuses in communication with the faraway program, or in a room where the user is located away from the containers, or elsewhere. The user can then take appropriate action, including commanding the measured parameter influencers in the apparatus that includes the sectioned container or other container where the measured parameter value(s) are out of the optimal or tolerance, or, if applicable, goal range to move the measured parameter(s) that are out of the optimal or tolerance or, if applicable, goal range back into the optimal or tolerance or goal range, respectively, or to change some of the measured parameter values in that container. An alert can keep alerting the user until the measured parameter value(s) that were out of the optimal or tolerance or goal range are back in the optimal or tolerance or goal range, respectively, or the alert can be more transitory. The user interface, in some embodiments, can be used to program the comparison module to use either one of these options.

In some embodiments, the user can also use the user interface to program the sending module to cause a sectioned container or other container to snap shut or stay shut automatically whenever a motion detector close to that container detects movement inside that container, or at another place where the motion detector can detect movement.

In some embodiments, the user interface will display values of the measured parameters on digital gauges. These digital gauges can be part of handles that are part of the invention, or can be elsewhere. In some embodiments, the user interface will function on one or more touch-screens on handles or other apparatus that is part of the invention to allow the user to select a type of lifeform which the user wishes to target, inside of one or more containers and/or sectioned containers in an apparatus of the invention.

Some embodiments of the invention may use transmitters, operatively connected to containers, that broadcast the measured parameter values in the containers in a manner which allows all nearby receiving modules to receive the measured parameter values in a way that allows these receiving modules to send the measured parameter values to the user interfaces to which they are connected, and for the user interfaces to display the measured parameter values. A user whose user interface is displaying these measured parameter values can also retrieve the optimal, tolerance, and any applicable goal ranges for a lifeform type that the user selects from the lifeform database. Then, the user will be able to, either by using a comparison module or central comparison module, or through observation, observe whether one of the measured parameter values being broadcast by the transmitters is out of the optimal, tolerance, or goal range for the lifeform type(s) in the container(s). Seafood markets may find this ability useful, because users will be able to quickly tell whether allegedly fresh seafood is being stored in the correct range of measured parameter values, and whether “live” seafood, such as live crabs, are being stored in appropriate ranges of measured parameter values, to keep them alive and to increase their chances of having desired culinary characteristics.

The lifeform database of the faraway program may also be programmed with specific limits for different measured parameters, for different lifeform types, such as the optimal and tolerance levels for different measured parameters (Preferably every known measured parameter optimal and tolerance limit), and known goal ranges, for multiple lifeform types. Examples are specific upper and lower limits on the temperature tolerance and optimal temperature range for a goldfish.

When a measured parameter's value inside a container is outside the tolerance or optimal range for that measured parameter, the faraway program will be aware of this, because the faraway program is continually receiving information about the measured parameters' values inside the containers with which it is communicating, from the transmitters receiving information from detectors that detect measured parameter values inside those containers.

The lifeform database, can also include information about the proper intervals between feedings, or intervals between providing other kinds of nutrition or care, for the lifeform types in the lifeform database. The lifeform database can also send the user interface a list of the lifeforms for which optimal, tolerance, or goal ranges for the measured parameters are recorded in the lifeform database, for the user to use the user interface to select from the list, and the range(s) that the user needs from the lifeform database. Alternatively, in some embodiments the user can input into the user interface the name of the lifeform type for which the user wants to retrieve tolerance ranges and the other above information, and the user interface can then send the lifeform type's name to the lifeform database, and the lifeform database will search for that lifeform type's name and send the applicable optimal, tolerance, and/or goal levels for that lifeform type to other components such as the user interface. The user can also input into the user interface the optimal, tolerance, or goal range combination(s) that the user wants to retrieve, and they will be retrieved from the lifeform database. Alternatively, in some embodiments once the lifeform database has found the optimal, tolerance, and/or goal range combinations for the lifeform type, the lifeform database may cause the user interface to give the user the option of which of these range combinations the user wants to use. The lifeform database will then send those range combinations to the appropriate components such as the user interface.

The optimal ranges for each measured parameter, for multiple lifeform types, can be programmed into the lifeform database, along with, and in addition to, the tolerance ranges for these lifeform types. If this information is programmed into the lifeform database, and one of the measured parameters moves out of the optimal range or tolerance range, the comparison module can inform the user interface, and can, in some embodiments, send an alert to the user interface, which the user interface will then make known to the user.

The comparison module, compares the measured parameters values being broadcast by transmitters directly or indirectly connected to the detectors to the optimal and tolerance ranges (And, in some embodiments, goal ranges) for the measured parameters for the targeted lifeform type(s), member(s) of which are inside the containers and/or sectioned containers.

The comparison module would operate the following way in some embodiments. The comparison module would receive, from the receiver module, the information being broadcast about the measured parameter values inside each of the containers. The comparison module would also receive, from the lifeform database, the optimal ranges and tolerance ranges, for the measured parameters, for the targeted lifeform type. In some embodiments, the comparison module will also receive, from the lifeform database, the goal ranges, for the measured parameters, for the targeted lifeform type. The comparison module would then compare the measured parameter values to the optimal, tolerance, and any goal ranges. If the actual value of one of the measured parameters in a sectioned container or container is outside the goal (if applicable), optimal or tolerance range for that measured parameter, for the targeted lifeform type, the comparison module can send an alert to the user interface, which will then inform the user of the alert.

In most embodiments, the comparison module can also be programmed (via the user interface) by the user to have an “automatic” mode, by which the comparison module, by itself, without human intervention, will do the following whenever it receives information that a measured parameter value in one of the sectioned containers or containers is out of the goal, optimal or tolerance range for a lifeform type targeted for that container: The comparison module would send the sending module a command for the parameter influencer(s) that influence those measured parameter(s) in the container that are outside the goal, optimal and/or tolerance ranges to alter those measured parameters, until these measured parameters are back within the optimal, tolerance, or goal range(s), respectively, for the targeted lifeform type inside that container. The sending module would then broadcast this command, and the command would be picked up by the receivers operatively connected to that sectioned container or other container.

In some embodiments the user would be able to use the user interface to program the comparison module, as part of the automatic mode, that, when a measured parameter level in a container moves out of the optimal range for a targeted lifeform type for that container, the comparison module should not broadcast a command for any parameter influencer to move the measured parameter back into the optimal range, but if the measured parameter level moves out of the tolerance range, the comparison module will broadcast a command for the relevant parameter influencer(s) to move the measured parameter back into the tolerance range, or optimal range (whichever the user wishes). The user would also be able to program the comparison module, as part of the automatic mode, that when the measured parameter level moves out of the optimal range, the comparison module will broadcast a command for the relevant parameter influencer(s) to move the measured parameter back into the optimal range.

As part of “automatic” mode, the comparison module may also send an alert or message to the user whenever the comparison module commands a parameter influencer in one of the containers to move a measured parameter's value back to the goal, optimal or tolerance range for a targeted lifeform type, and whenever the comparison module receives information, from one of the transmitters, that this measured parameter's value in that sectioned container is back within the goal, optimal or tolerance range for the targeted lifeform type.

In some embodiments, the comparison module can also send the other kinds of alerts described herein while in “automatic mode”.

The comparison module can also be designed to include an internal tinier. The timer can determine when is the appropriate time to feed the lifeform in each sectioned container or other container, based on the information about feeding times the comparison module has received from the lifeform database. The comparison module will then send the alert to the user interface at the appropriate time.

The comparison module can also be programmed via the user interface to, while in “automatic mode”, broadcast a command for one or more food compartments in a sectioned container or other container to open, releasing food, when the comparison module receives information, from the transmitters connected to that container, that one of the measured parameter values inside that container has reached a certain level.

In another version of the faraway program, there is another module, the handle control module, which can control the reels and other components in handles that are operatively connected to receivers with which a specific faraway program is communicating. The handle control module connects to the user interface and sending module, so that the user can utilize the user interface to command the components in each handle to act, for example, by commanding the reel in a handle to wind clockwise or counterclockwise. This command will be sent from the user interface to the handle control module, and from there to the sending module. This command will be broadcast by the sending module, and when the command is received by any of the receivers operatively connected to a processor, which controls the reel in that handle, the command will be sent, to the processor controlling the reel, which will cause the reel to move in the desired direction.

This is similar in concept to a faraway program running on the user's PC automatically controlling the measured parameter influencers.

The faraway program downloaded on a specific PC can also be programmed to only transmit communications that include an identification of a unique characteristic (such as a serial number) of the individual apparatus that the user desires to communicate with, or only transmit along a certain frequency which is received by that PC.

In another version of the invention, the lifeform database will be capable of connecting to wireless networks and downloading “updates” concerning the same types of information that the app saved on a user's PC can download in other versions of this embodiment of the invention. The lifeform database can be programmed to connect to a central website and download such updates, including updated optimal, tolerance, and goal ranges for lifeform types, with the permission of the user, in the manner that many “apps” receive updates from the “App Store” or “Google Store”.

In another version of the faraway program, the lifeform database will be stored remotely, while the other parts of the faraway program are stored on the PC. The modules of the faraway program stored on the PC will communicate with the lifeform database via the PC's remote capabilities, such as via cellular phone networks.

The faraway program can also theoretically receive “updates” and/or continuous new information which includes measured parameter goal, tolerance and optimal ranges and range combinations for additional lifeform types, or new information about the goal, tolerance and optimal ranges and range combinations of lifeform types that are already listed in the lifeform database, such as their tolerance and optimal ranges for additional measured parameters.

An embodiment of the faraway program could be designed where the comparison module commands the parameter influencers, and the food compartments, and where the comparison module does not send information concerning these actions, or warnings, to the user interface, but the inventors believe this will not be desired as much.

In still another embodiment, the user can change the optimal and tolerance levels for lifeform types in the lifeform database, however this ability will probably not be used often.

In still another embodiment the user can enter the goal, optimal and tolerance levels for the measured parameters that apply to some lifeform types into the lifeform database. This can be useful if the goal, optimal, or tolerance levels for a certain lifeform type are not already recorded in the lifeform database.

In still another embodiment, there are no pre-existing goal, optimum and tolerance levels for any lifeform type in the lifeform database, and the user must enter the goal, optimum and tolerance levels for each lifeform type into the lifeform database.

In some versions of the faraway program, the central lifeform database (51) serves as the lifeform database, and the central comparison module (50) serves as the comparison module. In those versions, the other components of the faraway program, such as the user interface, will communicate over the internet with the central lifeform database (51) the way they would communicate with a lifeform database, and will communicate with the central comparison module (50) the way they would communicate with a comparison module. This allows multiple users to make use of the same comparison module (The central comparison module) and the same lifeform database (The central lifeform database). For example, multiple users running faraway programs on their own PCs can utilize user interfaces, receiving modules, and sending modules running on their PCs, that communicate with a single central comparison module (50) and a single central lifeform database (51) on the internet.

In other embodiments, the central lifeform database (51) and central comparison module (50) can be stored on a cloud, and the other components of the faraway program, such as the user interface, will communicate over the internet with them, the way these components would communicate with a lifeform database and comparison module, respectively.

In other embodiments, the central lifeform database (51) is stored on the internet or on a cloud, and the other components of the faraway program, including the user interface and comparison module, will communicate with the central lifeform database (51) the way these components would communicate with a lifeform database.

In other embodiments, some or all of the components of the faraway program, particularly the central comparison module (50) and central lifeform database (51), can be distributed between a group of processors in multiple apparatuses, or between multiple PCs. This might improve functioning of the faraway program in certain circumstances, or improve the faraway program's fulfillment of users' goals.

In a variation of this, a group of processors in multiple apparatuses would run the faraway program and use it to control measured parameter values in sectioned containers and/or other containers that are components of those apparatuses. These processors would communicate with the central comparison module (50) and central lifeform database (51), and would use them as the comparison module and lifeform database, respectively. Once the user picks which lifeform type to target, this system can run, and keep the targeted lifeform(s) alive in the containers, with no or very little human intervention.

In other embodiments, all of the components of the faraway program will be online and will not be downloaded. The user will enter into the faraway program a unique ID for each of the apparatuses, and a container ID for each of the sectioned containers, or containers containing parameter influencers and/or detectors with which the user wishes the faraway program to communicate on behalf of the user. The faraway program's components will then interact with each other in the manner described elsewhere herein, and communicate with the receivers and transmitters in these apparatuses, sectioned containers, and other containers and broadcast the user's desired commands to them in the manner described herein. The commands will then be received by the receivers in these apparatuses, sectioned containers, and containers and fulfilled in the manner described herein.

In some embodiments, where multiple users share use of a central comparison module and/or central lifeform database, each user's goal ranges will only be visible to that user, meaning that the goal ranges the user has set, and the goals of those goal ranges, will only be visible to that user; For example, if one user has goal ranges for taste of salmon, with a goal of producing the best-tasting salmon, that user can program the goal ranges into the central lifeform database, and the central lifeform database will only send the goal ranges to that user and make them visible to that user.

In other embodiments, the user will not select the name of the lifeform type which the user wishes to target, but will take images of one or more of the individual lifeforms of that lifeform type, possibly by using a camera that takes pictures in visual light, and also taking an image of the lifeform(s) in another part of the electromagnetic spectrum, such as infrared or ultraviolet, and then using the combined images to identify the lifeform type using artificial intelligence. These images will then be sent to the lifeform database, which will identify the lifeform type based on the images.

In many of the embodiments described herein, each user should have a unique ID (The user ID). Each sectioned container, pocket ecosystem, or other container should have a container ID. Groups of users, and groups of groups of users, etc., should have group IDs.

### The First Group of Embodiments

Some embodiments in the first embodiment group involve the use of one or more sectioned containers (28) or other containers to hold lifeforms, and keep the lifeforms in conditions suited for them by controlling the measured parameter values inside the containers.

The containers will each generally have at least one means of opening and closing to trap lifeforms inside. For example, a sectioned container's wall can be divided into multiple sections, that can move apart or be pushed together through use of electromagnets, that are controlled from the cord control. The electromagnets in the sectioned container will be located in the of the sections' walls, close to the sections' surfaces. The electromagnets will be placed in positions where at least one pole of each electromagnet will be pulled, by magnetic force, closer to an oppositely charged pole of another electromagnet, when the electromagnets are activated. This will close the sectioned container, or keep it closed if it is already closed. The same methodology can be used to open and close other containers, with electromagnets being placed in the container's walls, and where at least one pole of each electromagnet will be pulled, by magnetic force, closer to an oppositely charged pole of another electromagnet, when the electromagnets are activated. Oppositely charged electromagnets, drawing sections of the container's outer wall together, can shut openings in the container's outer wall.

Other methods can be used to open and close a sectioned container or other container. For example, a linking mechanism can be used to open or close a container. Every method listed in U.S. Pat. No. 10,743,525 can be used to open or close a container. All other methods listed in the prior art can also be used to open or close a container.

Each sectioned container (28) or other container includes one or more parameter influencers (12) and one or more detectors (10), and at least one receiver (16) and/or transmitter (17). Each container should preferably include a measured parameter influencer (12) for each measured parameter for which that container includes a detector (10). The container can also have a transmitter (17), directly or indirectly connected to the detectors (10) so that the detectors can send the measured parameters' values to the transmitter, as the measured parameter values change, and the transmitter can send this information to a faraway program (11) or a central comparison module (50). The container can also include a receiver (16), which receives commands from a faraway program (11) or a central comparison module (50). The receiver (16) will be directly or indirectly connected to the parameter influencer(s) (12), and will transmit commands from the faraway program or central comparison module (50) to each parameter influencer (12), causing that parameter influencer (12) to raise or lower the value of a measured parameter that it influences, when the value of that measured parameter moves out of a specified goal, optimal, or tolerance range.

The containers will each have a container ID, and the wireless broadcasts sent from the transmitters in each container will identify that container. One way to do this is for the wireless broadcasts sent from the transmitters in each container to include the container ID of that container. The comparison module can then “know” which container has certain measured parameter values.

In some embodiments, the central comparison module (50) will operate as the comparison module. The transmitters in a plurality of containers will wirelessly broadcast the measured parameter values in those containers, and these measured parameter values will be sent over the internet to the central comparison module (50). The central comparison module (50) will retrieve, from the lifeform database, the optimal and tolerance, and if applicable goal, ranges and range combinations for the measured parameters for a targeted lifeform type, where one or more individuals of the targeted lifeform type live within the containers. The central comparison module will also compare the measured parameter values it is receiving from the transmitters in the containers to the optimal and tolerance (and if appropriate, goal) ranges for the lifeform types in those containers. If the value of a measured parameter inside one of the containers moves out of an optimal, tolerance, or, if applicable, goal, range for the lifeform type, targeted by the user, the central comparison module (50) will detect this and broadcast a command that the parameter influencer(s) responsible for influencing that measured parameter, in that sectioned container or other container, should move the measured parameter's value back into the optimal, tolerance, or goal range, respectively.

In some embodiments, the comparison module will be a part of the faraway program (11) being run on the user's PC or a computing device that is part of one apparatus.

In some embodiments, the user will input the name of, or another identifier for, the lifeform type, which the user wishes to target, into a user interface of the faraway program running on a PC, or into a user interface of the faraway program running on another computer input device operatively connected to the same apparatus as one or more of the containers (Such as a touchscreen similar in concept to a touchscreen that could be placed on the handle in some embodiments of the invention of U.S. Pat. No. 10,743,525), or to another kind of computer input device which can send input to the comparison module. The identity of the lifeform type to be targeted will be transmitted to the comparison module, so the comparison module will retrieve the optimal and tolerance, and, if applicable, goal ranges and range combinations for the measured parameters for that lifeform type, from the lifeform database. This is also true in embodiments where the comparison module is a central comparison module and the lifeform database is a central lifeform database.

In all embodiments involving a central comparison module (50) and/or central lifeform database (51), a single user does not necessarily control all the containers in operative communication with the central comparison module (50). A user can have multiple containers operatively communicating with, with receivers receiving commands from, and transmitters sending data to, the same faraway program. Multiple such users can have their faraway programs communicate with, and use, the same central comparison module. The central comparison module and central lifeform database do not need to be “controlled” by any of these users. Data from the users who are using the containers does not need to be shared between those users. Data from the containers does need to be shared with the central comparison module, for the central comparison module to send commands to those containers. This may produce better functioning in some ways, such as helping the central comparison module to be updated more quickly.

Likewise, under the same conditions, a user can have transmitters in multiple containers operatively communicating with the same faraway program, and multiple such users can have their faraway programs communicate with, and use, the same central comparison module and the same central lifeform database.

In some embodiments, the central comparison module and the lifeform database, or just the lifeform database, can be distributed between processors in multiple apparatuses, controlled by one user or controlled by multiple users.

In some embodiments, multiple processors and/or PCs that are physically close together will communicate wirelessly and “share” the operations of their comparison modules and lifeform databases, by dividing the operations of their comparison modules and lifeform databases between them. When the processors and/or PCs move apart, the processors and/or PCs will form new connections with other PCs and processors that are now close to them, and share the operations of their comparison modules and lifeform databases by dividing the operations of their comparison modules and lifeform databases in the same way.

In some embodiments, the user will be able to input, into the user interface, multiple lifeform types that the user wants to target, for each sectioned container or other container in a group, or for all the containers in a group. These lifeform types will all be transmitted to the comparison module. The comparison module will then retrieve the optimal and tolerance ranges for all the lifeform types which the user wishes to target, from the lifeform database. The comparison module will then try to identify common parts of the tolerance ranges for each measured parameter for all lifeform types, which the user wishes to target for each container. For example, if the user wants to target Species I and J for the same container, and Species I has a tolerance range of 18-30 degrees Celsius, and Species J has a tolerance range of 28-31 degrees Celsius, the comparison module will retrieve the temperature tolerance ranges for both Species I and Species J and identify 30-31 degrees Celsius as the parts of the temperature tolerance range Species I and Species J have in common. The comparison module will also try to identify common parts of the optimal ranges for each measured parameter for all lifeform types, which the user wishes to target, and parts of the optimal range of one lifeform type that are parts of the tolerance range for the same measured parameter for a different lifeform type.

Alternatively, the central comparison module can be used instead of the comparison module, and the central lifeform database can be used instead of the lifeform database.

In some of these embodiments, the user will also be able to input goal ranges, into the user interface, for one or more lifeform types that the user wants to target, for each sectioned container or other container in a group, or for all the containers in a group. The comparison module will then try to identify parts of the goal ranges for each lifeform type for which the user specified goal ranges, that are in common with the tolerance and optimal ranges for other targeted lifeform type(s) in the same container.

In some embodiments the comparison module may also “prioritize” the parts of the ranges for each measured parameter which have the highest “point” score, by adding up the number of points for each part of a measured parameter range where X=no. of lifeform types user is targeting for a specific container, parts of optimal ranges that two targeted lifeform types have in common are given B points, parts of the optimal range of one targeted lifeform type in common with parts of the tolerance range for another targeted lifeform type are given D points, and parts of the tolerance ranges that two targeted lifeform types have in common are given F points, where B,D, and F are numbers, and B>D>F. The highest score possible for a part of a range of a measured parameter would be BX. If B=4, D=3, and F=2, the highest score possible for a part of a range of a measured parameter would be 4×. If the number of lifeform types being targeted is 5, the highest score possible is:
4×5=20.

This priority system can be expanded to include goal ranges, in some embodiments, where parts of a goal range for one targeted lifeform type that are in common with optimal and tolerance ranges for the same measured parameter, for another targeted lifeform type in the same container, are given a certain number of points. For example, parts of a goal range for one targeted lifeform type that are in common with the optimal range for the same measured parameter, for another targeted lifeform type in the same container could be given A points, and parts of a goal range for one targeted lifeform type that are in common with a goal range for the same measured parameter, for another targeted lifeform type in the same container could be given C points, and parts of a goal range for one targeted lifeform type that are in common with a goal range for the same measured parameter, for another targeted lifeform type in the same container could be given E points, where A>B>C>D>E>F.

Then, when a transmitter in any sectioned container or other container in the group broadcasts the measured parameter value, inside that container, the comparison module will compare the measured parameter value received from the transmitter to the parts of the range of each measured parameter which have the highest point number, and keep the measured parameter within that part of the range.

Alternatively, in other embodiments, the comparison module can compare the measured parameter value received from the transmitter to the common parts of the tolerance ranges if they exist, or the common part of the optimal ranges if they exist, or the parts of the optimal range for one lifeform type that are within the tolerance ranges for other lifeform types being targeted, depending on which system is being employed. The goal ranges for targeted lifeform types can also be factored into this, as explained above. If the measured parameter value received from the transmitter inside a container is outside the range to which the comparison module is comparing it, the comparison module will broadcast a signal that the relevant parameter influencer(s) inside that container should move that measured parameter value, inside that container, back within the range to which the comparison module is comparing it. For example, if the measured parameter value received from the transmitter inside a container is outside the range with the highest point total, the comparison module will broadcast a signal that the relevant parameter influencer(s) inside that container should move that measured parameter's value, inside that container, back within the range with the highest point total.

In some embodiments the user can use the faraway program (11), running on a PC such as a cellular phone, and including a comparison module and lifeform database, to communicate with the detectors and parameter influencers in multiple containers. The user would use the user interface to pick a targeted lifeform type for each of the containers (Not necessarily the same targeted lifeform type for all of them). The user would previously have had to input container IDs for each of the containers into the user interface of the user's faraway program, and most embodiments would require the user to pass other security measures, to communicate with transmitters and receivers in each of the containers. The container IDs and results of the other security measures will be sent to the sending module, so that the sending module can configure the commands that it causes the PC to broadcast, so that the processor(s) in each specific container that the user wishes to command will interpret commands broadcast by PC and intended for that container as intended for that container.

The transmitters in each container would send the measured parameter values in that container to the faraway program's receiving module, which would send them to the comparison module. The comparison module would retrieve the optimal, tolerance, and, if applicable, goal ranges for each of the targeted lifeform types from the lifeform database. When a measured parameter's value, in a container, moves out of the optimal or tolerance, or, if applicable, goal range for a targeted lifeform for that container, the comparison module will send the sending module a command, to broadcast, for the parameter influencer(s) in that container to move the value of that measured parameter back into the optimal, tolerance, or, if applicable, goal range, respectively. The sending module will then broadcast the command. The containers will include receivers, so the receivers in the relevant container will receive the command.

In some embodiments, the central lifeform database (51) will serve as the lifeform database, and the other components of the faraway program will communicate with the central lifeform database in the way that they would communicate with the lifeform database, but the central comparison module (50) will not serve as the comparison module. Instead, the faraway program's comparison module will serve as the comparison module.

In some embodiments, especially those involving very large containers and/or sectioned containers, the specific parameter influencer(s) that are in the same container as, and that are located closest to, the specific detector, which detected the measured parameter level outside of the desired range (optimal, tolerance, or a goal range), shall be the parameter influencers that move the measured parameter level back within the desired range. That way, if a measured parameter level is outside of the desired range in only the part of the container near to that specific detector, the parameter influencer that is commanded to move that measured parameter level back to the desired range will be in the part of the container where that measured parameter level is out of the desired range. In very large containers, there is more of a chance of measured parameter levels varying between different parts of the interior space containing the lifeforms.

This design might allow for measured parameters to be kept within desired optimal, tolerance, and goal ranges more cheaply. In these embodiments the parameter influencers and detectors would each have Sensor IDs. The Sensor IDs of the detectors that detect measured parameter values, along with the measured parameter values they detect, would be broadcast by the transmitter(s) in each container, and the central comparison module or comparison module would pick and then broadcast the Sensor IDs of the parameter influencers that should move a measured parameter value back within the desired range when that measured parameter value is out of the desired range. Such a system could be simplified by making the Sensor ID of each detector, and the Sensor ID of the parameter influencer, closest to the detector, that influences the same measured parameter that the detector detects, variations of each other, where the relationship between the 2 Sensor IDs is based on rules programmed into a component of the faraway program (such as the comparison module), or another program component of the invention, such as the central comparison module being used by the faraway program. That way, the central comparison module would be able to broadcast a signal that includes enough information to identify the specific parameter influencer that needs to be activated.

In another group of embodiments, the sectioned container or other container will include multiple container latches (39) that will allow the container to be attached to a container connection device (5), or detached from the container connection device (5). The container can then be left by itself or attached to something else. In some variations of this group of embodiments, the container latches will be designed so that if they are used to attach the container to the container connection device, then the container will be held close enough to the container connection device so that, even if the container is underwater, that any transmitters in the container will be able to communicate wirelessly with receivers in the container connection device, and any receivers in the container will be able to communicate wirelessly with transmitters in the container connection device.

In those embodiments where the container can be connected or disconnected from the container connection device, the container can be connected, held to, and disconnected from the container connection device by any of the methods known in the prior art, a combination of such methods, a combination of the methods that are part of this patent application, or a combination of methods known in the prior art and methods that are part of this patent application.

In all embodiments using transmitters in a container and receivers in the container connection device, or using receivers in a container and transmitters in the container connection device, the container and container connection device should be connected in a manner that forces these transmitters and receivers to be close together, preferably less than 0.5 cm apart. This is important for wireless transmission between them, especially if the area between the container and container connection device is submerged in water.

In some embodiments, the container will include a battery, which will provide power to the container's electrical components, including, but not limited to, any processors or alert lights in the container. This will allow the measured parameters to be influenced, for longer, by the parameter influencers in the container.

In some embodiments, a sectioned container will be connected directly to the main wire group without a container connection device in between. Wires from the main wire group will go into the container, and will power electromagnets or a linking mechanism that will open and close an opening in the container.

In some embodiments, there will be an alert light that will flash whenever one of the measured parameters in a sectioned container or other container is out of the optimal or tolerance, or, if applicable, goal range. This alert light can be connected to a processor, to which the detectors in that container are connected. The alert light can also be connected directly to one or more parameter detectors in a way that will allow the alert light to activate automatically when one of these parameter detectors detects a measured parameter value that is out of the tolerance, optimal or, if applicable, goal range.

In some embodiments, the detectors will be connected directly to transmitters, and the parameter influencers will be connected directly to receivers, without an intervening processor.

In some embodiments, the sectioned containers and other containers will have receivers but not transmitters. They will therefore be able to receive commands but not broadcast information about measured parameter values inside the containers.

In some embodiments, the sectioned containers and other containers will have transmitters but not receivers. They will therefore be able to broadcast measured parameters' values inside the containers but not receive commands.

Some embodiments of the invention can be used as jewelry or other wearable containers, or as fashion accessories or decorations in the home or elsewhere. These embodiments would include lifeforms inside the wearable containers. The wearable containers include wearable sectioned containers. These embodiments should preferably utilize a transparent sectioned container or other container so that viewers can see the lifeforms inside the container. For example, an embodiment including a container, and including one or more lifeforms such as plants or animals, and including three detectors, and including three parameter influencers for the same measured parameters detected by the detectors, can be used as a broach or the pendant or centerpiece of a necklace, or included as a part of an article of clothing.

Embodiments, including lifeforms, can also be used as other types of jewelry or fashion accessories, or decorations in the home or elsewhere. Some of these embodiments can include fewer or more than three detectors, all directly or indirectly connected to a transmitter(s), and fewer or more than three parameter influencers, all directly or indirectly connected to a receiver(s).

The sectioned containers and other containers may also include lights, bait, or holes of the types discussed in the 3^{rd}-4^{th}, 6^{th}-7^{th} and 12^{th} embodiments of the invention of U.S. Pat. No. 10,743,525, small holes of the types discussed in the 5^{th} embodiments of the invention of U.S. Pat. No. 10,743,525, a hollow long rod of the types discussed in the 8^{th} embodiments of the invention of U.S. Pat. No. 10,743,525, transparent components of the types discussed in the 9^{th}-10^{th} embodiments of the invention of U.S. Pat. No. 10,743,525, an external reel of the type discussed in the 11^{th} embodiment of the invention of U.S. Pat. No. 10,743,525, and food compartments of the type discussed in the 15^{th} embodiment of the invention of U.S. Pat. No. 10,743,525.

The sectioned containers and other containers may also include controls on the handle that are not a part of a specific control panel, of the type discussed in the 13^{th} embodiment of the invention of U.S. Pat. No. 10,743,525.

The sectioned containers and other containers may also include extensive solar cells coating other physical components, of the types discussed in the 16^{th} embodiment of the invention of U.S. Pat. No. 10,743,525. These solar cells can each be operatively connected to any of the components that requires electrical power, or to batteries, that are operatively connected to any of the components that requires electrical power.

The sectioned containers and other containers may also include linking mechanisms of the types discussed in U.S. Pat. No. 10,743,525. A linking mechanism would force the sections of the sectioned container together and close the gaps between them, or open them. A linking mechanism would also close a container, or open it.

The sectioned containers and other containers may also vary substantially in size. For example, a group of large, non-portable, containers, each including detectors and parameters, can be used commercially to raise a large number of shrimp, fish, or some other type of commercially farmed organism.

Some types of measured parameters, including compounds such as certain proteins, or proteins in general, may be indications of an amount of a lifeform type's “food” that is in water. This may be true of filter-feeding organisms in particular. A compound could be an “indicator” of the concentration of an organism's food, without being food by itself, if the compound is correlated to something else that is the organism's food. For example, concentration of a compound could be correlated to concentration of plankton, which many filter-feeders eat. Light absorption, in the right circumstances, could be correlated to plankton concentration. A user may include detectors that detect the amounts of compounds in water, or the amount of light in water, if the compound concentration or light absorption is related to concentration of plankton or another type of food eaten by an aquacultured organism, and the user is trying to discern whether the water contains enough concentration of that food or light. These parameter detectors would directly or indirectly connect to a transmitter which would transmit the information the detectors have detected. A user may also include food compartments in the sectioned containers or other containers, controlled by a faraway program or central comparison module, to release food when the concentration of a compound indicating presence of food gets too low, or amount of light being absorbed gets too low.

A user can also use a similar principle in a home aquarium that is also a container, by using a detector, operatively connected to a transmitter, to detect the presence of a compound that indicates the presence of food for the organisms living in the aquarium. The transmitter will broadcast transmissions showing the compound's concentration, and these transmissions will be received by a faraway program or central comparison module. Then, when the compound's concentration gets too low, a faraway program or central comparison module will send a command to a receiver in that aquarium to release food. The receiver will be connected to a processor, which will be connected to a food compartment, which will cause release of the food, or in some embodiments the receiver will simply be directly connected to the food compartment and will cause release of the food directly.

Embodiments of the invention can also include a temperature control mechanism as part of the temperature parameter influencer for water, or a temperature control mechanism as part of the temperature parameter influencer for air, that can increase or decrease the water or air temperature, respectively, within the sectioned container or other container. Embodiments can also include a Ph control that contains a small amount of a solution that can be released into the pocket ecosystem or other container as part of the Ph parameter influencer to raise the Ph inside the water in the container, and another solution as part of the Ph parameter influencer that can be released into the pocket ecosystem or other container to lower the Ph inside the pocket ecosystem or other container. Embodiments can also include a salinity control as part of the salinity parameter influencer that contains a small amount of a solution that can be released into the container to raise the salinity inside the water in the container, and another solution as part of the salinity parameter influencer that can be released into the container to lower the salinity inside the water in the container. Embodiments can also include an oxygen control as part of the water oxygen level parameter influencer that contains a small amount of a solution that can be released into the container to raise the dissolved oxygen level inside the water in the container, and another solution control as part of the water oxygen level parameter influencer that can be released into the container to lower the dissolved oxygen level inside the container. The oxygen level might be lowered by the solution binding to the dissolved oxygen, for example. The water oxygen level parameter influencer might include a small air diffuser, or a small aerator which pumps air in from outside and/or then pumps it out again. The water oxygen level parameter influencer can theoretically include a small pump that pumps more oxygen-rich water in from outside, and pumps an equal amount of the water inside the container outside, however this would only be useful when the container is next to water. Any air diffuser or pump could be powered by a battery in the container, any attached container connection device, or a battery elsewhere that is connected to the oxygen control.

Some embodiments can also include a chlorine control, as part of a chlorine parameter influencer, that releases a solution to dechlorinate the water in the pocket ecosystem or other container when needed.

### Some Other Embodiments in the First Group of Embodiments

In other embodiments, the comparison module or central comparison module can have the ability to keep the measured parameter ranges in a sectioned container or other container within different goal ranges or range combinations at different times, on a pre-arranged schedule programmed into the comparison module. The comparison module would command parameter influencers in the sectioned container or other container to move a measured parameter's value back into one range, if it moves out of that range, at certain times, and to move the measured parameter's value back into a different range, if it moves out of that range, at different times. This might be useful, among other purposes, if a group of organisms have different needs at different stages in their life cycles, or if the user wants to vary measured parameter values to kill disease-causing organisms that are more vulnerable to measured parameter changes, while allowing larger, desired organisms that are less vulnerable to measured parameter changes to survive.

A user also may want to control measured parameters within the sectioned containers or other containers that contain aquacultured organisms, for the purpose of keeping the measured parameters within a “goal range combination” that optimizes the taste of the organisms inside the sectioned containers or other containers, or optimizes the size of each organism (In some cases), or optimizes some other quality related to the organisms' value for aquaculture. If the user wishes to optimize for taste, the user should have at least a general idea of which measured parameter range combinations tend to produce members of the lifeform type that taste the best; For example, the user can use a customer survey of aquacultured organisms raised while being exposed to multiple measured parameter value range combinations to decide which measured parameter value range combination produces the “most tasty” organisms.

A user may also try to develop a selected strain of aquacultured organisms by raising a group of aquacultured organisms in a certain measured parameter value range combination that only some of the organisms will survive, and then breeding the survivors, raising the offspring in the same measured parameter value range combination, etc.

Similar techniques may also help users to develop aquacultured organism strains that can withstand climate change better, by withstanding changed aquatic conditions that resulted from climate change.

In some embodiments, all the measured parameter values broadcast from transmitters in, or operatively connected to, sectioned containers and other containers, and received by a faraway program and/or central comparison module will be saved in a database.

### The Second Group of Embodiments

The second group of embodiments involves the use of one or more pocket ecosystems, equipped with detectors (10) and measured parameter influencers (12). The pocket ecosystems can be considered a type of “container”, as described elsewhere in this application. Alternatively, for some uses, sectioned containers or other containers, equipped with parameter influencers, detectors, transmitters, receivers, and possibly processors, can take the place of some or all of the pocket ecosystems. Each pocket ecosystem will include at least one detector, one measured parameter influencer, and at least one receiver connected to the parameter influencer(s) and one transmitter connected with the receiver(s). There will also generally be at least one processor connected to the parameter influencer(s) and detectors, receivers and transmitters.

Some differences between a pocket ecosystem and a “regular” sectioned container or other container are that a pocket ecosystem is more designed for visual observation and for users to observe the interaction of species in the pocket ecosystem in ways that might be unpredictable. Student observers can therefore learn, and add to our body of knowledge, by observing the interplay of species and conditions. Some of the methods of using embodiments involve helping the students to learn.

The user will easily be able to record the user's observations and make them available for other users to use for learning and examination, through a form of “crowdscience”. Users may also be able to, individually or as a group, discover new information about lifeform types, such as previously unknown optimal and tolerance values, or goal ranges for specific goals, for lifeform types.

In some embodiments, users, who may be students or others, observe the lifeforms in the pocket ecosystems, or other containers, and take notes, preferably using PCs (30) that are running note-taking programs (31). The detectors (10) in the pocket ecosystems and other containers measure the measured parameter values in the pocket ecosystems and other containers, and transmit these values wirelessly, so that a nearby student's PC (30) can receive these values, and display them on the PC's screen(s), possibly using the faraway program (11). Each student can also use the measured parameter influencers (12) in the pocket ecosystem(s) and other container(s) that the student is monitoring to alter those measured parameters in the pocket ecosystem(s) and other container(s), so the students can record the results. Each measured parameter influencer (12) would only be able to influence measured parameter(s) in the pocket ecosystem, or other container where that parameter influencer (12) is located.

An online report's “subject” is the container that the user observed, and recorded the user's observations in the online report (26).

The observing users' note-taking programs (31) send the notes automatically in the form of online reports (26) over the internet to the research processing module (32), which logs a copy of each user's “online report”, with the name of the user who gave the online report (if desired by the user), a user ID for that user, and the dates, and times, that the online report was started and submitted, and in some embodiments, the location that the online report (26) was transmitted from, into a research corpus (33). The research corpus is a compilation of all online reports. In most embodiments, the research corpus will be saved on some form of computer memory storage. Any form of computer memory storage known in the prior art can be used for this. Each user can, and preferably should, send multiple online reports over time.

The transmitters (17) in the pocket ecosystem or other container are also continually transmitting the measured parameter values inside that pocket ecosystem or other container. These values are broadcast wirelessly and transmitted over the internet to the research processing module (32), which saves them in the research corpus (33). The research processing module (32) also associates the measured parameter value measurements from each pocket ecosystem or other container with the online reports (26), based on observations of that pocket ecosystem or other container, that were broadcast between the time the online report was started and the time the online report was submitted. The online reports will have the pocket ecosystem or other container's container ID, which will help the research processing module (32) to associate the above-mentioned measured parameter value measurements and online reports. This will allow the relationships between measured parameter values in the pocket ecosystem or other container and the behavior, characteristics, and well-being of the lifeforms in the pocket ecosystem or other container, and also relationships between measured parameter value changes and changes in the lifeforms in the pocket ecosystem or other container to be analyzed later.

In some embodiments, users can use their faraway programs to cause the measured parameter influencers in those users' pocket ecosystems and/or other containers to be commanded by the users' comparison modules, or by the central comparison module. Each user can then observe A. The behavior, wellbeing, and characteristics of the lifeforms in the user's pocket ecosystems and/or other containers when those lifeforms experience different measure parameter value combinations, and B, how these lifeforms' behavior, wellbeing, and characteristics changes as measured parameter values change. Each user can then create and submit appropriate online reports describing this information.

In some embodiments, the central comparison module, or the user's faraway program's comparison module can also “automatically” control measured parameter values by causing parameter influencers in pocket ecosystems or other containers to move the measured parameter values, and not keep them within any optimal or goal range. Each user can then observe A. The behavior, wellbeing, and characteristics of the lifeforms in the user's pocket ecosystems and/or other containers when those lifeforms experience different measured parameter value combinations, and B, how these lifeforms' behavior, wellbeing, and characteristics change as measured parameter values change. Each user can then create and submit appropriate online reports describing this information.

In some embodiments, each user can use that user's faraway program to command the parameter influencers in each pocket ecosystem(s) and/or other container(s) that user controls to change the measured parameter values in that pocket ecosystem or other container. Each user can then observe A. The behavior, wellbeing, and characteristics of the lifeforms in the user's pocket ecosystems and/or other containers when those lifeforms experience different measure parameter value combinations, and B, how these lifeforms' behavior, wellbeing, and characteristics changes as measured parameter values change. Each user can then create and submit appropriate online reports describing this information.

In some embodiments, the user's faraway program will use the central comparison module and the central lifeform database as the comparison module and lifeform database, respectively, and will broadcast commands for the parameter influencers in each of the user's pocket ecosystems and other containers to change one of the measured parameter values inside that container when the central comparison module concludes this is necessary to keep that measured parameter's value within the optimal, tolerance, or, if applicable, goal range. Each user can then observe A. The behavior, wellbeing, and characteristics of the lifeforms in the user's pocket ecosystems and/or other containers when those lifeforms experience different measure parameter value combinations, and B, how these lifeforms' behavior, wellbeing, and characteristics changes as measured parameter values change. Each user can then create and submit appropriate online reports describing this information.

When a group of students is using the pocket ecosystems and/or other containers, an administrator or teacher, acting as a “group leader”, can use the viewing module to view which of the students have submitted online reports, either in total or during a certain time period, or other information about the online reports and patterns of who turned them in, and when.

In some embodiments, the user will also be able to download or otherwise save, for analysis, all the measured parameter values from pocket ecosystems, sectioned containers or other containers, that the user has registered, whether or not these measured parameter values are associated with an online report.

The notetaking app (31) may be a module of the faraway program, in some embodiments.

In some embodiments, users will also be able to use their faraway programs (11) to command and get data from more than one pocket ecosystem and/or other container (such as a sectioned container), in the same way that a user could command and get data from more than one container in the first group of embodiments. When the user wishes to command a parameter influencer in one of these pocket ecosystems or other containers, the user will use the user's faraway program (11) to specify which of the containers, includes the parameter influencer which the user is commanding.

In some embodiments, the research processing module will also associate the measured parameter values that the research processing module received from each container during a certain length of time before an online report (26), of which that container is the subject, is started, and/or after the time when the online report (26) is submitted, with that online report. For example, the research processing module might associate the measured parameter values from the 5 minutes before the online report (26) is started, or the measured parameter values from the hour before the online report (26) is started, with that online report (26).

In some embodiments, the note-taking program will automatically place A. The user ID of the user that submitted the online report, B. Group IDs of any groups of which that user is a part, and C. The container ID for the pocket ecosystem or other container that was the online report's subject, in each online report when the online report (26) is submitted. One way, but not the only way, in which this can be done, is for these three pieces of information to be saved in the note-taking program on the user's PC ahead of time, and the online program will include these three pieces of information in the online reports (26) sent from the user's PC. If a user using one of these embodiments also uses multiple pocket ecosystems or other containers, the user will have to indicate which pocket ecosystem or other container is the online report's subject before, or at the same time as, the user's submission of the online report.

In some embodiments, the note-taking app (31) is part of the faraway program (11).

The data gathered and saved in the research corpus (33) will help researchers understand how lifeform types react to different measured parameter ranges, and will also help researchers to find goal ranges, and optimal and tolerance ranges, for lifeform types where these ranges are presently unknown. Each user has access to the entire research corpus (33).

This methodology will also help students who submit online reports to feel like something “larger than themselves”, to reduce “climate change anxiety” and “eco-anxiety”, and to directly help reduce the negative effects of climate change, by gaining information about different species, which humanity can use to help those species survive through climate change.

In some embodiments, each user will also be able to download or otherwise acquire, from the research corpus (33), copies of the measured parameter values broadcast by transmitters in containers that the user has previously registered. The user could do this by placing the identifier (Such as a container ID) for each individual container the user has registered in the user's note-taking program (31), and causing the note-taking program to transmit this information to the research processing module (32). The note-taking program can be designed to automatically transmit this information to the research processing module (32), or to transmit the container ID for the container that is the subject of each online report with that online report. The research processing module (32) will then save this information in the research corpus (33).

This methodology, and the other methodologies discussed herein, will also help users to identify sources of abiotic stress to lifeform types, that may result from climate change. These methodologies will also help users detect unforeseen ways that measured parameter value changes, different measure parameter value combinations, and climate change (Which, by definition, involves measured parameter value changes like temperature change, and changes in different measure parameter combinations to which lifeform types are exposed) affect lifeform types in hard-to-foresee ways, such as climate change making it harder for a lifeform type to perform behaviors that it performs instinctively, or climate change affecting the nutrient-related costs, or energy costs, of a lifeform type's actions, affecting the lifeform type's survival chances.

### The Third Group of Embodiments

Many embodiments use the idea that as measured parameter values change, the behavior, wellbeing, and characteristics of lifeforms experiencing those measured parameter values will change. Therefore, the words observers (such as users) use to record the lifeforms' behavior and characteristics will change. This change can be detected through text analysis, and through comparing the distribution of words that users use to record the lifeforms' behavior, wellbeing, and characteristics when the lifeforms are experiencing one measured parameter value combination, versus the distribution of words that users use to record the lifeforms' behavior and characteristics when the lifeforms are experiencing a different measured parameter value combination. By accumulating enough written observations (here the written observations are in the online reports (26)) of how members of a lifeform type react to different measured parameter value combinations and changes in measured parameter value combinations), and examining the word distributions in the observations and how these word distributions change as measured parameter values change, we can learn more about how lifeform types' behavior, wellbeing, and characteristics change as measured parameter values change, and how lifeform types respond to different measured parameter value combinations. This is useful for learning more about lifeform types, including lifeform types that we know little about, and about how the lifeform types react to in measured parameter value combination changes, such as climate change.

In some embodiments, users, who may be students or others, observe the lifeforms in the pocket ecosystems, and other containers, and take notes, preferably using PCs (30) that are running note-taking programs (31). The detectors (10) in each pocket ecosystem and other container measure the measured parameter values in that pocket ecosystem or other container, and the transmitter(s) operatively connected to those detectors transmit these values wirelessly, so that the receiving module of a faraway program (11), or a note-taking program (31) running on a nearby user's PC (30) can receive and display them. Each student or other user can also use the measured parameter influencers (12) in each of the pocket ecosystem(s) and other container(s) that the user is monitoring to alter those measured parameters in that pocket ecosystem(s) or other container(s) and record the results. Each parameter influencer (12) would only be able to influence measured parameter(s) in the pocket ecosystem or other container where it is located.

The note-taking programs (31) send the users' notes, automatically formatted into online reports (26), over the internet to the research processing module (32), which logs a copy of each of each user's “online reports”, with the name of the user who gave the online report (in some embodiments), the user's user ID, and the date, and time, that the online report (26) was started and submitted, and if possible, the physical location from which the online report (26) was submitted, into a research corpus (33). In many embodiments, the user will also have to include the container ID of the container that the user observed, when the user made the online report, for the online report (26) to be accepted by the research corpus. Each research corpus is a compilation of all online reports, and, at a minimum, the measured parameter value measurements, that came from the containers or pocket ecosystems that were those online reports' subjects. Ideally, data about the present and past physical locations, of as many containers as possible that are online reports' subjects should be included in the research corpus. Transmitters operatively connected to these containers can broadcast the containers' locations as described herein, and they can be received by the research processing unit and saved in the research corpus. Ideally, all online reports (26) should be placed in the research corpus (33).

The language processing module (29) then performs text analysis on the research corpus, to identify information about specific species or lifeform types that live in the pocket ecosystems or containers users observe. The higher the number of online reports (26) in the research corpus, the higher the text analysis' theoretical accuracy. The language processing module (29) can perform text analysis at a user's direction, where the user is deciding the text analysis' focus, like the names of the lifeform types that are the text analysis' subject(s) and the type of text analysis to do. In some embodiments, the language processing module (29) can also perform text analysis on its own, using methodologies programmed into the language processing module (29). Tokenization of the online reports (26) or parts of the online reports being analyzed can be part of the text analysis that the language processing module (29) performs on behalf of users, or on its own. Tokenization would help prepare the online reports (26), or groups thereof, for further analysis. The text analysis helps to identify information such as what a lifeform type, such as a species, does in certain situations (Such as when measured parameter values reach certain levels defined by the user). The text analysis would show how the words users used in online reports, regarding a lifeform type, changed as the measured parameters to which the lifeform type was exposed, in containers, had different levels. The measured parameter values in each container that was an online report's subject, from the time the online report was started to the time it was finished are saved in the research corpus, and associated with that online report. The text analysis is intended partly to detect whether the words users used in online reports regarding a lifeform type when the measured parameter values associated with those online reports had certain levels differed substantially from the words users used in online reports regarding a lifeform type when one or more of the measured parameter values associated with those online reports had a different level, and how the word users used differed. This would hopefully give information about how the lifeform type reacted to different measured parameter values and value combinations. The language processing module (29) will also have the ability to, at a user's request, divide up its reports of the text analysis' results based on the results from online reports associated with different measured parameter value combinations, and send the divided reports to the viewing interface (37), which will display them. For example, the language processing module (29) can report the average number of mentions of a specific word sequence, in online reports (26) that also mention a lifeform type's name, and were associated with one measured parameter value combination, versus the average numbers of mentions of the word sequence in online reports (26) that mention the lifeform type's name, and were associated with each of multiple other measured parameter value combinations.

In some embodiments, the language processing module, at a user's command or on its own, can use the physical locations of the containers that were online reports' subjects, between the time that each of the online reports was started and the time that it was submitted, to explore relationships between the measured parameters a lifeform type experienced, in the containers, and the words used in online reports regarding that lifeform type, as it experienced different measured parameter value combinations. These physical locations might help reveal other patterns in the data; For example, maybe all individuals of a lifeform type in, that experienced a certain measured parameter value combination, in containers in a first geographic area acted a certain way, while individuals of a lifeform type, that experienced the same measured parameter value combination, in containers in a second geographic area, acted a different way. A further examination may reveal that the first area was cloudy, while the second area was not. The cloudy weather in the first area might have affected the individuals of the lifeform type there.

If the container's location changes, between the time that an online report with that container as its subject is started and the time the online report is finished, the language processing module may, in different embodiments, address this and decide what location to “use” in conjunction with that online report, when doing text analysis, and calculating the relationships between different words being used regarding a lifeform type, in online reports, and the locations of containers where the lifeform type was kept, in numerous ways. For example, in different embodiments, the language processing module may pick the container's location at the time the online report was started, or the time the online report was finished, or another point during the online report's creation, or use a method for picking an “average” location for the container, between the time the online report was started and finished. One way to pick the average would be to take each of the sets of GPS coordinates associated with the online report, convert them into numbers, average the numbers, and convert the average back into GPS coordinate format. The language processing module may also ignore that particular online report, when doing text analysis.

In some embodiments, the approximate physical locations of a container, instead of its exact physical locations, between the time an online report with that container as its subject will be made available to most users for their analyses, because of privacy reasons. For example, the exact locations could be stored in the research corpus, while the research corpus is configured to release only enough information about a container's physical location at any time, to most users, that the container's approximate physical location would be exact to within 1 mile.

The results of the text analysis that the language processing module and local language processing modules perform will help researchers understand how lifeform types react to different measured parameter value ranges and range combinations, and will help researchers to find goal, optimal and tolerance ranges, and range combinations, for lifeform types where these ranges and range combinations are presently unknown.

For example, a group of researchers (Who can be students) might observe members of an amphibian species in pocket ecosystems, under different measured parameter value combinations, to find a measured parameter value range combination where the measured parameter values are within the tolerance ranges for the amphibian species but where the chances of the amphibian species' members dying of chytrid fungus infection is substantially reduced or eliminated. This is a “goal range” for the species, where the “goal” is reducing or eliminating its chances of dying of chytrid fungus infection. Some of the researchers may observe the species under one measured parameter value combination, others under another measured parameter value combination, and others under other measured parameter value combinations. All the researchers would contribute online reports (26) to the research corpus (33).

If one or more of the measured parameter values in a container changed between the time that an online report with that container as its subject is started and the time the online report is finished, the language processing module may, in different embodiments, address this, while doing text analysis that uses the online report, in numerous ways. For example, in different embodiments, the language processing module may use the measured parameter's value at the time the online report was started, or at the time the online report was finished, or another point during the online report's creation. The language processing module may also use an average of the measured parameter's values associated with that particular online report. The language processing module may also ignore that particular online report, when doing text analysis.

Some of the text analysis will include finding the lift of a combination of words describing a lifeform type's wellbeing, characteristics, or actions in the research corpus or a subpart of the research corpus. For example, the language processing module (29) can parse through the online reports (26) in the research corpus (33) to find online reports that mention the name of a certain species (A lifeform type). Then, the language processing module (29) can find the lift of combinations of words that were used in reference to that species by dividing the probability of the words in the combination being mentioned at the same time, (based on the number of times that the words actually were mentioned at the same time), in the research corpus (33) by the probability the words would be mentioned at the same time in the research corpus due to random chance.

Lift can be defined as follows: When P(x)=probability that x will happen, the “lift” of two events a and b happening at the same time is P(a and b actually happening at the same time)/P(that a and b would happen at the same time due to random chance).

Finding the lift of word combinations involving a lifeform type's name is helpful because the lift shows what words and phrases users use most often to describe the lifeforms in the pocket ecosystems and other containers they are observing, and those lifeforms' behavior and wellbeing. If the lift of word sequences in the research corpus that include a lifeform type's name changes as the measured parameter values in the pocket ecosystems and other containers where users are observing the lifeform type changes, this can indicate that the lifeform type responds differently to different measured parameter value combinations, and/or to changes in measured parameter value combinations. This methodology allows humanity to have greater understanding of lifeform types, the results of their internal processes, and how they react to measured parameter value changes and different measured parameter value combinations.

In some embodiments, when a user acquires a pocket ecosystem (25), the lifeform types that are in that pocket ecosystem when the user acquires it will be recorded, before the user embodiments, the user will be required to name all the lifeform types that the user can find, inside the pocket ecosystem, when the user submits the user's first online report about that pocket ecosystem (25), and the research processing module (32) will not accept the first online report unless the user does this. The research processing module (32) will be able to search the research corpus (33) for previous online reports from the same user that have a container with the same container ID as a subject. If the research processing module (32) cannot find any such online reports, the research processing module will not accept the aforementioned first online report.

The language processing module (29) should have the ability to count the frequency of words, and also the frequencies of lifeform types' names, in the online reports, in the research corpus (33), and in subsidiary corpuses (41). An example is if a user commands the research processing module (32) to create a subsidiary corpus (41) with all the online reports (26) that have the name of a certain fish species. Then, the user commands the language processing module (29) to calculate how frequently the word “fast” appears in those online reports (26), and how the frequency of the word “fast” in those online reports changes as the water concentration of oxygen, a measured parameter, changes. This can give insight into how the fish species' swimming speed changes as water oxygen concentration changes, and in response to different water oxygen levels.

The research corpus (33) itself will be available for all users to examine and perform text analysis. This is another way that users can harness “crowd” power to increase scientific advancement. Each user has access to the entire research corpus (33), and all the data therein, which should give the users more options for performing research, and more ability to perform accurate research. Users who are researchers can use the language processing module (29) to perform text analysis on the research corpus (33). If a researcher finds that the researcher has discovered something significant, through text analysis, that researcher can save the results in the central observation collection (46) for all users to view, and to use as ideas to encourage further research. The results of the text analysis the language processing module (29) has performed on its own will also be saved in the central observation collection (46). Users can get ideas for publishable-quality studies from results saved in the central observation collection (46), or information in the research corpus (33). In one way to do this, a researcher would view part of the central observation collection (46), notice that text analysis had documented an effect on a certain species of two measured parameter values changing at the same time, which had been noticed by users, and the researcher would then start a publishable-quality study to investigate this effect further.

A researcher may also be more likely to secure funding for such a study if the user can point out that users have documented, the effect the researcher wants to investigate, in the research corpus (33).

An example of a researcher discovering “something significant” through text analysis using the language processing module (29) might be in a scenario where a certain disease became more common in a certain lifeform type when the disease's distribution changed because of climate change, and the researcher discovers that there is no mention of the disease's name, in online reports mentioning the name of the lifeform type, in online reports that were submitted concerning containers where the relative humidity level in air was below 70% and where the water salinity level was above 2 g/L, and where both the water salinity level of 2 g/L and relative humidity level of below 70% were within the lifeform type's tolerance ranges.

In some embodiments, all results of text analysis by users, on the research corpus (33) using the language processing module (29), will be automatically saved in the central observation collection (46).

In some embodiments, all results of text analysis that the language processing module (29) performs on its own, when not commanded by a user, will be automatically saved in the central observation collection (46). For example, the language processing module (29), on its own, can calculate the frequencies of words in the research corpus (33) within groups of online reports (26) wherein the containers that were those online reports' subjects were subjected to different measured parameter combinations, and the frequencies of specific bigrams and trigrams in the research corpus (33) wherein the containers that were those online reports' subjects were subjected to different measured parameter combinations, and how these frequencies change as the measured parameter combinations to which the containers that were those online reports' subjects were exposed changed. The language processing module (29), in some embodiments, can also calculate how statistics such as frequencies of specific words, bigrams, and trigrams in online reports in the research corpus (33) changes as the measured parameter values associated with the online reports (26) change, and the frequencies of specific words, bigrams, and trigrams that appear in online reports when the measured parameter values in the containers that were the subjects of online reports had certain levels, versus other levels.

Some of these bigrams and trigrams can be bigrams and trigrams including a lifeform type's name.

In some embodiments, the user ID for the user who created each online report, and container ID for the pocket ecosystem or other container that was the online report's subject will be unavailable to any user examining and/or performing text analysis on a group of online reports that includes that particular online report, unless the examining or analyzing user has special permissions. The exact location of the pocket ecosystem or other container which was the online report's subject, and the exact locations of the PC of the user who made the online report at the times between when the online report was started and when it was submitted, may also not be available to a user without special permissions. One possible kind of special permissions is being a “Group Leader” for a group that includes the user who made the online report.

The language processing module will calculate “syntagmatic relations” of words in the research corpus (33). A syntagmatic relation is: When one word occurs, what other words also tend to occur? Here, the language processing module (29) examines what words tend to occur together in segments of online reports (26), such as sentences or paragraphs. For example, the language processing module (29) can examine what words occur together with a lifeform type's name, in an online report (26) segment such as a sentence or paragraph. Whether or not a word co-occurs with a lifeform type's name can be expressed as a binary variable X where X_{w}=1 where the word is present in the segment and X_{w}=0 where the word is absent in the segment.

The “entropy”, or randomness, of X, the word, appearing in a segment can be described as H(X). Its formula is:

$$- p ( {X}_{w} = 0 ) {log}_{2} p ( {X}_{w} = 0 ) - p ( {X}_{w} = 1 ) {log}_{2} p ( {X}_{w} = 1 ) ,$$

where p=probability.

“Mutual Information” of words X and Y in a segment can be defined as the difference between entropy of word X and (entropy of word X given the presence of word Y in the segment). Likewise, “mutual information” of phrases X and Y in a segment can be defined as the difference between entropy of phrase X and (entropy of phrase X given the presence of phrase Y in the segment).

Mutual information for two words in a segment can be calculated using this formula:

Mutual information of two words W1 and W2=I(X_{w1},X_{w2})=the sum of the sum of the set of probabilities that (X_{w1}=U, X_{w2}=V)log₂(((Probability of X_{w1}=U, X_{w2}=V)/((Probability of X_{w1}=U) multiplied by (Probability of X_{w2}=V))), where the probability of word 1 appearing in the segment is X_{w1}, which equals U, and the set of possible U=is 1 or 0 and the probability of word 2 appearing in the segment is X_{w2}, which equals V, and the set of possible V is 1 or 0.

The language processing module (29) will calculate the mutual information of lifeform type names and other words, in online reports, and in paragraphs and sentences in online reports. The language processing module (29) will calculate the mutual information of other words, in online reports, and in paragraphs and sentences in online reports, and will calculate how this mutual information changes as measured parameter values change. An example is the following hypothetical scenario: There are 2000 online reports (26) in the research corpus (33) that mention a certain plant species. A user will command the language processing module (29) to calculate the mutual information of the plant species' name and the word “flower” in paragraphs in online reports (26) in the research corpus (33), where the pocket ecosystems (25) that were subjects of the online reports (26) included water that had a Ph level of 6.9, and where the pocket ecosystems (25) that were subjects of the online reports (26) included water that had a Ph level of 6.8. The language processing module also calculates the difference between the two mutual information levels for the plant species' name and the word “flower”, in online reports (26) in the research corpus (33) regarding pocket ecosystems with a water Ph of 6.9 versus pocket ecosystems with a water Ph of 6.8.

The user's viewing interface will display the results of this text analysis, show the mutual information of pairs of words in “segments” in the research corpus or subsidiary corpus, and specify whether the “segments” on which the analysis was based were sentences, paragraphs, or some other kind of segment.

The language processing module will also be able to perform text analysis by finding concordances of words in individual online reports, in subsidiary corpuses, and the research corpus, and to show how the concordances of words change as measured parameter values change, and how different concordances, especially concordances involving lifeform types' names, appeared in groups of online reports (26), in conjunction with different combinations of measured parameter values.

For example, if the user uses the language processing module to find concordances for the online reports in a subsidiary corpus (41) comprising all the online reports that mention a certain crustacean species, and the concordances show that the word “healthy” is gradually mentioned less in online reports, as the iron content of water in the containers discussed in those online reports decreases, the language processing module will send this information to the viewing interface for users to examine, and, at a user's request, will save this information in the central observation collection.

The language processing module will also be able to perform text analysis by calculating frequency of n-grams of words in the research corpus and in subsidiary corpuses, and calculating how the frequency of n-grams in the research corpus and subsidiary corpuses changes as measured parameter values in and pocket ecosystems and other containers change, and which frequencies of an n-gram in online reports in the research corpus or in subsidiary corpus are associated with a certain measured parameter value combination in the pocket ecosystems and other containers that were those online reports' subjects.

Another way that the language processing module can perform text analysis is by doing calculations analogous to “sentiment analysis” of online reports (26), that were created by users as they observed pocket ecosystems pocket ecosystems or other containers with different measured parameter value combinations, as follows: The language processing module will include a directory of words and their assigned “weights” for different aspects of the lifeforms' wellbeing. The “weights”, in these embodiments, will have been assigned ahead of time based on what the language processing module's creators believe are appropriate weights for the words. These weights are tied to words that are supposed to represent users' factual observations, but they are processed in a way analogous to “sentiment weights”. For example, the language processing module (29) may include a subdirectory of words with “weights” for each lifeform type's health, a subdirectory of words with “weights” for each lifeform type's apparent energy level, and a subdirectory of words with “weights” for each lifeform type's size, and a subdirectory of words with “weights” for each lifeform type's number (The number of individuals of the lifeform type present in the container that is the online report's subject). These four subdirectories would make up the directory of words and their weights. Different organizations of the directory, including different kinds of subdirectories, or further dividing the subdirectories according to categories of lifeforms, such as size of plants, while having “apparent energy level” not apply to plants, or having more subdirectories, are possible.

Examples of words and possible scores are “bright”, +0.1, “fast”, +0.4, “dead”, −1. Other scores can be assigned to these words, these are merely examples. Other scores for words are possible.

Then, to find an indication of how measured parameter value changes affect a lifeform type, the positive and negative weights of the words in each online report (26) that also mentions that lifeform type are added together to make a total score for each online report (26) that mentions that lifeform type. This is one example of a “scoring function”, a function that gives scores to online reports based on criteria. As the measured parameter values in the containers that were the subjects of the online reports change, this score will change, and the change can be observed. Higher score would likely indicate a measured parameter value combination that is better for the lifeform type.

The total score of an online report will be the sum of the scores of the words in the subdirectories. The scores of the words in the first subdirectory will be added up, then the scores of the words in the second subdirectory will be added up, etc. Then the scores for all the subdirectories will be added together.

The language processing module will then take the group of online reports and divide it into subgroups based on the measured parameter value combinations in the containers that were those online reports' subjects at the times those online reports were created. The average score for each subgroup will be calculated and then displayed in the viewing interface. The measured parameter value combinations in the containers that users observed to create the subgroups of online reports (26) with the highest average scores are likely to be the best measured parameter value combinations for the lifeform type being studied.

If the user is going to use a scoring method for online reports (26), as part of the user's analysis, the user should ensure that the scoring method is appropriate for the lifeform type's characteristics that the user is studying. For example, a scoring method that relies purely on adding up the weights of positive and negative words in online reports might not be appropriate if a user is seeking to learn about how much time an organism spends guarding its eggs. Likewise, if a user plans to use an assay function (see below), the user should make sure that the assay function makes sense for the user's intended research goal.

Another scoring function the language processing module might use is to instead add up the positive and negative weights of words in the sentences that also mention the lifeform type's name in each online report (26), to get a total score for that online report. The language processing module will then take the group of online reports and divide it into subgroups based on the measured parameter value combinations in the containers that were those online reports' subjects at the times those online reports were submitted. The language processing module will calculate the average score of each subgroup. The subgroups, average scores, and the measured parameter value combination related to each subgroup, will then displayed in the viewing interface.

Alternatively, the language processing module might add up the positive and negative weights of words in n-grams, in each online report, that also mention the lifeform type's name, using a consistent number of words for the n-grams (Such as 6-grams or 7-grams). The language processing module will then take the group of online reports and divide it into subgroups based on the measured parameter value combinations in the containers that were those online reports' subjects at the times those online reports were submitted. The language processing module will calculate the average score of each subgroup. The subgroups, average scores, and the measured parameter value combination related to each subgroup, will then displayed in the viewing interface.

In some embodiments, the users will be able to tell the language processing module (29) and/or local language processing module (45) how the users want the language processing module (29) and local language processing module (45), respectively, to create “assay functions” using a combination of text analysis techniques, to use on online reports. A scoring function is one kind of assay function. The assay function would be applied to the online reports to find find information which indicates measured parameter value range combinations are the best for the user's desired purpose, such as which measured parameter value range combinations are best as optimal, tolerance, or goal range combinations for the user's desired purposes.

For an assay function, the user would essentially pick a combination of text analysis techniques for the language processing module (29) or local language processing module (45) to use as an assay function, depending on the user's goals. One way the user could do this is by using the viewing interface to interact with the language processing module (29) and tell the language processing module which assay function to use, and how the assay function would be constructed. The language processing module would then apply the assay function to those online reports that the user wants to score.

An example of use of such an assay function is: A user wishes to track whether measured parameter values affect the amount that a fish species cleans itself. The user uses the viewing interface to command the language processing module to find the mutual information of 2 bigrams, “Cleans itself” and “Near surface”, in online reports that include the fish species' name, and to divide the results into subcategories based on the measured parameter value combination the container that was an online report's subject experienced at the time the online report was submitted. The language processing module finds all the online reports that include the fish species' name, and divides this group of online reports into subgroups depending on the measured parameter value combination the container that was each online report's subject experienced at the time the online report was submitted. The language processing module (29) then calculates the mutual information of the two phrases within each online report, calculates the average mutual information of the two phrases for each subcategory, and sends the average mutual information of the two phrases for each subcategory to the viewing interface (37). The viewing interface (37) then displays the mutual information for each subcategory. The user might make observations about whether measured parameter values affect how often the fish cleans itself, based on how the mutual information varies between categories of online reports.

In some embodiments, the language processing module can use every other method of text analysis known in the prior art, including, but not limited to, paradigmatic relational discovery, natural language content analysis, word association mining, topic mining and analysis motivation, probabilistic topic models with an expectation maximization algorithm, probabilistic latent semantic analysis, latent dirichlet allocation, text clustering, generative probabilistic models, similarity based approaches, text clustering, text categorization, use of discriminative classifiers, opinion mining, sentiment analysis, sentiment classification, sentiment analysis ordinal logistic regression, sentiment analysis latent aspect rating analysis, text-based prediction, contextual probabilistic latent semantic analysis, and contextual text mining with time series sentiment supervision. The language processing module's use of all methods of text analysis known in the prior art is explicitly part of the present invention. The viewing interface will display the results of this text analysis.

In some embodiments, the language processing module and/or the local language processing module will include a list of text analysis functions, which will be displayed in the viewing interface. The user can pick and choose from the list, to get a text analysis function for the language processing module or local language processing module to apply, that is appropriate for the user's purpose. The language processing module (29) and local language processing module can also allow for a user to combine text analysis functions by using the viewing interface to tell the language processing module or local language processing module, respectively, to use a text analysis function to further analyze the results of another text analysis function. An example is telling the language processing module to find the most common 4-gram in those online reports that include the name of a certain plant species, and then find the mutual information of that 4-gram and the word “fast” in those online reports that include that plant species' name.

The language processing module (29) will send the results of all the text analysis that, a user commanded it to perform, to the viewing interface (37) of the user who commanded it to perform that text analysis. The user can view the results in the viewing interface.

One application of this methodology, among others, is to help users detect whether lifeform types may be suffering from previously unnoticed sources of abiotic stress. If many users mention a previously unnoticed problem with a lifeform type, in online reports, this could be a potential source of abiotic stress to that lifeform type.

The above methodologies can also be useful for finding conditions where plants may be more saline-tolerant and drought-tolerant, because the above methodology can help users find measured parameter value combinations wherein plant lifeform types that experience these combinations of measured parameters can better tolerate salinity or drought. This can also help plant species to better adapt to climate change, and can help humanity to help plant species to survive through climate change.

Copies of an online report (26), and the measured parameter values from the container or pocket ecosystem or other container which was that online report's subject, may also be placed in subsidiary corpuses (41) where a subsidiary corpus (41) can comprise all the online reports where a certain species is mentioned, or all the online reports from a certain school or a certain classroom, or all the online reports with other characteristics in common, such as all the online reports (26) pertaining to a certain study. A subsidiary corpus (41) can also be created with only some users with specific user IDs having permission to access the subsidiary corpus.

In some embodiments, a user can create a subsidiary corpus (41) later, after the online reports (26) in the subsidiary corpus (41) were placed in the research corpus (33). A user can create the new subsidiary corpus by commanding the research processing module (32) to search the research corpus (33) for online reports (26) with certain characteristics, and place these online reports, and the measured parameter value measurements from the pocket ecosystems and other containers which were associated those online reports, in a subsidiary corpus (41).

Researchers could also use embodiments that utilize a research corpus to improve on the method of optimizing organisms' taste discussed above. In embodiments that utilize a research corpus, the measured parameter values in the containers that are the subjects of online reports are being continually recorded in the research corpus. For example, a researcher could create a subsidiary corpus comprising the online reports and measured parameter values from a group of containers controlled by the researcher's organization, and containing a type of shellfish. The researcher's organization could then offer the shellfish to consumers, and have the consumers do a survey of the shellfish's taste, while keeping track of the container where the shellfish provided to each consumer were raised. Then, the researcher could match the best-tasting shellfish to the measured parameter value combination(s) that those shellfish experienced during their lifespans before they were harvested (Including possibly different measured parameter values at different times) and the contents of the online reports (26) about these shellfish, such as words that appeared most in those online reports (26). The researcher's organization can then structure future operations “raising” that shellfish type according to what the researcher learned. For example, the researcher's organization can raise future shellfish of that type throughout their life cycle in measured parameter value range combinations, that mimic the measured parameter value range combinations that the best-tasting shellfish from the survey experienced throughout their life cycles.

Some embodiments allow a researcher to use a local language processing module to perform text analysis (Some or all of the same kinds of text analysis that the language processing module (29) can perform) on the research corpus (33) or a subsidiary corpus (41) and store the results in a local association collection (47). These results can be available only to the researcher or to those who the researcher granted access. This can be useful, for example, to researchers working for an entity that wants to achieve competitive advantage. Researchers can keep the results of their text analysis secret, by keeping their results in their local association collections.

In some embodiments, copies of the online reports that some users create will be sent to both a research corpus (33) and, at the same time, a subsidiary corpus (41) which includes only a predesignated group of the online reports. For example, the subsidiary corpus (41) may include only the online reports from a single class of students. The language processing module (29) and the statistical investigation module (36) will still be available to users, such as teachers, who will be able to use the viewing interface (37) to view the results of the language processing module (29)'s text analysis on the subsidiary corpus (41).

In some embodiments, the note-taking app (31) has scanning capability and the research processing module (32) has OCR (Optical Character Recognition) capability, so that users can add handwritten notes that have gone through OCR to the research corpus (33) and subsidiary corpuses (41). When the note-taking app (31) scans handwritten notes, and sends them to the research processing module (32), the research processing module (32) will convert the handwritten notes to the same format as an online report (26), include as much information that would ordinarily go into an online report as is available, and add the new online reports, that were formerly handwritten notes, to the research corpus (33) and any relevant subsidiary corpuses (41). These new online reports are then processed the way other online reports are processed, though without some information, such as the times the handwritten notes were started, and the container IDs of the container(s) on which the handwritten notes were based. The user ID of the user who submitted the handwritten online report (26) will still be added to the online report if that user's user ID was previously entered into, and saved in, the specific copy of the note-taking program being used to scan and upload the handwritten online reports. In some embodiments, the user could manually input the time each handwritten online report (26) was started into the note-taking app (31) at the time that the user scans that handwritten online report (26).

In some embodiments, the lifeform database will be updated based on information from the research corpus (33) as follows: The central observation collection will be examined to see how the words being used, regarding a lifeform type, changed as the measured parameter values in the pocket ecosystems and/or other containers where lifeforms of that lifeform type were kept changed. Then, the optimal and tolerance ranges in the lifeform database will be updated based on the measured parameter value range combinations related to the subgroups of online reports with the highest-positivity words concerning the health of individuals of the lifeform type, and any publicly available goal ranges will be updated based on measured parameter value range combinations related to the subgroups of online reports with the highest-positivity words concerning the goal. One method of deciding which online reports are the “highest-positivity” regarding a lifeform type is to give weights to words, depending on the amount of positivity the words are believed to signify, and to calculate the score of each online report mentioning the lifeform type's name by adding the weights of the words in that online report, and then to find the online reports, mentioning the lifeform type's name, with the highest scores. One method of deciding which online reports are the “highest-positivity” regarding a goal, relating to a lifeform type, is to give weights to words, depending on the amount of positivity the words are believed to signify, and to calculate the score of each online report mentioning the lifeform type's name and a term for the goal in the same sentence, then adding the weights of the words in each such online report, and then to find the online reports, mentioning the lifeform type's name, with the highest scores.

Users can then cause the central comparison module to use these new goal, optimal, or tolerance ranges to command the measured parameter influencers in the users' sectioned containers and other containers to keep the measured parameter values therein within the new goal, optimal, or tolerance ranges. For example, if an exceptionally high percentage of users observe, and include in their online reports, that a certain shellfish species is spawning at the same time as the detectors in those users' containers report that water magnesium content is above a certain level and temperature reaches a certain level, and water Ph simultaneously reaches a certain level, this is evidence for “goal ranges”, forming a “goal range combination” near those levels of water magnesium content, temperature, and Ph, respectively, for the shellfish species to spawn. The percentage of online reports about the shellfish species that included that the shellfish species was spawning, the difference between this percentage and the “normal” percentage of online reports about the shellfish species that included that the shellfish species was spawning, and the measured parameter ranges of temperature, magnesium content, and Ph that occurred at the same time, will be saved in central observation collection. The lifeform database may then be updated, with “goal ranges” for that shellfish species to spawn, at or around those same levels of water magnesium content, temperature, and Ph. A user controlling a sectioned container or pocket ecosystem that contains members of that shellfish species can then request the central comparison module to apply the new tolerance, optimal, or goal range to that sectioned container or pocket ecosystem, and the central comparison module will do so.

The central comparison module can also apply the new tolerance, optimal, or goal range, whether or not the user has specifically requested that new tolerance, optimal, or goal range, in some embodiments.

The lifeform databases in users' faraway programs can also be updated over the internet, in some embodiments, to use the new tolerance, optimal, or goal ranges.

In some embodiments, the language processing module (29) and/or local language processing module (45) can automatically use text analysis to adjust the measured parameter optimal and tolerance ranges for selected lifeform types, and/or to discover previously unknown optimal and tolerance ranges for lifeform types. One way that the language processing module (29) can find a previously unknown optimal or tolerance range, or can adjust an optimal or tolerance range, for a lifeform type is: By using text analysis to find those ranges, for each measured parameter, where users' online reports were the most favorable about the lifeform type's wellbeing. That would be an indication of the “true” optimal and/or tolerance range combination for that lifeform type (Some embodiments will try to find the measured parameter value combinations where users' online reports were most favorable, instead of the measured parameter value range combinations).

Then, the language processing module would put this range combination in the central observation collection. In some embodiments, the language processing module will then tell the central comparison module (And/or the comparison modules of individual faraway programs with users who have given permission) the “new” optimal and/or tolerance range combination for measured parameters, for the lifeform type (Hereafter called the lifeform type's R2 range combination). Some pocket ecosystems and other containers will contain members of the lifeform type and also will include parameter influencers controlled by the central comparison module. When one of the measured parameters for which that lifeform type has an R2 range, in one of these pocket ecosystems or other containers, moves out of its R2 range, the central comparison module will then broadcast commands for the parameter influencer(s) that influences that measured parameter in that pocket ecosystem or other container to move the value of that measured parameter, in that pocket ecosystem or other container, until that measured parameter's value goes back within the range in the lifeform type's R2 range combination. Then, the language processing module (29) will monitor whether online reports with these pocket ecosystems and other containers as their subjects (Hereafter these online reports are called the “R2 online reports”) are as favorable to the lifeform type, using defined criteria for “favorable”, as online reports created under the parts of the measured parameter value ranges where the online reports most favorable to that lifeform type were created, when the “old” optimal and tolerance ranges were being used (Hereafter these “old” ranges are called the “R1 ranges” and these online reports are called the “R1 online reports”). If the R2 online reports are less favorable to the lifeform type than the R1 online reports, the language processing module will tell the central comparison module (and any comparison modules for which the users have given permission) to reinstate any R1 ranges.

If the R2 online reports are more favorable to the lifeform type than the R1 online reports, the language processing module will tell the central comparison module (and any comparison modules for which the users of those comparison modules have given permission) to use the R2 ranges in the R2 range combination.

This process can be repeated more than once, with the language processing module (29) locating the parts of the R2 range combination where the online reports made by users are most favorable to the lifeform type and then discovering a new measured parameter value range combination (The R3 range combination) for the central comparison module to use for that lifeform type. The language processing module could do this by repeating the process of finding the R2 ranges previously discussed, and then testing the proposed R3 ranges (The parts of the R2 range combination where the online reports made by users are most favorable to the lifeform type) against the R2 range combination in the same way that the R2 range combination was tested against the R1 ranges. The language processing module could repeat this process again with the R3 ranges to discover R4 ranges, then repeat the process again, etc., and discover a range combination that is more optimal, or most optimal, for the lifeform type.

Some embodiments use scoring systems for the online reports to decide which online reports are “most favorable”, and which groups of online reports with the highest mean and/or median scores can be considered “most favorable”.

This process can also be used to find optimal and tolerance ranges for lifeforms for which optimal and tolerance ranges are not known.

Which online reports are “most favorable” to a lifeform type can be defined in multiple ways. All such ways known in the prior art are explicitly part of the present invention. One way is that the language processing module can include a database of words with positive ratings, with a previously decided rating strength for each word, and words with negative ratings, with a previously decided rating strength for each word. Then, the online reports (26) which mention the lifeform type being examined, will be placed in a subsidiary corpus (41). The language processing module can add up a score for each online report (26) in the subsidiary corpus by adding the strength of the positive-rated words in the online report (26) together and subtracting the strength of the negative-rated words from this number. Then, the language processing module can find the measured parameter value range combinations which coincided with the highest-scored online reports. One way (Not the only way) to define the combinations of measured parameter value ranges which coincided with the highest-scored online reports is for the language processing module (29) to pick a percentage of online reports (such as the top 3%) with the highest scores, and find the measured parameter value ranges associated with this top 3%. These would be the online reports considered “most favorable”, in this example. The percentage of online reports considered “most favorable” can be changed in other examples.

In some embodiments, the local language processing module (45) is capable of performing the same functions in finding R2 ranges as the language processing module (29) above, though not capable of commanding the central lifeform database to change any of the optimal, tolerance, or goal measured parameter value ranges therein for all users. In some embodiments, the local language processing module (45) would be capable of commanding the lifeform database in the user's faraway program to use R2 ranges after these have been discovered, if they are more favorable to a lifeform type being examined than the R1 ranges.

Users could discover new goal ranges using a similar method, but the users will have to carefully define what “most favorable” means in a goal range's context. Users could also command the language processing module (29) to score the online reports in a different way from that described above.

### The Fourth Group of Embodiments

The fourth embodiment group involves using an artificial neural network (34) to find the best measured parameter value combinations for a lifeform type (Or multiple lifeform types), and find out more information about the lifeform type's characteristics like its behavior. The fourth embodiment group seeks to measure how a lifeform type's wellbeing and behavior changes in response to changes in one measured parameter's value or (preferably) simultaneous changes in multiple measured parameters' values. The words users used in online reports (26) relating to a lifeform type (Including words used regarding the lifeform type's behaviors and other characteristics) will presumably be different if the measured parameters to which the lifeform type is exposed, that were associated with those online reports, are different. Therefore, the use of a neural network will try to trace which measured parameter combinations cause lifeform types to react in different ways, and how the reactions change as the measured parameter value combinations to which the lifeform type is exposed change.

The neural network will calculate whether a certain measured parameter value combination correlates to certain kinds of words being used in online reports regarding a lifeform type that was exposed to that measured parameter combination. The artificial neurons' weights in the neural network are some of the inputs in the neural network's calculations.

The neural network will adjust the artificial neurons' weights to minimize the differences between what the neural network calculates should be the kinds of words being used in online reports regarding a lifeform type, or regarding the lifeform type's behavior or other characteristic, and the kinds of words actually being used in online reports regarding the lifeform type or its characteristic. One way to do this is for a score to be given to the words being used in the online reports, and for the neural network to generate projected scores that are compared to the scores in the online reports.

Changes in the weights of artificial neurons (35) in the neural network (34) are used to estimate changes in a lifeform type's sensitivity to a specific measured parameter's value change combination (Here “sensitivity” can indicate any specific way that a lifeform type changes in response to measured parameter value changes, such as the lifeform type changing behavior). Lifeform types' sensitivity to measured parameters' value changes might be nonlinear, and it is important that we understand how lifeform types respond to measured parameter value changes, especially to multiple simultaneous measured parameter value changes. This will help us understand how the lifeform types respond to measured parameter value changes in the wild, and to multiple simultaneous measured parameter value changes, and to gauge how lifeform types respond to measured parameter value changes that might be caused by climate change.

For example, a lifeform type may react proportionately differently to a water temperature change from 30 to 31 degrees C. from the way it reacts to a change from 31 to 32 degrees C., especially if some other measured parameter changes at the same time.

A set of measured parameter value data from a set of containers, where the data is associated with online reports (26) that had those containers as their subjects, is inputted into, and processed by, the neural network (34). The neural network will assign weights to the artificial neurons (35) that minimize the value of the “training loss function”, which can be seen here as the difference between A. The results, from text analysis of the online reports in the training data, that the neural network calculated should correlate to the measured parameter values in the training data, and B. The actual results from text analysis of the online reports in the training data. For example, in some embodiments the training loss function could be the difference between the projected average scores (see below) of groups of the online reports in the training data based on the weights in the neural network, and the actual average scores of the groups of online reports. In some embodiments, the training loss function could be the sum of the difference between the scores the neural network projected for the individual online reports in the training data, and the actual scores of those individual online reports.

Then, a different set of measured parameter value data from a set of containers, such as pocket ecosystems, where the data is associated with online reports (26) with those containers as subjects, is inputted into and processed by the neural network (34), and the neural network will assign weights to the artificial neurons (35) that minimize the training loss function's value, which can be seen as the difference between A. The results, from text analysis of the online reports in the second group of data, that the neural network calculated should correlate with the measured parameter values in the second group of data, and B. The actual results from text analysis of the online reports in the second group of data.

The differences between the weights of the artificial neurons under the first combination of measured parameter values and weights under the second combination of measured parameter values can be taken as a proxy for the following: Regarding the lifeform type's characteristics that the user is studying, the difference between the lifeform type's sensitivity to measured parameter value changes when the lifeform type experiences the first measured parameter value combination, and the lifeform type's sensitivity to the same measured parameter value changes when the lifeform type experiences the second measured parameter value combination.

The data to be processed by the neural network could come from either the online reports, the detectors, the automatic reports (where available) or a combination of the above.

The lifeform type's characteristics that the user is studying could be the lifeform type's health and well-being, or any other of the lifeform type's characteristics. If the user is not studying the lifeform type's health and well-being, but a different characteristic, the text analysis of the online reports (26) that the user is using should focus on the different characteristic, so that the results can be more useful.

In one method, initial weights are assigned, either randomly, or by another method, to the artificial neurons in the neural network. Some other methods are below. The initial weights can be assigned based on the weights that are effective for other related species. For example, the neural network can be trained using fish species A and the weights thus derived can be used as initial weights to train a neural network to optimize conditions for related fish species B. In some versions, specialist researchers select the “related species”. Initial weights for the artificial neurons, can be assigned based on distributions, like the Glorot distribution (truncated normal) or can be made based on heuristics, or in other ways.

An “epoch” in use of artificial neural networks is one data pass, where the training data is cycled through the artificial neural network, and processed by the artificial neural network, once.

Backpropagation or backprop facilitates efficient learning throughout layers of artificial neurons within a deep learning model. Backpropagation is used to correct the weights of the artificial neurons (35) in the artificial neural network (34) depending on the results of how far the artificial neural network's output values (results the artificial neural network projected) are from the true values (the actual results). Backpropagation also is used to find the optimal weights, that minimize the training loss function, in an artificial neural network. Backpropagation calculates an accuracy loss across each layer of artificial neurons in an artificial neural network. For example, if the artificial neural network's output values differ from the true values by an average of 20%, the weights in the artificial neural network may be adjusted through backpropagation, hopefully reducing the difference between the output values and the true values.

Batch normalization is a way to normalize outputs of a layer in an artificial neural network by using the mean and standard deviation of mini-batches. A mini-batch is a relatively small portion of the training data. One way to do batch normalization for mini-batches is to take the activation outputs from the preceding layer, subtract the batch mean, and divide by the batch standard deviation. The distribution is recentered with a mean of 0 and a standard deviation of 1.

Batch normalization adds 2 extra parameters to any layer it is applied to, gamma and beta. In batch normalization's final step, outputs are linearly transformed by multiplying by gamma and adding beta, where gamma is analogous to standard deviation, and beta to mean.

Batch normalization helps with training artificial neural networks faster.

In some embodiments, a training dataset will be created as follows: The language processing module will analyze the online reports mentioning a lifeform type, and created when lifeforms of that type were experiencing a certain measured parameter value combination, and will “score” these online reports. One way to score these online reports (26) is based on their positive or negative words, in conjunction with that lifeform type's name. For example, each online report could be scored by adding up the positive and negative weights of words in n-grams including the lifeform type's name, or sentences including the lifeform type's name, in that online report. These are not the only possible ways to score the online reports.

A different method of scoring online reports may be needed if researchers try to track something else about the lifeform type besides its general well-being. For example, if researchers want to track how measured parameter value changes influence a lifeform type's chances of engaging in, and ability to engage in, a certain behavior, each online report could be scored through adding up the positive and negative weights of words in n-grams including the behavior's name, or sentences including the behavior's name, in online reports (26) that include the lifeform type's name.

In many other cases where a user wants to track something else about the lifeform type besides its general well-being, the user can create a “scoring function” that mentions a name for the characteristic(s) the user wants to track. One way for a user to do this is to use the viewing interface to access the language processing module, design an appropriate scoring function with the characteristic's name, and command the language processing module to analyze the research corpus, or a subsidiary corpus, using the scoring function, after which the language processing module can send the text analysis's results to the viewing interface and/or the central observation collection. The language processing module will be able to use the text analysis techniques discussed herein, but focused on a lifeform type, and on the way that the characteristic is discussed in online reports mentioning the lifeform type. Here “characteristic” can be defined very loosely, and can include things like how often an animal appears to clean itself, or where it leaves its egg cases, or how big a plant's leaves are, or the estimated population density of plankton. The loose definition is deliberate, so that researchers can examine a wide variety of questions about organisms. This also helps researchers to examine questions related to how climate change affects organisms. Scientists may not previously have been aware that these questions needed to be asked.

In some embodiments, a group of A. Online reports, that mention the lifeform type under scrutiny, and the measured parameter values associated with those online reports, or alternatively B. A group of online reports associated with measured parameter values in same measured parameter value ranges as each other, and mentioning the lifeform type under scrutiny, and the measured parameter values associated with these online reports, or alternatively C. Regarding the lifeform type under scrutiny, the highest-scoring online reports, and the measured parameter values associated with those online reports, will be used to create a training dataset. The measured parameter values in the training dataset will be inputted into the neural network (34), and the neural network will generate projected scores with the training loss function minimized. These projected scores, will be compared to the actual scores in the online reports. The weights that the neural network (34) gives to the artificial neurons (35) can then be used as estimates for how much, regarding the lifeform type's characteristic that the user is examining, the lifeform type is sensitive to measured parameter value changes within the amplitudes of the measured parameter values associated with the online reports, meaning how much the lifeform type changes, regarding that characteristic, as each measured parameter's value changes within the amplitude of that measured parameter's values associated with the online reports.

The training dataset can then be tested in this way: The system (possibly the central comparison module) will recommend for a large group of users, who have members of this lifeform type within their sectioned containers (28), pocket ecosystems, and other containers to adjust the measured parameter values within their sectioned containers (28), pocket ecosystems, and other containers to mirror the measured parameter values used in the training dataset. These users will then make online reports (26) about the species within their sectioned containers (28), pocket ecosystems (25), and other containers, and these online reports (26) will be scored in the same way as the online reports (26) in the training dataset. The measured parameter values associated with this second group of online reports (26) will be inputted into the neural network (34) and the resulting scores projected by the neural network (34) will be compared to the actual scores associated with the second group of online reports (26). The estimated weights from the artificial neurons (34), with the training loss function minimized, will then be compared to the estimated weights from the artificial neurons (34) associated with minimizing the training loss function from the first group of online reports, to see if the two groups of estimated weights are similar. If they are similar, this is evidence that they are correct, or close to correct.

The neural network can also give different weights to measured parameters based on what was predicted from the training dataset, for example, if a rapid change in a certain measured parameter seemed to be associated with a rapid score change, that measured parameter will be given more weight.

A way to examine whether the lifeform type's sensitivity to changes in a measured parameter's value differs as the measured parameter's value goes up or down is as follows: A group of online reports (26) that is A. Associated with the same or roughly similar measured parameter value ranges as each other, but also B. Associated with different measured parameter value ranges from the test dataset, and also C. Mentions the lifeform type under scrutiny, will be used, and these online reports and the associated measured parameter values will be called the “Category 3 dataset” here. The measured parameter values in the Category 3 dataset will be inputted into the neural network, and the resulting weights the neural network assigns to the artificial neurons with the training loss function minimized will be compared to the weights that the neural network (34) assigns to the artificial neurons (35) after processing the measured parameter values in the training dataset. The changes in the weights between the weights the neural network assigned to the artificial neurons after processing the training dataset, and the weights the neural network assigned to the artificial neurons after processing the Category 3 dataset, are estimates of the changes in the lifeform type's sensitivity to measured parameter value changes in the measured parameter ranges associated with the Category 3 dataset online reports, regarding the lifeform type's characteristic the user is examining. For example, one such “characteristic” of an amphibian species (a lifeform type) could be the amphibian species' susceptibility to infection with chytrid fungus. This, in turn, can help us draw better conclusions about how climate change and global warming affect amphibian species' susceptibility to chytrid fungus infection. We can also gain more insights because multiple measured parameter values sometimes change at the same time, and an artificial neural network gives us an opportunity to simulate the effect of multiple measured parameter values changing at the same time.

In some embodiments, artificial neurons in the neural network will represent specific measured parameters such as temperature and Ph. In some embodiments, one hidden layer in the neural network could be composed of artificial neurons that each represent a specific measured parameter.

### One Example of Use of an Artificial Neural Network

An example is that the neural network, using the results of text analysis, and the increases and decreases in the percentage of eggs that hatch into juveniles that happen as the measured parameter values change, can be used to find the effect of different measured parameter value changes on the percentage of eggs that hatch into juveniles for axolotls, a useful but critically endangered amphibian species whose sole wild habitat is lakes in Mexico City.

In our example, the average percentage of eggs that hatch into juvenile axolotls is known to be 50%, under conditions including average water temperature of 25 degrees C. and water Ph of 7.0. This can be determined by a group of observers, such as students, observing the axolotls' eggs and juveniles in pocket ecosystems (25) with water temperature of 25 degrees C. and water Ph of 7.0. Note that these numbers for percentage of eggs that hatch, water temperature, and water Ph are for our example's purposes only and may differ from the real numbers.

Alternatively, researchers can observe the eggs and juvenile in their natural habitat and note the average water temperature and water Ph there. For our example's purposes, we assume that axolotls' natural habitat has an average temperature of 25 degrees C. and water Ph of 7.0.

Each weight is the effect of a certain change in a measured parameter on the percentage of eggs that hatch into juveniles, in this scenario. It is unknown at the beginning whether the of changes' effects are linear (Such as whether a water Ph change from 7.0 to 7.1 causes the same change in percentage of eggs that hatch as a water Ph change from 7.1 to 7.2).

The first group of online reports the students made, and associated measured parameter values, are the training data. Researchers input the measured parameter values from the training data into the neural network (34) and these measured parameter values are processed by the neural network (34) in multiple “epochs”, or data passes. Each epoch is when the measured parameter values are processed by every layer in the neural network (34), from the artificial neurons (35) in the input layer to the artificial neurons (35) in the output layer. As the measured parameter values are processed by the neural network, in multiple epochs, the “training loss function” should reach a minimum, the lowest value that the neural network can find the “training loss function” to reach. As the training loss function's value goes lower, it is said to “converge”. Here the value of the “training loss function” means the total of the differences between A. The neural network's projected scores of the online reports (26) that “resulted from” the different measured parameter value combinations in the training data, and B. The actual scores of the online reports (26) that “resulted from” (Were associated with) the different measured parameter value combinations in the training data. The neural network assigns values to the artificial neurons' weights, with the weight for each artificial neuron representing how much the neural network calculates a specific measured parameter value change will influence the percentage of eggs that hatch into juvenile axolotls, with the training loss function minimized.

In this hypothetical scenario, the neural network then predicts, based on these weights, that a temperature of 24 degree C., combined with a water Ph of 6.9, will result in an average percentage of eggs that hatch into juvenile axolotls that is 40%, or 10% lower than the present average percentage of eggs that hatch into juvenile axolotls. Then, the prediction is tested with a group of pocket ecosystems (25) and, in our example, the combination of a temperature of 24 degree C., combined with a water Ph of 6.9 actually results in an average of 45% of eggs that hatch into juvenile axolotls. The weights in the neural network (Such as weights of different changes in measured parameter values) are then adjusted, so that the result of the neural network's predictions, is that a water temperature of 24 degree C., combined with a water Ph of 6.9, results in a prediction of an average of 45% of eggs that hatch into tadpoles for frog species A. Then the artificial neurons' weights are examined, so that researchers can learn how different changes in measured parameter values, especially water Ph and water temperature, affect the percentage of eggs that hatch into juvenile axolotls.

If the researchers believe that this will yield better results, the measured parameter value combination samples from the training dataset can be run through the neural network in “batches”, for example, 1/100 of the training dataset at a time. The researchers may also run the samples from the training dataset through the neural network in “batches” to avoid accidentally arriving at a “local minimum” combination of weights that seems to minimize the value of the training loss function but does not minimize it. The researchers can also train the neural network using “mini-batches” to update the weights more quickly.

The researchers can also use “batch normalization” of the batch mean and batch standard deviation to improve results and reduce the value of the training loss function in various scenarios, for example, to speed up training of the artificial neural network.

### Additional Embodiments

Other embodiments of the invention are also possible, containing combinations of the above characteristics from different embodiments, and such embodiments will fall within the scope of the claimed invention.

### Some Variations in Size of the Components

Variations of the sectioned containers and other containers could potentially be large enough for a cat or a dog to be placed inside the sectioned container or other container, and to enjoy themselves inside these variations of the container, when being carried on a trip by humans, with measured parameter values inside the sectioned container or other container controlled using one of the methods described herein. Other, larger animals such as monkeys could be placed inside of large variations of the sectioned container or other container, and carried around by humans. This will enable the animal to have some variety in its sensory experiences, and will enable the human carrying the animal to travel with his or her animal companion. However, it is unclear whether this will be “humane” for all larger animal species, so whether it is humane for a specific species must be researched fully. Embodiments of the invention may be able to help with this research.

The components can vary in size, length, and thickness, as long as each component can perform its required functions. For example, a version of the container ball with thinner walls than those displayed in the drawings, or a version of the container ball which is wider than those displayed in the drawings, can be built, and will be useful in some circumstances, such as for catching larger creatures. A version of apparatus embodying the present invention that includes a thicker long rod, than that displayed in the drawings, is also possible.

### Monitoring Genetic Change within a Species

The invention can also monitor the results of population genetic change and genetic drift within a lifeform type, in that if the central lifeform database (51) keeps receiving information about the optimal and tolerance values of a measured parameter for a lifeform type from auto-sensors within containers, or from the results of text analysis or from an artificial neural network, and these optimal and tolerance values change over time, this could be evidence that the characteristics of the lifeform type itself change, and that the distribution of different genes within the lifeform type is different from its previous distribution.

Change in a lifeform type's genetic makeup can be monitored in the following way: By noting how a lifeform type's responses to changes in measured parameter values changes over time. For example, if the percentage of online reports each year that have negative scores about a species' reaction to a certain temperature level goes down from 50% to 20% over the course of five years, that is evidence that the population genetic makeup of the species is changing to be able to tolerate that temperature better.

If what is reported in online reports, related to a lifeform type, in response to the same change in a measured parameter, changes significantly between years (Or between smaller time periods, in some cases), this can be evidence that the genetic makeup of the lifeform type is changing. It may also be evidence of genetic drift. For example, if five years ago the net positive weight of words in online reports (26) mentioning a species tended to be lower, as the air oxygen level associated with that online report was lower, and this correlation was statistically significant, and now the correlation still exists but is far lower, this could be evidence that the genetic makeup of the species itself is changing.

Another way that changes in genetic makeup can be monitored is through measuring how the weights assigned to the lifeform type's responses to changes in measured parameters change over time.

The neural network can monitor how it has to change the weights in the neural network to keep minimizing the training loss function over time, and whether the minimum value of the training loss function from datasets for the same lifeform type, with similar measured parameter values, changes over time. If it goes up, this could show an increase in a lifeform type's genetic variety. If it goes down, this could show the lifeform type's genetic variability is being reduced.

### Use of Versions of the Invention as a Teaching Aid

The invention can be used as a teaching aid in numerous ways. The first way is that students can acquire, or be given, the pocket ecosystems (25), sectioned containers, or other containers, and can learn, learn to observe better, and learn more about different species and what conditions are good for those species, by examining the lifeforms within the pocket ecosystems, sectioned containers, or other containers as measured parameter values change, and noting how the lifeforms react to changing measured parameter values. The students, in many embodiments of the invention, will then include this information in online reports (26) that will later be saved in the research corpus (33). In some embodiments of the invention, the students will also be able to learn more about how the lifeforms themselves within a pocket ecosystem can affect each other, by observing how measured parameter values change as the lifeforms change and grow. For example, the carbon dioxide level in a pocket ecosystem may be higher if the number of animals, and combined weight of those animals, in the pocket ecosystem has grown. The students can also learn about observation and note-taking, from creating the online reports (26).

The combination of electronically noting a time that an online report was started and sent, and having the measured parameter values from the pocket ecosystem, sectioned container, or other container that was the online report's subject, at the times the online report was started, sent, and the time in between, eliminates a lot of problems related to the report-takers (Who may be students) possibly failing to mention details that they observed, and also a lot of potential issues with inaccuracy of the time that events happened, or inaccuracy of what the user believes to have been the measured parameter values at a certain time.

In embodiments of the invention where a group leader can view the location of a pocket ecosystem, sectioned container, or other container and can also view the location of a PC from which an online report discussing that pocket ecosystem, sectioned container, or other container is submitted, at the time that the online report is submitted, the group leader will be able to see that the PC and pocket ecosystem, sectioned container, or other container were in the same place, giving additional veracity to the online report (26).

Educators can also use the statistical investigation module (36) to efficiently check, to learn which students have been submitting online reports, and what percentage of a group of students have submitted online reports within a certain time period. This is helpful for assessing what proportion of a group of students have complied with a requirement to submit online reports, and when they submit the reports. In some versions of the invention, educators may be able to pick up idiosyncrasies of the way members of a group of students express themselves in online reports, versus the “average” of how students express themselves in online reports.

The invention can also be used as a teaching aid in other ways, and all of the above methods, using the invention, can also be used in other situations where the invention is not being used as a teaching aid. For example, the capability to check whether a sectioned container, pocket ecosystem, or other container that was an online report's subject, and the PC from which the online report was submitted, were in the same place at the time of the submission, can be used in other situations besides when the invention is being used as a teaching aid.

### Use of Automatic Sensors and Hybrid Systems

Other versions of sectioned containers, pocket ecosystem, and other containers, that include the ability to further refine measured parameter optimal and tolerance ranges but are not dependent on human observation, are also part of the current invention. These systems include sectioned container, pocket ecosystem, and other containers with auto-sensors (49). The auto-sensors (49) in each sectioned container, pocket ecosystem, or other container sense information about the lifeforms in that sectioned container, pocket ecosystem, or other container, and these auto-sensors (49) send the information they have sensed, to a processor in that sectioned container, pocket ecosystem, or other container. Then the processor composes that information into automatic reports (38) and sends the automatic reports (38) to a transmitter, which then broadcasts the automatic reports. The automatic reports are then received by the research processing module (32), which stores the automatic reports (38) in the research corpus (33). The measured parameter values are detected by the detectors (10) in these sectioned containers, pocket ecosystems, or other containers, and then the measured parameter values are sent from these detectors (10), directly or indirectly, to transmitters (17) and broadcast by the transmitters. The measured parameter values are then received by the research processing module (32), and stored in the research corpus (33). The measured parameter values generated during a certain time period, and generated from detectors in each sectioned container, pocket ecosystem, or other container, are associated in the research corpus (33), by the research processing module (32), with any automatic report (38) generated by the processor in that sectioned container, pocket ecosystem, or other container, during the same time period.

Some auto-sensors can monitor movement. Some other auto-sensors can provide visual monitoring using recognition algorithms that focus on what the auto-sensor “sees” on a series of points, similar in concept to facial recognition algorithms. Other types of auto-sensors are discussed elsewhere in this application.

The processor in some embodiments can compose an automatic report from information derived from one sensor, derived from multiple sensors, or partly or fully from information derived by combining outputs from multiple sensors. For example, in some embodiments, the processor can include an infrared sensor's readings concerning part of a container, combined with an optical sensor's readings concerning the same part of the container.

In many embodiments, the identities of the lifeform types being examined in each sectioned container, pocket ecosystem, or other container will be communicated to the language processing module (29), so that the language processing module (29) can use analytical techniques more effectively. Three ways these identities can be communicated to the language processing module are: First, the processor in each sectioned container, pocket ecosystem, or other container can be programmed, at the factory where it was made, or elsewhere, to identify the targeted lifeform types for the sectioned container, pocket ecosystem, or other container in each automatic report created by that processor. Second, a human observer could also examine the sectioned container, pocket ecosystem, or other container, or pocket ecosystem, and use a variation of the faraway program (11) to program the processors therein with the target lifeform types for the sectioned container, pocket ecosystem, or other container. The automatic reports that the processor later creates will mention these lifeform types. Then, if later, new lifeform types are placed in the sectioned container, pocket ecosystem, or other container, the processor can be re-programmed again. The human observer will not need to do any observation of the sectioned container, pocket ecosystem, or other container besides observing what lifeform types are in them. This is a difference from embodiments using online reports (31), because an online report (31) is created by a human observer, based on what the human observer saw or otherwise observed, so the human observer would have to spend more time observing the sectioned container, pocket ecosystem, or other container.

Third, another component, such as the language processing module (29) or the research corpus (33) can include information saying that each certain container ID is associated with targeting certain lifeform types.

The language processing module (29) or the research corpus (33), or another software-based component, should also be programmed with information about content of automatic reports that would be considered “positive” for each lifeform type that can be targeted. “Positive”, in this case, means positive for the lifeform type's survival and health, and would be somewhat dependent on which lifeform type is being discussed. For example, if a movement auto-sensor senses more movement, in a time period, than it had sensed in a previous time period of the same length, and this is included in an automated report, this would be considered “positive” for most animal lifeform types. If the movement auto-sensor senses less than a certain amount of movement, in a time period, and this is included in an automated report, this may be considered “bad” for most animal lifeform types.

In some embodiments, the language processing unit (29) then examines the research corpus (33) and calculates which measured parameter value ranges are correlated to “positive” observations from the auto-sensors (49) that are included in automatic reports. One way the language processing unit (29) can do this is by using a pre-determined threshold for whether an observation from an auto-sensor regarding a lifeform type is “positive”. For example, a certain amount of movement being detected by the motion sensor would be considered a “positive” observation for most lifeform types. Another way is for the language processing module to find the parts of the measured parameter value ranges that happened at the same time as, and from the same containers as, high-scoring percentiles of automatic reports. The total score of an automatic report could be calculated by giving a certain weight to the score of the reading from each auto-sensor, and adding the weighted scores together to get a total score for the auto-sensors' readings at a particular time. For example, if there are 10 auto-sensors in a pocket ecosystem, with the readings from each being given equal weight, the scores from the 10 auto-sensors would be added together to get the total score for an automatic report. The score for the reading from each auto-sensor would be based on how “positive” for the targeted lifeform type is the reading from that auto-sensor. The language processing module would find the highest-scoring automatic reports.

The language processing module may, for example, find the automatic reports with the highest 5% of scores for a lifeform type. The language processing module would then find the measured parameter values associated with these automatic reports.

The language processing module (29) then stores these results, based on thresholds for what constitutes a “positive” reading, or based on a percentile of combined readings, in the central observation collection (47). Unlike humans, the auto-sensors do not express themselves in words, so there is no need for “text analysis”.

In some embodiments, the measured parameter ranges which the language processing module (29) has found to be associated with “positive” content in automatic reports will then be examined further. The central lifeform database (51) can receive input from the language processing module (29), indicating that parts of the measured parameter ranges are associated with “positive” content in automatic reports observations by the auto-sensors, and that these parts of the measured parameter ranges will be considered the “new” optimal or tolerance ranges for that lifeform type. Then, the central comparison module will send commands to the parameter influencers in the sectioned containers, pocket ecosystems, and other containers containing that lifeform type, when one of the measured parameter values goes out of the “new” optimal or tolerance range, the parameter influencer(s) that influence that measured parameter in that container will move the measured parameter back into the “new” optimal or tolerance range. This will keep the measured parameter values in the “new” optimal or tolerance ranges, in those sectioned containers, pocket ecosystems, and other containers, similarly to how the central comparison module was previously sending commands to those parameter influencers in the “old” optimal or tolerance ranges.

In some embodiments, the language processing module (29) can also “score” combinations of readings from auto-sensors, as expressed in the automatic reports, or other content in automatic reports, and factor those scores into whether observations by the auto-sensors or other content are “positive”. For example, the language processing module (29) can “score” occasions where both a motion sensor detects motion and an optical sensor set to find a specific color pattern, which indicates the presence of a specific lifeform type, detects that color pattern close to the movement sensor, and an infrared sensor detects a specific infrared pattern in the same place as the color pattern. The combination of readings from the motion sensor and the two juxtaposed readings from the optical sensor and infrared sensor, together in an automatic report, would mean that the automatic report could be “scored” highly, and would factor into whether the automatic report is considered “positive”.

The cycle can then be repeated, with the language processing module (29) finding the parts of the “new” optimal and tolerance ranges that correlate with the most “positive” automatic reports, and the language processing module (29) then telling the central lifeform database to update the optimal or tolerance ranges.

In some embodiments, a user's faraway program (11)'s comparison module can achieve the same effect as the language processing module (29), where the transmitters (17) communicate with the user's faraway program (11)'s comparison module, and the faraway program's lifeform database is updated, instead of the central lifeform database, and the faraway program's comparison module then commands the parameter influencers in the sectioned containers, pocket ecosystems, and other containers.

In other embodiments, the local language processing module can find the most “positive” automatic reports in the same way, and using the same thresholds, as the language processing module (29) can. The measured parameter values associated with the most positive automatic reports, and the levels of positivity of the automatic reports (Such as a score of the type discussed above) are then stored in the local observation collection. The faraway program's lifeform database can then be updated, instead of the central lifeform database, with new optimal and/or tolerance ranges based on the measured parameter values associated with the most positive automatic reports, which are stored in the local observation collection. The faraway program's comparison module would then command the parameter influencers in the sectioned containers, pocket ecosystems, and other containers.

In some embodiments, the above methods, using auto-sensors, can be used to find measured parameter combinations that are useful for some goal ranges. Instead of the measured parameter value ranges correlated to the most “positive” automatic reports, the language processing module will find the measured parameter value ranges correlated to the automatic reports that display the most evidence of the “goal” for the goal range. Note that, for this to be effective, the automatic sensors would have to be able to detect evidence of the goal, and the language processing module would have to include information about how the evidence for the goal, would appear in the automatic reports.

The inventors believe that sectioned containers, pocket ecosystems, and other containers, using human observation will be more effective than use of sectioned containers, pocket ecosystems, and other containers, equipped solely with auto-sensors.

Hybrid systems are also a part of the present invention, where both A. The sectioned containers, pocket ecosystems, and other containers include auto-sensors (49) that send information to processors, that create automatic reports, saved by the research processing module (32) in the research corpus (33), and B. The system also includes human observation, with the human observers submitting online reports about the sectioned containers, pocket ecosystems, and other containers that are then saved by the research processing module (32) in the research corpus (33).

Any transmitters in the invention should preferably be able to transmit wirelessly, with enough strength for the transmission, when sent through air, to be received by nearby internet routing systems and then over the internet, or at least received and understood by a nearby PC.

### Some Uses of Vector-Based Techniques in the Present Invention

The words used in the research corpus (33) and subsidiary corpuses (41) together with lifeform types' names can be used to create graphical models fixing these lifeform types' names' positions in a graphical “multidimensional space” which can be analyzed computationally. The lifeform types' names' positions, relative to each other, in the multidimensional space, may also give us more information about those lifeform types' needs and how the lifeform types react to changing conditions.

Word2Vec is a type of computational model that can take the research corpus, or a subsidiary corpus, as input and make a “latent space”, a kind of multidimensional space, usually with more than three dimensions, with each unique word in the research corpus or subsidiary corpus (whichever is being analyzed) assigned a corresponding vector in the latent space.

Word2Vec can use an artificial neural network to learn word associations. Word2vec represents each distinct word with a particular list of numbers that is a vector. The cosine similarity between the vectors indicates the semantic similarity level between the words those vectors represent. Cosine similarity depends on the vectors' angles, but not on their magnitudes.

Word embeddings in Word2Vec represent the relative probability of words in the “context window”, which is the number of words before and after a given word that are recorded as that word's context words.

The “Continuous Bag of Words” method is a refinement of Word2Vec. A word's “context” words in “Continuous Bag of Words” are usually the 5 words before and 5 words after the given word. The “context” of the name of a lifeform type's name can therefore be the five words before and 5 words after the name. If the name is two words, the name's context can be the five words before the name's first word and 5 words after the name's second word. The number of words before the lifeform's name and after the lifeform's name can be varied; for example, users could choose to make the name's context the 7 words before the first word in the name and 7 words after the second word in the name, or the 8 words before the first word in the name and 4 words after the second word in the name, etc.

A latent space is a space that locally resembles Euclidean space near each point. A latent space can have more than 3 dimensions. Computer programs can simulate a latent space and calculate objects' positions within the latent space.

By analyzing the research corpus or a subsidiary corpus using Word2Vec, a researcher might find that the word embeddings relating to two or more lifeform types are very similar because similar words are used to describe the lifeform types. This is highly significant information and may lead to greater understanding of the lifeform types in various ways.

This can also indicate that the lifeform types have common physiological processes and/or limitations (which might not be evident otherwise), and/or that measured parameter value changes will affect the lifeform types the same way, and that climate change may affect the lifeform types in the same way. It may also be valuable to further study whether the lifeform types are affected by the same measured parameter value changes in the same way, and/or to record this study's results in the research corpus (If users used containers or pocket ecosystems to study the two lifeform types and recorded the results in the research corpus). If we know that climate change affects the lifeform types in the same way, this helps us to minimize climate change's effects on the lifeform types. If we know that multiple lifeform types are affected by the same measured parameter value changes in the same way, this is evidence that the lifeform types have features in common, such as similar physiological processes or metabolic pathways to generate the same compounds. This is also highly useful information, for conserving the lifeform types in the future and ensuring they do not go extinct.

If the word embeddings used to describe a large number of lifeform types are similar, this may also indicate that certain physiological processes, such as metabolic pathways, are widely used by those lifeform types.

Word2Vec may also be able to identify how lifeform types, including species, are taxonomically related. If the cosine similarity of the vectors representing the words used to describe two lifeform types is high enough, this could indicate that the two lifeform types are closely related.

If multiple lifeform types are expected to react the same way to changing conditions, such as changing measured parameter values, this can be important in conservation planning, and attempts to mitigate climate change's negative effects.

We can also examine how a lifeform type's position, in a latent space, changes, as the measured parameter values to which that lifeform type is exposed change. We would first define the context of the lifeform type's name, in terms of the number of words before and after the lifeform's name that will be part of the context. The language processing unit (29) would then find the context words for the lifeform type's name that users used in online reports that were created when the lifeform type was experiencing a first combination of measured parameter values. Word2Vec would then convert these context words to vectors, and use the vectors to place the lifeform type's name at one position in the multidimensional space. The language processing unit (29) would next find the context words for the lifeform's name that users used in online reports that were created when the lifeform type was experiencing a second combination of measured parameter values. Word2Vec would then convert this second group of context words to a second group of vectors, which would place the lifeform type's name at a second, different position in the latent space. The difference between the lifeform type's name's two positions would be measured by the language processing unit (29), and the language processing unit (29) would send the lifeform type's name's two positions, and the distance between the two positions, to the user's viewing interface, so that the viewer can gauge how the lifeform type reacts to the difference in measured parameter values between the first group of measured parameter values and the second group.

If we do not know some of the optimal or tolerant measured parameter range combinations, or measured parameter range combinations that are goal range combinations for a certain goal, for a lifeform type, we may be able to estimate these unknown measured parameter range combinations by examining vectors based on the measured parameter value range combinations that are optimal, or tolerance range combinations, or goal range combinations for the same goal, for other lifeform types, such as related lifeform types. This can also be useful for estimating optimal and tolerance and goal ranges for newly discovered lifeform types. New insect species are being discovered all the time, for example. We might be able to find the measured parameter range combinations that are optimal, tolerant, or goal range combinations for a newly discovered insect species by examining vectors based on the measured parameter value range combinations that are optimal, or tolerant range combinations, or goal range combinations for the same goal, for related insect species or other insect species that live in similar environments, using the methodologies described herein.

In some embodiments, the language processing module (29) can use Word2Vec and the “Continuous Bag of Words” method to find and track lifeform types' names' positions in a latent space, through the method listed above, at a user's request. The language processing module (29) can then send this information about the lifeform type's name's positions in the latent space, when the lifeform type experiences different measured parameter value combinations, and the distances between those positions, to the viewing interface (37) for the user to view.

Another way that converting the words used, in online reports (26) regarding a lifeform type into vectors in a vector space can be used to find likely information about other lifeform types is this: First, the language processing unit (29) would include a directory of the “strength” of different words. Examples are “bright”, +0.1, “fast”, +0.4, “dead”, −1, “the”, 0. Negative words would have negative magnitude, and positive words would have positive magnitude.

Second, the context of the lifeform type's name would be defined, in terms of the number of words before and after the name that would be part of the context.

Then, the language processing unit (29) would add up the strength of the context words for each mention of the lifeform type's name in the research corpus, or a subsidiary corpus (whichever is being examined), in the research reports created by users observing members of the lifeform type experiencing a first measured parameter value combination. The language processing unit (29) would then create a vector based on the added-together magnitude of the context words. This vector would define a first position for the name of the lifeform type in a vector space.

The language processing unit (29) adds up the strength of the context words for each mention of the lifeform type's name in the research corpus, or a subsidiary corpus (whichever is being examined), in the research reports created by users observing members of the lifeform type experiencing a second measured parameter value combination, and then create a vector based on the added magnitude of the context words. This vector would define a second position for the name of the lifeform type in the vector space.

The language processing module would then do the same regarding research reports created by users observing members of the lifeform type experiencing a third measured parameter value combination, and possibly a fourth, and as many others as there are measured parameter value combinations in which users observed the lifeform type and created online reports. These vectors would each define a third, fourth, etc. position for the name of the lifeform type in the vector space.

The range combinations where the magnitude of the vectors defining the lifeform type's position are most positive are likely to be potential optimal and tolerance range combinations, if optimal and tolerance range combinations are unknown for the lifeform type.

The changes in the lifeform type's position in vector space, as the measured parameter value combinations in which the lifeform type was kept change, is an indication of the lifeform type's sensitivity to changes in different measured parameters.

The positions of the lifeform type's name in the vector space, related to each measured parameter value combination, can be used as the “starting estimate” for how a second, related, lifeform type might be positioned, related to that measured parameter value combination. This is useful for finding the measured parameter value combinations that are likely to be part of tolerance range combinations for poorly known species.

In another variation of this group of embodiments, the words for which “strengths” have been designated, in the language processing module (29), will be divided into “aspects”. Then, the magnitude of the context words in each aspect will be added. There will then be multiple vectors, one vector for each aspect, defining each of the lifeform type's name's position.

### Some Other Processes that are Part of the Invention

The processes of use of an artificial neural network to find the optimal ways of caring for lifeform types, and to note changes in the optimal ways of caring for lifeform types, including species/breeds, are part of the present invention.

The process of using every embodiment of the invention described herein is also part of the present invention.

The components of the invention that use computer memory, such as the research corpus (33), subsidiary corpuses (41), the central observation collection (46), and the local observation collection (47), the online reports (26) and the memory components of the faraway program (11) can be stored on any form of computer memory known in the prior art, including, but not limited to, memory storage on a hard drive, or cloud-based storage. Likewise, a memory (48) can be any of the types of computer memory known in the prior art.

It is further understood that the parts of the invention that are computer program components can be combined, or functions belonging to one computer program component can be integrated into another computer program component. Computer program components of the invention can also be further subdivided. Computer program components of the invention may also be run on an individual processor (19), run over a group of processors, run over the cloud, or run in any of the other methods known in the prior art.

The discussion included in this patent application is intended to serve as a basic description. The reader should be aware that the specific discussion may not explicitly describe all embodiments possible, and alternatives are implicit, or obvious to those skilled in the art. Also, this discussion may not fully explain the generic nature of the invention and may not explicitly show how each feature or element can actually represent equivalent elements. Again, these are implicitly included in this disclosure. Where the invention is described in device-oriented terminology, each element of the device implicitly performs a function. It should also be understood that a variety of changes may be made to the embodiments that have been described, without departing from the essence of the invention. Such changes are implicitly included in the description. These changes still fall within the scope of this invention.

Furthermore, each of the various elements of the invention and claims may also be achieved in a variety of manners. This disclosure should be understood to encompass each such variation, whether it is a variation of an apparatus embodiment, a method embodiment, or a variation in any element of an embodiment. As the disclosure relates to elements of the invention, the words describing each element may be replaced by equivalent apparatus terms, even if only the function or result is the same. Such equivalent, broader, or even more generic terms should be considered to be encompassed in the description of each element or action. Such terms can be substituted, when desired, to make explicit the implicitly broad coverage to which this invention is entitled. It should be understood that all actions may be expressed as a means for taking the action in question, or may be expressed as an element for causing the action in question.

Similarly, each physical element disclosed should be understood to encompass a disclosure of the action which that physical element facilitates. Such changes and terms are to be understood to be explicitly included in the description.

The features, functions, and advantages that have been described herein may be achieved independently in various embodiments of the present invention including computer-implemented methods, computer program products, and computing systems or may be combined in yet other embodiments.

### BRIEF DESCRIPTION OF THE DRAWINGS

FIG. 1 shows a view of a version of an embodiment of an apparatus with a long rod and container ball. The container ball (6) is transparent, and open. There are some small holes in the top of both halves of the container ball, through which the detectors (10) and parameter influencers (12) will fit when the container ball is closed. The detectors and parameter influencers (12) are connected to a processor (19), which is also connected to a transmitter and receiver inside the container connection device. The transmitter (17) and receiver (16) are connected to the main wire group (3), which also connects to another transmitter (17) and receiver (16) inside the handle. The transmitter and receiver in the handle, and the main wire group, draw power from a battery (13). The transmitters are transmitting information about the measured parameter values inside the container ball to the faraway program (11), which is running on the PC (30) (a cellular phone in this case), and the faraway program is sending a command to change the temperature to the receivers, inside the handle and container connection device. A version of the linking mechanism (18) is seen, capable of mechanically closing the container ball.

FIG. 2 shows a cut-away view of a container connection device, with a container ball connected to the container connection device (5), in an apparatus with more than one container ball, that can be interchanged, and can each be connected with the container connection device (5). The flexible hinges that connect the two container ball latches (21) to the container ball can be seen. The container connection device (5) has indents in it, that the container ball latches (21) can “hook” into, to latch onto the container connection device (5) while holding the container ball in a position where the transmitter in the container connection device is close to the receivers in the container ball. The transmitter in the container connection device, and its proximity to receivers in the container ball, can also be seen. This allows the receivers in the container ball to transmit information to the transmitter in the container connection device more easily. This particular container ball has two food compartments (15) on its sides. The user can open the food compartments (15), to place food inside, and the food compartments (15) can open upon the interior of the container. Another, larger, container ball is shown to the side, also with container ball latches, and flexible hinges.

FIG. 3 shows a view of a version of an apparatus, and a cross-section of the container ball where the electromagnets in the container ball are clearly seen. The electromagnets are present in the other versions of the container ball shown in these drawings, but the electromagnets are the same color as the container ball in the other drawings with pictures of a clear container ball, so the electromagnets are not easily visible in the other drawings. The container ball and container connection device are covered with thin-film solar cells, which feed power into batteries in the container ball and container connection device, respectively.

FIG. 4 shows a side view of an apparatus with an alert light (24) on the long rod (2) and digital gauges, and controls, including measured parameter controls, in a control panel (7) on the handle (1). The digital gauges respond to information received via the main wire group from the detectors in the container ball. These detectors feed information about the measured parameter values that they detect to a processor (19) in the container ball. This particular example of the apparatus includes a much longer main wire group than the other apparatus examples in other figures.

FIG. 5 shows a cut-away view of a container connection device, with a container ball connected to the container connection device, in a version of the invention where the two container ball latches (21) latch into specialized grooves in the container connection device. The flexible hinges that connect the two container ball latches (21) to the container ball can be seen. The transmitter in the container connection device, and its proximity to receivers in the container ball, can also be seen. The receivers in the container ball connect to processors in the container ball.

FIG. 6 shows a version of a pocket ecosystem (25). The pocket ecosystem includes guppies, plants, and detectors (10) and parameter influencers (12). The pocket ecosystem (25) also includes at least one transmitter (17) and at least one receiver (16). The transmitter is transmitting the information collected from the detectors about the measured parameter values inside the pocket ecosystem.

The pocket ecosystem contains members of multiple species, and the measured parameters are being controlled so that the lifeforms in the pocket ecosystem survive and contribute resources (Carbon dioxide and oxygen in this case) to each other.

The guppies produce carbon dioxide for the plants to breathe, and the plants produce oxygen, for the guppies to breathe. The user can observe, indirectly, how the carbon dioxide produced by the guppies produce affects the health of the plants, and the oxygen produced by the plants affects the guppies' health and activity.

FIG. 7 shows an example of one of the sectioned containers in a necklace. A fish is inside the sectioned container. The measured parameter influencers (12) inside the sectioned container ensure that the measured parameter values inside the sectioned container are within the tolerance ranges for the fish, so that the fish continues to live. Detectors inside the sectioned container monitor the measured parameter values inside the sectioned container.

FIG. 8 shows an example of one way, in some embodiments of the invention, that a researcher can use the viewing interface, and use the language processing unit (29) to perform text analysis to sort through a research corpus (33) to determine the effects of different measured parameter values upon a fish species' behavior.

FIG. 9 shows a flow chart of a group of students using pocket ecosystems (25) to take notes about lifeforms of a species that are inside the pocket ecosystems. Each of the students takes an online report (26) which is then transmitted to the language processing module (29).

FIG. 10 shows a sectioned container (28) that is shaped like a cube. The sectioned container (28) has two sections, that are open. Inside the sectioned container (28) is a parameter influencer (12). On top of the sectioned container (28) is a linking mechanism (18).

FIG. 11 shows an example of a vector space, being used in one embodiment of the invention to find a measured parameter value combination that is likely to be at or near optimal for a species, for which the optimal combination of measured parameter values was not previously known.

FIG. 12 shows a flow chart of one way that a large group of students going to several different schools can learn about how a species (A salamander species in this case) reacts to measured parameter value changes and different measured parameter value combinations. Each student has a pocket ecosystem (25) equipped with an alert light (24), a transmitter (17), a processor (19) and multiple detectors (10) and multiple parameter influencers (12). The students observe the pocket ecosystems and use note-taking apps (31) on their PCs (30) to create a plurality of online reports (26). Each online report (26) automatically includes the container ID of the pocket ecosystem (25) owned by the student who created that online report (26), and also includes that student's user ID. The online reports (26) are sent, using the students' PCs' internet transmission capabilities, over the internet until the online reports (26) reach the research processing module (32). The research processing module (32) stores the online reports (26) in the research corpus (33).

Meanwhile, the detectors (10) in each pocket ecosystem (25) send the values of the measured parameters inside that pocket ecosystem (25) to the processor (19). The processor sends the pocket ecosystem (25)'s container ID, the time, and the measured parameter values to the transmitter (17) attached to that pocket ecosystem (25). The detectors keep sending the processor (19) updated values for these measured parameters over time, and the processor (19) keeps sending the updated values and pocket ecosystem (25)'s container ID, and the time, to the transmitter. This transmitter (17) will wirelessly transmit the pocket ecosystem's container ID, the time, and the measured parameter values (and keep transmitting their new values as they are updated). The time, and the measured parameters' values at that time, and the pocket ecosystem's container ID will be sent over the internet to the research processing module (32). The research processing module (32) will save the measured parameter value measurements, and the times those measured parameter values were measured, for each pocket ecosystem, together with that pocket ecosystem's container ID, in the research corpus (33). The research processing module (32) will also associate the online reports (31) that include each specific pocket ecosystem's container ID with the measured parameter value measurements from the pocket ecosystem with that pocket ecosystem's container ID, that were made, at the same times as the times that particular online report was started, submitted, and the time in between.

The language processing module (29) then performs text analysis on the research corpus (33). This text analysis includes, but is not limited to, A. Calculating the 5 most common combinations of 8 words each in the research corpus at the present time. B. Calculating and the lift of each of these combinations, and each of the names of multiple specific species listed in the language processing module. The language processing module (29) stores the results of the text analysis that it performs in the central observation collection (46), so that other users can view the text analysis' results later. Researchers, can view the text analysis' results including the 5 most common combinations of 8 words each, that also use the names of the aforementioned specific species, and specific numbers for the lift of each of these combinations, using the viewing interface (37).

The research processing module (32) can also create a subsidiary corpus (41) comprising solely those online reports (26) in the research corpus (33) that have some characteristic in common, such as online reports that came from students at the same school, or that mention a certain species. Here in this example the research processing module (32) has created six subsidiary corpuses (41), each comprising online reports submitted by students in one of six schools.

The text analysis' results are used to create a training data set, which then is used to create a series of weights which are assigned to some of the artificial neurons (35) in the artificial neural network (34). Later on, groups of students will be assigned to do tests, by observing the same species under parts of the measured parameter value ranges under which the first group of students observed their pocket ecosystems. The tests' purpose will be to find whether the weights assigned to the artificial neurons are correct. If the actual results of the tests differ from the results predicted by the artificial neural network, the weights can be adjusted.

The students' teachers, in this example, can use the viewing interface (37) to command the statistical investigation module (36) to investigate information such as: A. Which students made online reports during a certain time period, B, when, during the time period, were the online reports submitted? C. What percentage of students in a group submitted online reports during a certain time period?

FIG. 13 shows a version of an apparatus with a main wire group (3) wound on an external reel (4) and threaded through wire holding rings (8). The external reel (4) is attached to the handle (1). The main wire group extends along the long rod (2). The long rod (2) is attached to the handle (1). The main wire group (3) connects to a container connection device (5). A sectioned container (28) shaped roughly like a ball but with a flat top and bottom is latched to the container connection device (5) by two container latches (39). There is also a linking mechanism (18) attached to the container connection device (5) and the sectioned container (28), which will help the sectioned container to open and close when desired. On the outside of the sectioned container, and on the outside of the handle, are charging ports (20), in this case wireless charging ports. Inside the sectioned container (28) is a light (9), and two parameter influencers (12), and two detectors (10).

A transmitter and a receiver, which are too small to be indicated on this drawing, are in the container connection device, close to its bottom, and another transmitter and receiver, which are too small to be indicated on this drawing, are in the sectioned container, close to its top and close to the container connection device's transmitter and receiver, respectively.

A processor, which is too small to be indicated on this drawing, is in the sectioned container, and this processor is connected to the transmitter and receiver in the sectioned container, and to the two parameter influencers and two detectors in the sectioned container.

The handle (1) also includes a control panel with 2 digital gauges, and controls. The digital gauges show information that was detected by the detectors in the sectioned container, sent by them to the processor in the sectioned container, and by that processor to the transmitter in the sectioned container. Then, this information is transmitted by the transmitter in the sectioned container to the receiver in the container connection device, and sent through the main wire group to another processor (not shown) inside the handle (1), which controls the digital gauges.

Likewise, the user can use the control panel in the handle to, among other things, send commands to the parameter influencers in the container connection device. The commands will be sent from the controls to the processor in the handle, which will then send them along the main wire group (1) to the container connection device (5). The transmitter and receiver in the container connection device are connected to the main wire group. The transmitter will transmit the commands to the receiver in the sectioned container, which will then transmit the commands to the processor in the sectioned container, which will then transmit the commands to the parameter influencers.

FIG. 14 shows how researchers or others can use the invention to investigate a small part of the research corpus. A researcher uses the viewing interface (37) to command the research processing module (32) to access the research corpus (33) and access those research reports that mention a plant species, which will be called “plant species B” here.

FIG. 15 shows a flow chart of use of an embodiment of the invention where auto-sensors (49) are used to monitor the lifeforms in a group of pocket ecosystems (28) without human intervention.

### DETAILED DESCRIPTION OF THE DRAWINGS

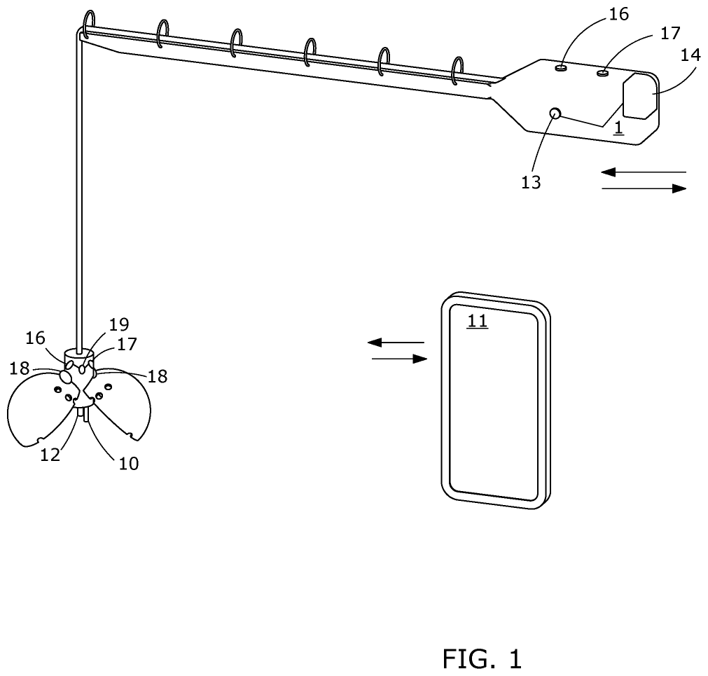

FIG. 1 shows a view of an apparatus with a long rod and container ball. The container ball is transparent, and is open. There are some small holes in the top of both halves of the container ball, through which the detectors (10) and parameter influencers (12) will fit when the container ball is closed. The detectors (10) and parameter influencers (12) are connected to a transmitter and receiver inside the container connection device. This transmitter and receiver are connected to a processor (19), which, in turn, is connected to the main wire group, which also connects to another transmitter and receiver inside the handle.

The transmitter, receiver, a processor in the handle, and the main wire group all draw power from a battery (13) which is inside the handle. The main wire group transmits some power to the transmitter, processor, receiver, and linking mechanism inside the container connection device.

The battery (13) receives some power from a solar cell (14), which is attached to the handle (1). The transmitters are transmitting information about the measured parameter values inside the container ball to the faraway program, which is running on the PC (a cellular phone in this case), and the faraway program is sending a command to change the temperature to the receivers, that are inside the handle and container connection device.

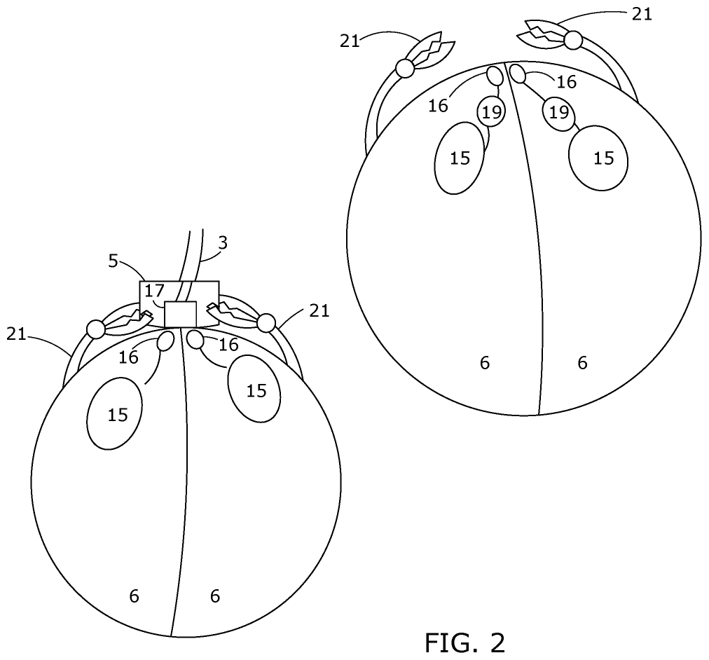

FIG. 2 shows a cut-away view of a container connection device, with a container ball connected to the container connection device, in an apparatus with more than one container ball, that can be interchanged, and where both container balls can be connected with the container connection device. The container connection device (5) has indents in it, that the container ball latches (21) can “hook” into, to latch onto the container connection device (5) while holding the container ball in a position where the transmitter in the container connection device is close to the receivers in the container ball. The transmitter in the container connection device, and its proximity to receivers in the container ball, can also be seen. This allows the receivers in the container ball to transmit information to the transmitter in the container connection device more easily. The flexible hinges that connect the two container ball latches (21) to the container ball can be seen. This particular container ball has two food containers (15) on its sides. The user can open the food containers (15), to place food inside, and the food containers (15) can open upon the interior of the container ball. Another, larger, container ball is shown to the side, also with latches, and flexible hinges.

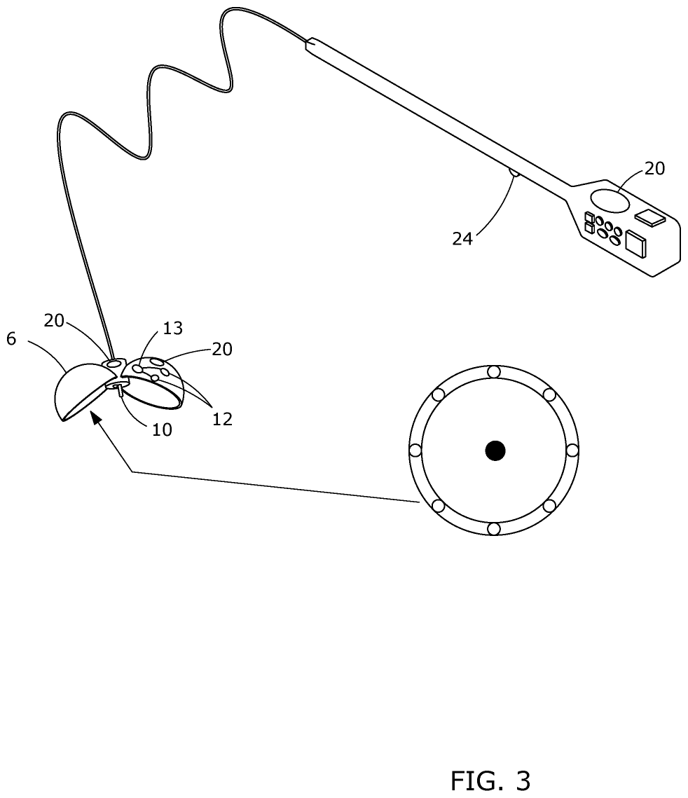

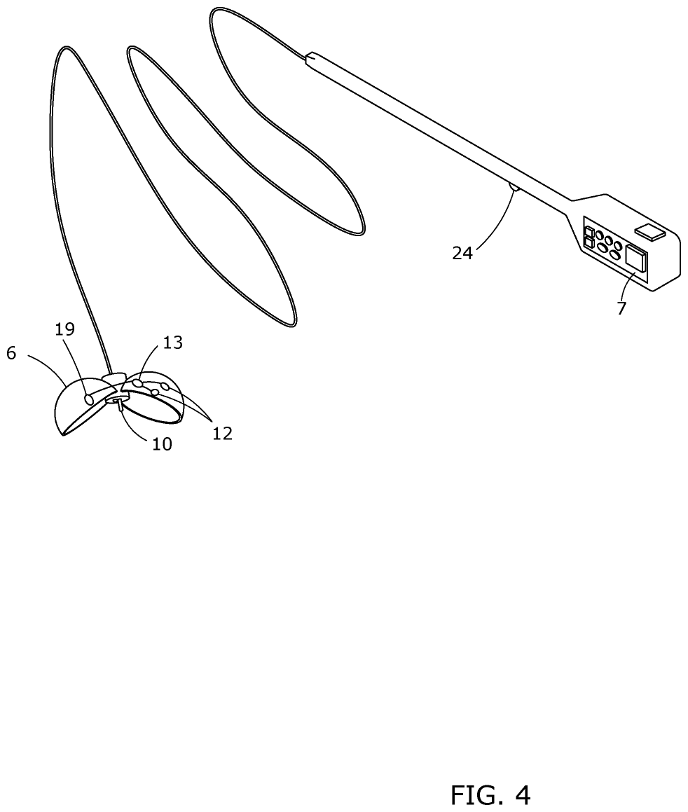

FIG. 3 shows a view of an apparatus, and a cross-section of the container ball where the magnets in the container ball are clearly seen. This version of the apparatus also has charging ports (20) in the container ball, container connection device, and handle. The electromagnets are present in the other versions of the container ball shown in these drawings, but the electromagnets are the same color as the container ball in the other drawings with pictures of a clear container ball, so the electromagnets are not visible in the other drawings. A detector (10) is in between two halves of the container ball, and connected to a processor in the container connection device. This connection is not visible here. Two parameter influencers (12) are in one half of the container ball, and connect to a battery in the container ball. The battery in the container ball is connected to the main wire group via the container connection device, but this connection is not visible here.

FIG. 4 shows a side view of an apparatus with an alert light (24) on the long rod and digital gauges, and controls, including measured parameter controls, in a control panel on the handle. The digital gauges respond to information received via the main wire group from the detectors (10) in the container ball. These detectors (10) feed information about the measured parameter values to a processor (19) in the container ball. This processor also sends commands to the parameter influencers (12) when needed. The processor (19) is connected, via the main wire group, to the control panel, but the connection is not visible here. This particular example of the apparatus includes a much longer main wire group than the other examples of the apparatus in other figures.

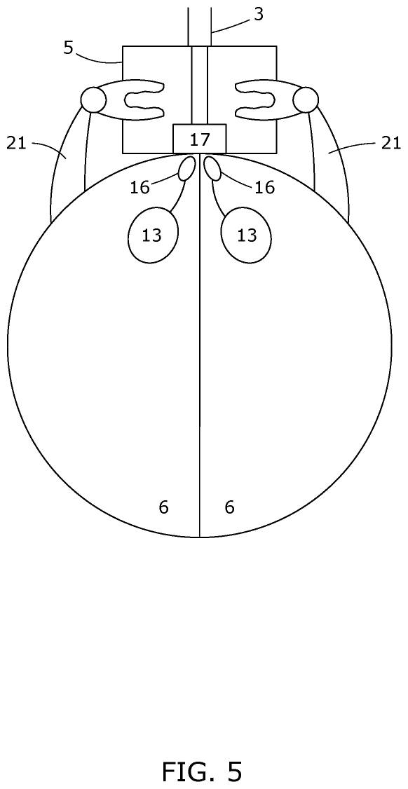

FIG. 5 shows a cut-away view of a container connection device, with a container ball connected to the container connection device, in an apparatus where the two container ball latches latch into specialized grooves in the container connection device. The flexible hinges that connect the two container ball latches (21) to the container ball can be seen. The transmitter in the container connection device, and its proximity to receivers in the container connection ball, can also be seen. The receivers in the container ball connect to processors in the container ball.

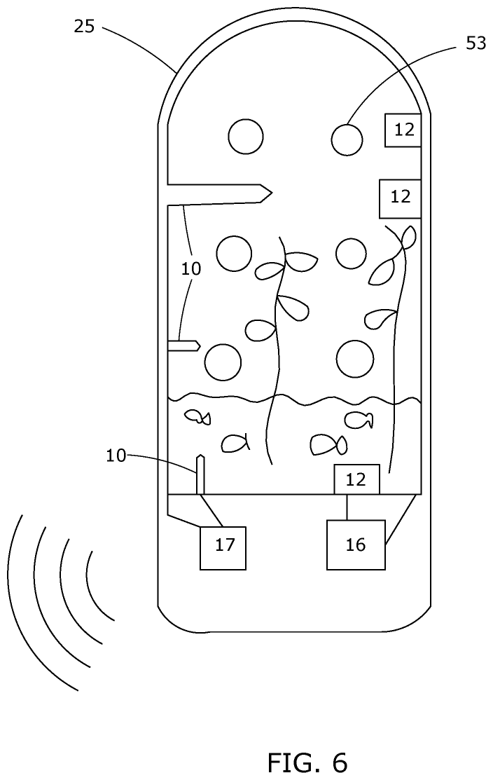

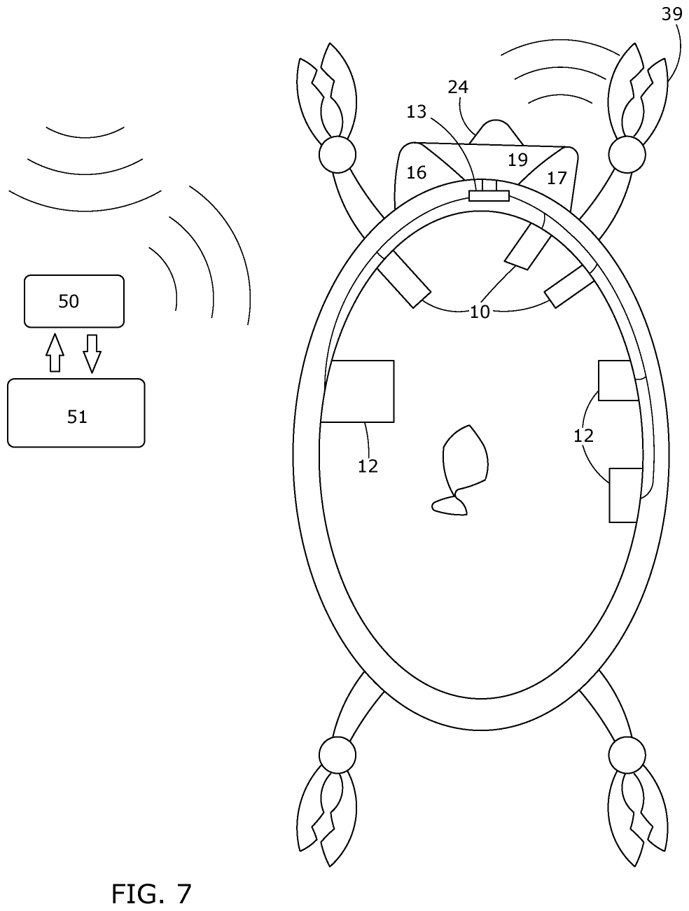

FIG. 6 shows a version of a pocket ecosystem (25). The pocket ecosystem (25) includes guppies, snails, plants, and detectors (10) and parameter influencers (12). The pocket ecosystem (25) also includes at least one transmitter (17) and at least one receiver (16). The transmitter is transmitting the information it has received from the detectors (10) about the measured parameter values inside the pocket ecosystem. The detectors (10) include at least one water oxygen detector to detect oxygen in the water, and at least one air carbon dioxide detector to detect carbon dioxide in the air.

The guppies and snails produce carbon dioxide for the plants to breathe, and the plants produce oxygen, for the guppies and snails to breathe.

The pocket ecosystem contains multiple species, and the measured parameters are being controlled so that the species in the pocket ecosystem (25) survive and contribute resources (Carbon dioxide and oxygen) to each other. The measured parameters are being controlled by commands from a user's faraway program, which is not shown. The faraway program receives the measured parameter values from the transmitter. The faraway program, which includes a lifeform database, also sends commands to the receiver, commanding the relevant parameter influencer to change the value of a measured parameter when that measured parameter's value goes out of the optimal range for a species with a member inside the pocket ecosystem. The receiver transmits these commands to the parameter influencers, which execute these commands.

The faraway program searches the lifeform database, which includes the tolerance and optimal ranges for multiple measured parameters for each species with members inside the pocket ecosystem. This is how the faraway program knows what are the tolerance and optimal ranges for each measured parameter, for each of those species.

The user, a student, in this case, can observe how the oxygen and carbon dioxide levels, and other measured parameter levels, in the pocket ecosystem fluctuate in response to the plants and animals' activity, and other factors, and the user can learn.

This particular pocket ecosystem (25) has nutrient balancing holes (53) to improve exchange of gases from the outside. The nutrient balancing holes (53) also help a student using the pocket ecosystem to observe how the concentration levels of oxygen, carbon dioxide, and other measured parameters inside the pocket ecosystem (25) change in response to different factors.

FIG. 7 shows an example of one of the sectioned containers in a necklace. A fish is inside. The measured parameter influencers (12) inside the sectioned container ensure that the measured parameter values inside the sectioned container are within the optimal ranges for that fish's species, so that the fish continues to live healthily. Detectors (10) inside the sectioned container monitor the measured parameters' values inside the sectioned container. The sectioned container has a battery (13) which powers the detectors and parameter influencers. The sectioned container also includes a transmitter (17), a receiver (16), and a processor (19), and an alert light (24). The processor is connected to the detectors, parameter influencers, the transmitter, and the receiver, and the alert light. The detectors transmit information about the measured parameter values that they detect, inside the sectioned container, to the processor. The processor (19) then transmits these values to the transmitter (17), which then broadcasts these values wirelessly, so that these values are transmitted over the internet and reach the central comparison module (50). The central comparison module has been previously programmed with the optimal and tolerance ranges for the measured parameters the detectors measure, for the species of the fish inside the sectioned container. The central comparison module (50) receives information from the central lifeform database (51) about the optimal and tolerance values for the measured parameters that are monitored by the detectors in the sectioned container. The central comparison module (50) compares these optimal and tolerance values to the actual measured parameter values received indirectly from the detectors inside the sectioned container.

If the value of one of the measured parameters measured by the detectors (10) moves out of the optimal range for the species of the fish inside the sectioned container, the processor (19) will receive a signal about this, because the processor is continuously receiving signals about the measured parameters' values inside the sectioned container from the detectors. The processor will then send a signal to the alert light to activate, so that the user will be aware that the value of one of the measured parameters measured by the detectors is out of the optimal range.

If the value of one of the measured parameters measured by the detectors moves out of the optimal range for the species of the fish inside the sectioned container, the central comparison module will broadcast a command, for the parameter influencer that influences that parameter to move that parameter back into the optimal range. The receiver will receive this command, and transmit it to the processor, which, in turn, will command the parameter influencer that influences that parameter to move that parameter back into the optimal range.

If the value of one of the measured parameters inside the sectioned container moves out of the optimal range for the species of the fish inside, the detectors (10) will transmit this information to the processor (19), which will then cause the alert light (24) to light.

The sectioned container also has two container latches (39), which can connect to container connection devices or other things if needed.

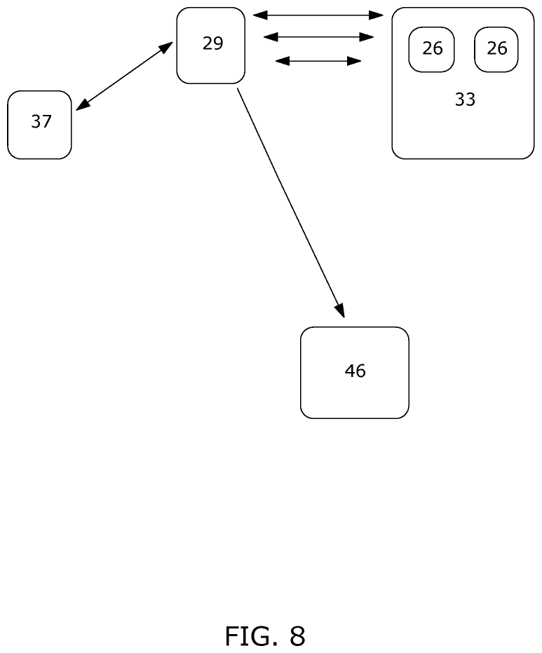

FIG. 8 shows one example of a way that in some embodiments of the invention a researcher can use the viewing interface (37) to command the language processing unit (29) to use text analysis methods, and to sort through a research corpus (33) to determine different measured parameter values' effects upon the behavior of a fish species, which will be called Species C. First, the researcher, who is using the viewing interface (37) sends the language processing unit (29) a command to search through the research corpus (33) for online reports (26) that mention Species C and seeks information about Species C's behavior. The researcher inputs into the viewing interface a word (“swim”, in this case) for the language processing unit to use to calculate the lift of the word and the name of Species C, in online reports (26) that mention Species C. The researcher also uses the viewing interface to command the language processing module (29) to calculate the lift of the word “swim” and specific 8-word combinations that include Species C's name, in the entire research corpus. The researcher also uses the viewing interface to command the language processing module (29) to find the 10 most common 7-grams (n-grams involving 7 words) in the research corpus (33) where two or more of the words are the scientific name for Species C and one of the words is the word “swim”, and to calculate the ratios of positive to negative 7-grams where two or more of the words are the scientific name for Species C and one of the words is the word “swim”, for each measured parameter value combination where the ratio exists.

Second, the language processing unit (29) searches through the research corpus (33) to find online reports (26) that mention Species C. Third, the language processing unit (29) then calculates the lift of Species C's name and the word “swim”, and the lift of the specific combinations of 8 words involving the name of Species C and the word “swim” in the research corpus (33), and calculates the following associations for each measured parameter value combination where at least one online report discussing Species C's reaction to that measured parameter value combination has been submitted: 10 most common 7-grams (n-grams involving 7 words) in the research corpus (33) where two or more of the words are the scientific name for Species C and one of the words is the word “swim”. Then, the language processing unit (29) calculates whether each 7-gram using the word “swim” and Species C's name (Not just the 10 most common ones) is positive or negative about Species C, by adding up the positive and negative weights of the words in each 7-gram. If the weights' sum is positive, the 7-gram will be presumed to be positive, and if the weights' sum is negative, the 7-gram will be presumed to be negative. If the weights' sum is zero, the 7-gram will be presumed to be neutral. Note that, in this version of the invention, the online reports from sectioned containers and pocket ecosystems that include at least one detector capable of measuring a measured parameter's level will be “searched” for purposes of calculating the n-grams for a measured parameter value combination that includes that measured parameter. For example, if some sectioned containers or pocket ecosystems include salinity detectors, but others do not, and a researcher wants to find the n-grams that mention Species C and salinity, only those online reports from sectioned containers and pocket ecosystems that include detectors that measure salinity will be searched to find the n-grams.

The language processing module creates graphs showing the ratio of positive 7-grams mentioning Species C and the word swim to the ratio of negative 7-grams mentioning Species C and the word swim, for each measured parameter value combination for which at least one online report mentioning Species C and the word swim exists. The language processing module will send these graphs to the viewing interface. The viewing interface then displays these graphs.

The language processing unit also sends the viewing interface the lift numbers for 8-word combinations including Species C's name and the word swim, and the lift number for Species C's name and the word swim.

The language processing unit also sends the viewing interface the 10 most common 7-grams in the research corpus (33) where two or more of the words are the scientific name for Species C and one of the words is the word “swim”.

The viewing interface displays the graphs, lift numbers, and 10 most common 7-grams. The researcher examines the graphs and the lift numbers, and 10 most common 7-grams and makes observations.

The researcher then uses the viewing interface (37) to tell the language processing unit (29) to cause the researcher's observations, and the 10 most common 7-grams mentioning Species C and the word “swim”, and also the aforementioned graphs, and the lift numbers, if desired, including the words and phrases for which lift was calculated, to be saved in the central observation collection (46).

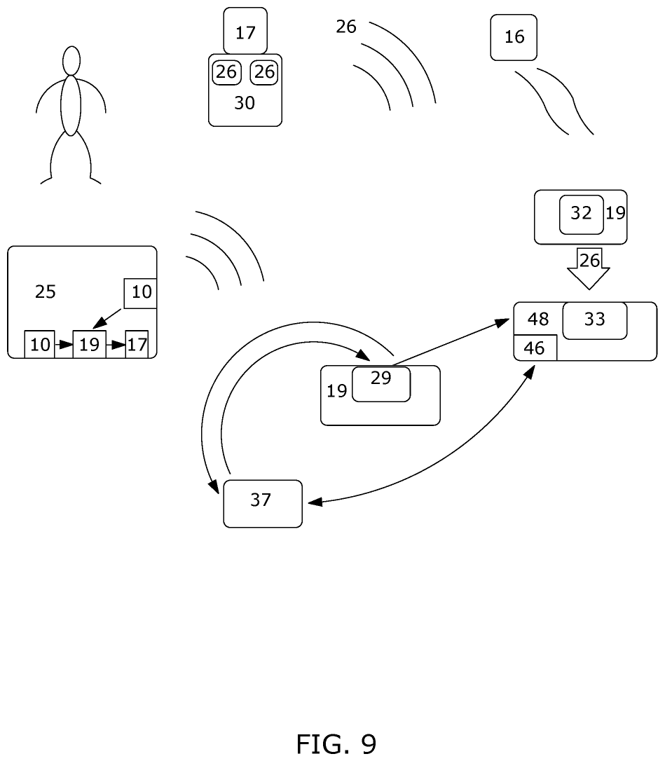

FIG. 9 shows a flow chart of a group of students using pocket ecosystems (25) to take notes about lifeforms of multiple species that are inside the students' pocket ecosystems (25). These notes should ideally include information about the behavior, appearance, and other characteristics of the species that are inside the pocket ecosystems (25) (Such as any information the students can discern about the health of the individual members of those species in the pocket ecosystems (25)). Each student uses a computer, cellular phone, or other computing device (different types of PC (30)) to take the above-mentioned notes in an online report (26). In this version of the invention, the online reports (26) are then each transmitted by a transmitter (17) attached to one of the PCs. A receiver (16) receives the online reports, and then sends them over the internet to a processor (19) on which is running the research processing module (32). The research processing module (32) saves the online reports in a research corpus (33) of text. The online reports will be considered “unstructured” data, because they do not have the structure one would normally expect for data. This is because the formats of the online reports and the types of words that users (Some of whom may be students) will use cannot be predicted. The research corpus (33) is in a memory (48). The processor (19) on which the language processing module (29) is run, is connected to the memory (48). Researchers, including the students, can use the viewing interface (37) to command the language processing module (29) to use text analysis tools to analyze the research corpus and find words that occur together often, and other associations concerning the species in the pocket ecosystems. The results of the language processing module (29)'s text analysis that was commanded by a researcher will be available for that researcher to view, using the viewing interface (37). The users store the results of the text analyses performed by the language processing module (29) in the central observation collection (46), which, in this version of the invention, is stored in the same memory (48) as the research corpus (33). Researchers, including the students who created the online reports (26), can use the viewing interface (37) to view the results of the analysis, which are saved in the central observation collection (46).

The detectors (10) in each pocket ecosystem (25) send the values of the measured parameters inside that pocket ecosystem (25) to the pocket ecosystem's processor (19). The pocket ecosystem's processor sends the pocket ecosystem (25)'s container ID, the time, and the measured parameter values to the transmitter (17) attached to that pocket ecosystem (25). The detectors keep sending the pocket ecosystem's processor (19) updated values for these measured parameters over time, and the pocket ecosystem's processor (19) keeps sending the updated values and pocket ecosystem (25)'s container ID, and the time, to the pocket ecosystem's transmitter. This transmitter (17) will wirelessly transmit the pocket ecosystem's container ID, the time, and the measured parameter values (and keep transmitting their new values as they are updated).

The receiver (16) will receive the measured parameter values, pocket ecosystem's container ID, and the time, and will send them to the research processing module (32), which will save them in the research corpus (33). The research processing module (32) will also associate the measured parameter values, from the beginning of the time an online report was started to the time an online report was finished, with that online report, and will associate the pocket ecosystem's container ID, with the online report.

Students can perform a form of “crowd-science” in this way, by having the language processing module analyze the research notes created by the citizen scientists (The students) to find information about the organisms in the pocket ecosystems.

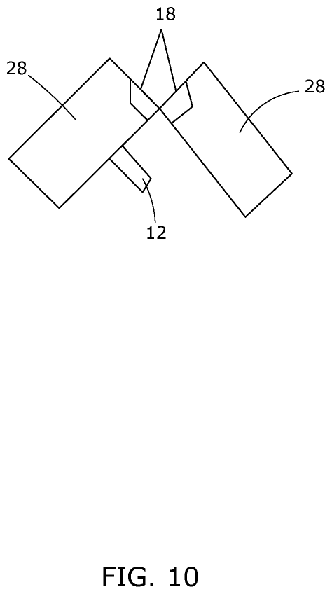

FIG. 10 shows a sectioned container (28) that is shaped like a cube. The sectioned container (28) has two sections, that are open. Inside the sectioned container (28) is a parameter influencer (12). On top of the sectioned container (28) is a linking mechanism (18).

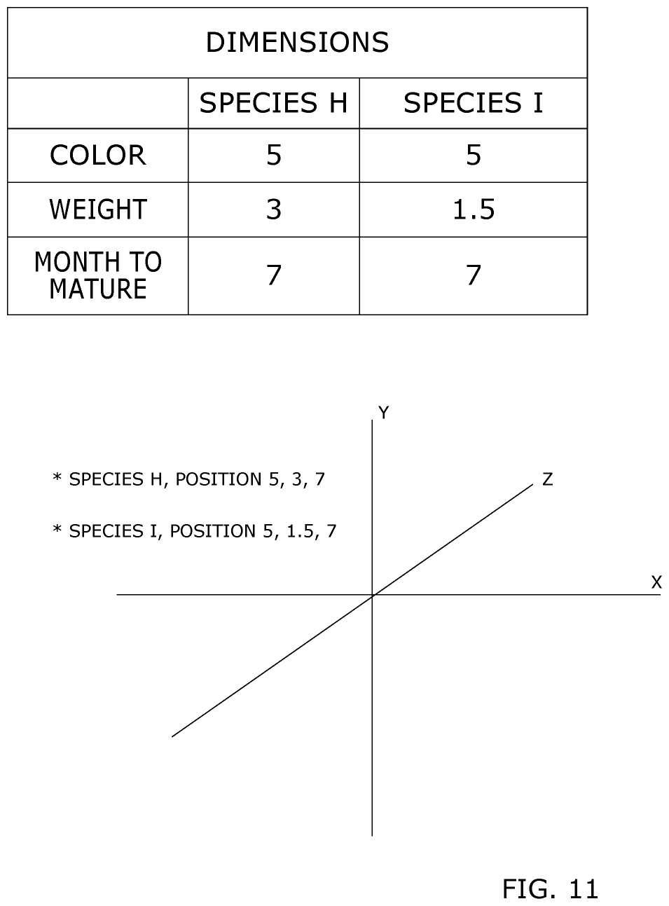

FIG. 11 shows an example of a vector space, being used in one embodiment of the invention to find a measured parameter value combination that is likely to be at or near optimal for a species, for which the optimal measured parameter value combination was not previously known. Species H's position in the latent space has been fixed based on Species H's known physical characteristics (Such as average weight, length, color, etc.), the taxonomic classification of Species H, and analysis of the context words of the name of Species H, and context words of other terms that obviously refer to Species H, to find the most optimal measured parameter value combination for Species H.

The position of related Species I in the latent space, in terms of optimal combination of measured parameters, is being inferred based on the parts of the taxonomic classification of Species I, which it holds in common Species H, and Species I's known characteristics. Species I's position is inferred by “subtracting” the vectors representing Species I's physical characteristics that Species I does not have in common with Species H, and adding vectors representing those physical characteristics for Species I. For example, if the average weight of Species I is half of that of Species H, the vector representing weight for species I will have half the magnitude of the vector representing weight for Species H. If Species H is mostly red and Species I is mostly blue, the physical characteristic vector for “red” will be subtracted from the position of species H and “blue” will be added, to get the initial position of Species I. Later, Species I's correct position will be calculated based on observations of Species I.

If the position of Species H or Species I in the vector space changes later, from the position that has been calculated based on observation, this is an indication that the genetic makeup of that species (Species H or Species I) has changed.

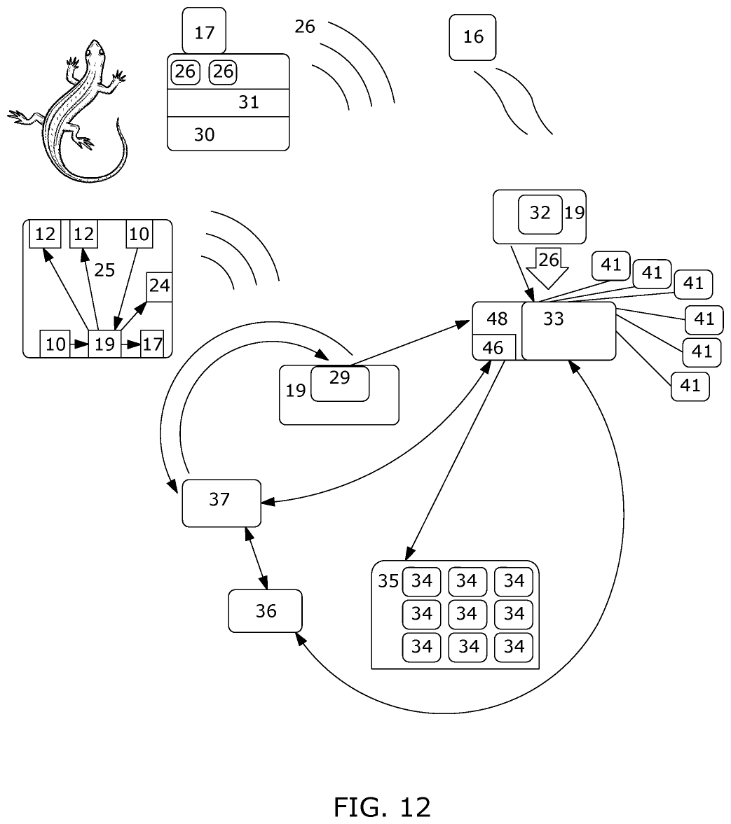

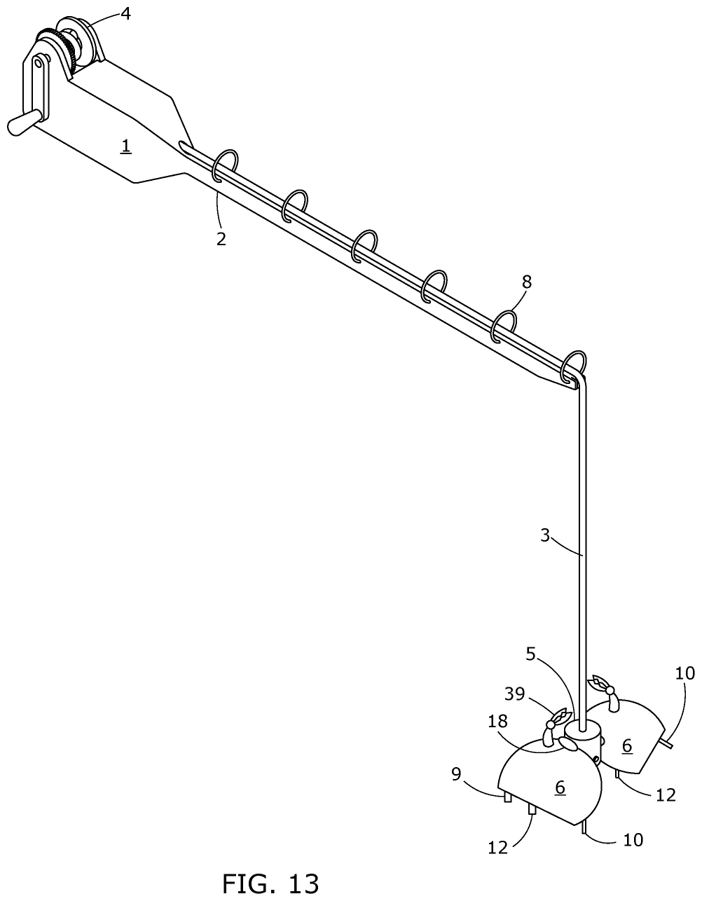

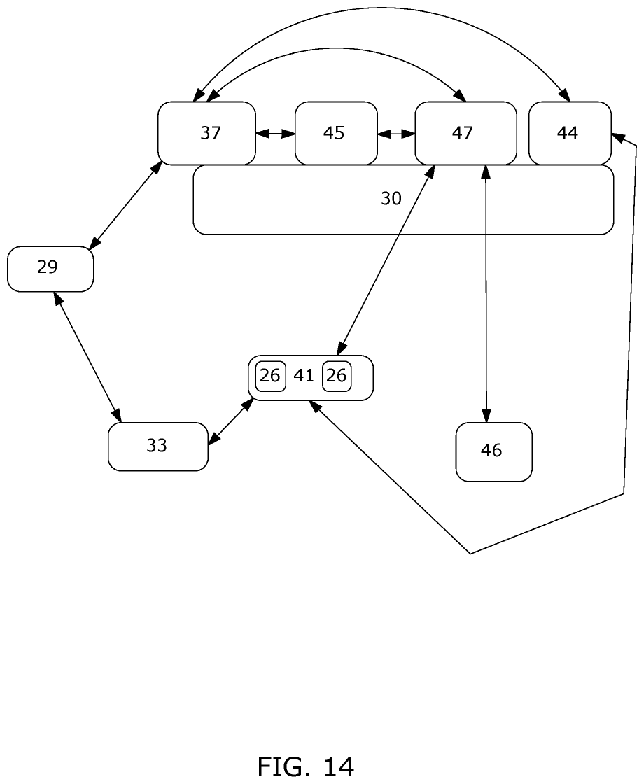

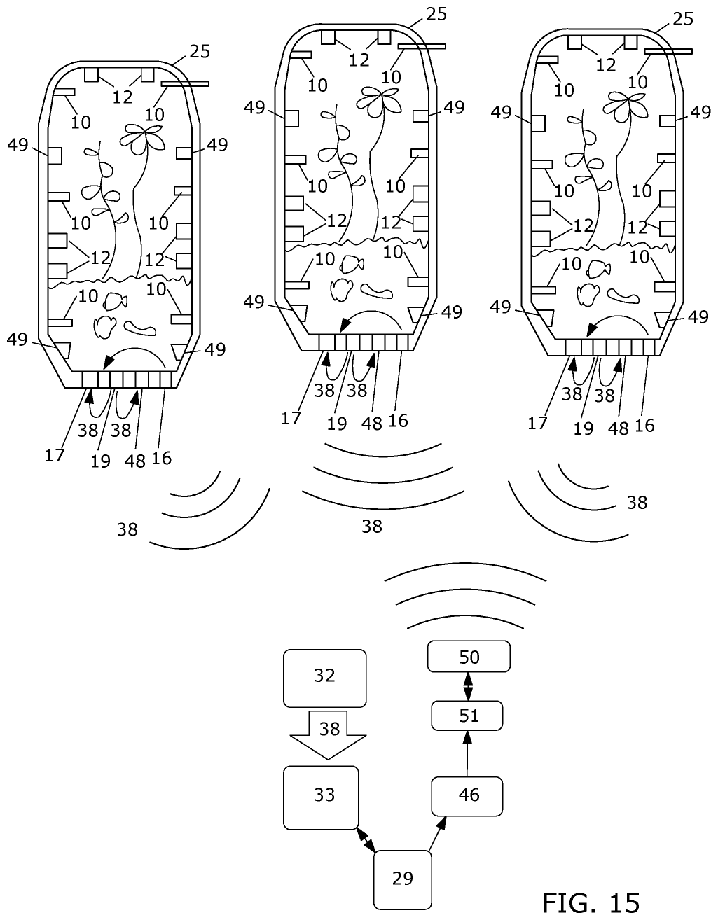

FIG. 12 shows a flow chart of one way that a large group of students going to several different schools can learn about how a species (A salamander species in this case) reacts to measured parameter values changes and different measured parameter value combinations. Each student has a pocket ecosystem (25) equipped with an alert light (24), a transmitter (17), a processor (19) and multiple detectors (10) and multiple parameter influencers (12). The students observe the pocket ecosystems and use note-taking apps (31) on their PCs (30) to create a plurality of online reports (26). Each online report (26) automatically includes the container ID of the pocket ecosystem (25) owned by the student who created that online report (26), and also includes that student's user ID. The online reports (26) are sent, using the students' PCs' internet transmission capabilities, over the internet until the online reports (26) reach the research processing module (32) which is stored on a processor (19). The research processing module (32) stores the online reports (26) in the research corpus (33).

Meanwhile, the detectors (10) in each pocket ecosystem (25) send the values of the measured parameters inside that pocket ecosystem (25) to the pocket ecosystem's processor (19). The processor sends the pocket ecosystem (25)'s container ID, the time, and the measured parameter values to the transmitter (17) attached to that pocket ecosystem (25). The detectors keep sending the pocket ecosystem's processor (19) updated values for these measured parameters over time, and the pocket ecosystem's processor (19) keeps sending the updated values and pocket ecosystem (25)'s container ID, and the time, to the pocket ecosystem's transmitter. This transmitter (17) will wirelessly transmit the pocket ecosystem's container ID, the time, and the measured parameter values (and keep transmitting their new values as they are updated). The time, and the measured parameters' values at that time, and the pocket ecosystem's container ID will be sent over the internet to the research processing module (32). The research processing module (32) will save the measurements of the measured parameter values, and the times those values were measured, for each pocket ecosystem, together with that pocket ecosystem's container ID, in the research corpus (33). The research processing module (32) will also associate the online reports (26) that include each specific pocket ecosystem's container ID with the measurements, made at the same time as the time that online report was started, finished, and the times between, of the measured parameter value measurements of the pocket ecosystem with that pocket ecosystem's container ID.

The language processing module (29) then performs text analysis on the research corpus (33). This text analysis includes, but not limited to, A. Calculating the 5 most common combinations of 8 words each in the research corpus at the present time. B. Calculating and the lift of each of these combinations, and each of the names of multiple specific species listed in the language processing module. The language processing module (29) stores the results of the text analysis in the central observation collection (46) so that other users can view the results of the text analysis. Researchers can view the results of the text analysis, including the 5 most common combinations of 8 words each, and the number for the lift of each of the 8-word combinations and each of the aforementioned species' names, using the viewing interface (37). Researchers can view specific numbers for the lift of each of these combinations, using the viewing interface (37).

The research processing module (32) can also create a subsidiary corpus (41) comprising solely those online reports (26) in the research corpus (33) that have some characteristic in common, such as online reports that came from students at the same school, or that mention a certain species. Here in this example the research processing module (32) has created six subsidiary corpuses (41), each comprising online reports submitted by students in one of six schools.

In this version of the invention, results of the text analysis of the research corpus, stored in the central observation collection (46) are used to create a training data set, which then is used to create a series of weights which are assigned to some of the artificial neurons (35) in the artificial neural network (34). Later on, groups of students will be assigned to do tests, by observing the same species under certain measured parameter value combinations, to find whether the weights assigned to the artificial neurons are correct. If the actual results of the tests differ from the results predicted by the artificial neural network, the weights will be adjusted.

The students' teachers, in this example, can use the viewing interface (37) to command the statistical investigation module (36) to investigate information from the research corpus such as: Which students in a group (The teacher's class) made online reports during a certain time period? When, during the time period, were the online reports made? What percentage of students in the group made online reports during a certain time period? The statistical investigation module will then access the research corpus (33) and make the appropriate calculations to find the information the teacher requested. For example, the statistical investigation module (36) can divide the percentage of students in the group who submitted online reports during a certain month by the total number of students in the group to find the percentage of students in the group who submitted online reports during that month.

Once the statistical investigation module finds this information, it will send the information to the viewing interface, which will display the information for the teacher to view.

FIG. 13 shows a version of an apparatus with a main wire group (3) wound on an external reel (4) and threaded through wire holding rings (8). The external reel (4) is attached to the handle (1). The main wire group extends along the long rod (2). The long rod (2) is attached to the handle (1). The main wire group (3) connects to a container connection device (5). A sectioned container (28) shaped roughly like a ball but with a flat top and bottom is latched to the container connection device (5) by two container latches (39). There is also a linking mechanism (18) attached to the container connection device (5) and the sectioned container (28), which will help the sectioned container to open and close when desired. On the outside of the sectioned container, and on the outside of the handle, are charging ports (20). In this apparatus they are wireless charging ports. Inside the sectioned container (28) is a light (9), and two parameter influencers (12), and two detectors (10).

A transmitter and a receiver, which are too small to be indicated on this drawing, are in the container connection device, close to its bottom, and another transmitter and receiver, which are too small to be indicated on this drawing, are in the sectioned container, close to its top and close to the transmitter and receiver, in the container connection device, respectively.

A processor, which is too small to be indicated on this drawing, is in the sectioned container, and this processor is connected to the transmitter and receiver in the sectioned container, and to the two parameter influencers and two detectors in the sectioned container.

The handle (1) also includes a control panel with 2 digital gauges, and controls. The digital gauges show information that was detected by the detectors in the sectioned container, sent by these detectors to the processor in the sectioned container, and sent by the processor to the transmitter in the sectioned container. Then, this information is transmitted by the transmitter in the sectioned container to the receiver in the container connection device, and sent through the main wire group to another processor (not shown) inside the handle (1), which controls the digital gauges.

Likewise, the user can use the control panel in the handle to, among other things, send commands to the parameter influencers in the container connection device. The commands will be sent from the controls to the processor in the handle, which will then send them along the main wire group (1) to the container connection device (5). The transmitter and receiver in the container connection device are connected to the main wire group. The transmitter will transmit the commands to the receiver in the sectioned container, which will then transmit the commands to the processor in the sectioned container, which will then transmit the commands to the parameter influencers.

FIG. 14 shows an example of a researcher using the local statistical investigation module (44) and local language processing module (45) to analyze some of the information about a certain plant species (Called Species E here) in a subsidiary corpus (41). The researcher uses the viewing interface (37), running on a PC, to access the language processing module (29) and command the language processing module (29) to create, from the research corpus (33), a subsidiary corpus (41) comprising those online reports (26) which the researcher has permission to access completely (In this case, online reports from the researcher's class). The researcher then uses the local language processing module (45), running, in this version of the invention, on the same PC (30) as the viewing interface (37) to perform text analysis on the subsidiary corpus and analyze the text content of the online reports (26) that are saved in the subsidiary corpus (41) for each measured parameter value combination for which at least one online report is available. The viewing interface (37) displays the results of the text analysis to the researcher. The results of the text analysis are saved by the researcher in the local association collection (47) so that the researcher can examine them later more easily. The local association collection is saved, in this version of the invention, on the same PC that is running the viewing interface (37), and the local language processing module (45). The researcher can also theoretically use the viewing interface to view the information in the local observation collection and/or command the local observation collection (47) to send the information in the local observation collection (47) to the central observation collection (46), and to the researchers running the central observation collection (46), and request for that information to be included in the central observation collection (46). The researcher also uses the local statistical investigation module (44) to examine the subsidiary corpus and get information about the distribution of the online reports in the subsidiary corpus (Such as distribution of when the online reports were submitted, and names and user IDs of users who contributed online reports to the subsidiary corpus) and the results are shown to the researcher in the viewing interface (37).

FIG. 15 shows a flow chart of use of an embodiment of the invention where auto-sensors (49) are used to monitor and learn about the lifeforms in a group of pocket ecosystems (25) without human intervention. Each of several pocket ecosystems (25) includes detectors (10), parameter influencers (12), and auto-sensors (49), a transmitter (17), a processor (19), a memory (48), and a receiver (16). Each pocket ecosystem (25) contains lifeforms of several species, and the species of all the lifeforms inside each pocket ecosystem contains are known. The optimal measured parameter ranges for the different species inside each of the pocket ecosystems overlap. The auto-sensors (49) in each pocket ecosystem monitor the lifeforms in that pocket ecosystem, and send the information they have gathered to the processor (19), which saves it in the memory (48). The processor sends automatic reports (38) of what the auto-sensors (49) have observed to the transmitter (17), which then broadcasts them. The processor also saves the automatic reports in the memory (48). The automatic reports are received by the research processing unit (32), which places them in the research corpus (33). The language processing module (29) then performs text analysis on the automatic reports in the research corpus (33), and places the results of the text analysis in the central observation collection (46). Researchers update the central lifeform database (51) based on the new information in the central observation collection (46). The central comparison module (50) then compares the measured parameter values that were received from the pocket ecosystems (25) with the optimal and tolerance ranges of the species inside the pocket ecosystems (25). If the value of one of the measured parameters inside a pocket ecosystem (25) is outside the optimal range for a species with members inside that pocket ecosystem (25), the central comparison module (50) can broadcast a signal, which is received by the transmitter (17) in that pocket ecosystem (25). The transmitter (17) inside the pocket ecosystem (25) sends the signal to the processor (19) inside the pocket ecosystem, which then commands the parameter influencer(s) (12) that influence that measured parameter inside that pocket ecosystem to act, to move that measured parameter's value inside the pocket ecosystem back within the optimal range for that species.

1. An apparatus for controlling lifeforms' environment, said apparatus comprising at least one container, wherein each said container includes at least one detector for a measured parameter and at least one parameter influencer for the same measured parameter, and at least one transmitter and at least one receiver,
said apparatus further comprising that said transmitter is operatively connected to said detectors and said receiver is operatively connected to said parameter influencers,
said apparatus further comprising a faraway program, said faraway program further comprising a comparison module and a lifeform database, where said lifeform database comprises the optimal and tolerance levels of the measured parameters measured by the detectors, for a plurality of lifeform types, and the optimal and tolerance levels of the measured parameters influenced by the parameter influencers, for said plurality of lifeform types,
said apparatus further comprising that said comparison module is able to retrieve the optimal and tolerance levels of the measured parameters influenced by the parameter influencers for lifeform types in the lifeform database from said lifeform database,
said apparatus further comprising that said detectors in each container transmit the values of measured parameters in that container to the transmitters in that container and said transmitters wirelessly transmit the values of measured parameters in that container to said comparison module;
said apparatus further comprising that said comparison module is able to compare the value of at least one measured parameter in said container, measured by a detector in said container, with the optimal and tolerance ranges for that measured parameter for lifeforms of a targeted lifeform type, members of which are within that container, and if the value of one of said compared measured parameters inside said container is outside of said targeted lifeform type's optimal or tolerance range for that measured parameter, said comparison module is able to directly or indirectly send a command to a parameter influencer in said container that influences that measured parameter, commanding said parameter influencer to move the value of that measured parameter within said container to a value closer to, or within, said targeted lifeform type's optimal range or tolerance range, respectively, for that measured parameter,
said apparatus further comprising that then said parameter influencer moves the value of said measured parameter within said container to a value closer to, or within, the targeted lifeform type's optimal range or tolerance range, respectively, of that measured parameter.

2. The apparatus of claim 1, further comprising at least one component, attached to said container, that can also be temporarily attached to another object, thus allowing said container to be temporarily attached to said other object, or detached from said other object when desired by the user.

3. The apparatus of claim 2, said apparatus further comprising an assembly which includes a container connection device, and a handle directly or indirectly connected to said container connection device,
said apparatus further comprising that said component attached to said container, that can also be temporarily attached to another object,
can be attached to, and detached from, said container connection device.

4. The apparatus of claim 3, said apparatus further comprising multiple said containers, each of which is attached to at least one said component that can be temporarily attached to another object, so that one of said components that can be temporarily attached to another object, can be attached to, and detached from, said container connection device, and then another of said components that can be temporarily attached to another object, can be attached to, and detached from, said container connection device.

5. The apparatus of claim 1, said apparatus further comprising a plurality of said containers,
and said apparatus further comprising that said detectors in each said container transmit the values of measured parameters in that container to the transmitters in that container and said transmitters wirelessly transmit the values of measured parameters in that container to said comparison module;
said apparatus further comprising that said comparison module is able to compare the value of at least one measured parameter in said container, measured by a detector in said container, with the optimal and tolerance ranges for that measured parameter for lifeforms of a targeted lifeform type, members of which are within that said container, and if the value of one of said compared measured parameters inside that said container is outside of said targeted lifeform type's optima or tolerance range for that measured parameter, said comparison module is able to directly or indirectly send a command to a parameter influencer in that said container that influences that measured parameter, commanding said parameter influencer to move the value of that measured parameter within said container to a value closer to, or within, said targeted lifeform type's optimal range or tolerance range, respectively, for that measured parameter,
said apparatus further comprising that then said parameter influencer then moves the value of said measured parameter within said container to a value closer to, or within, the targeted lifeform type's optimal range or tolerance range, respectively, of that measured parameter.

6. The apparatus of claim 5, said apparatus further comprising that a plurality of users can access a plurality of faraway programs connected to the same comparison module, which is connected to the same lifeform database;
said apparatus further comprising a means by which each said user can input individual identifiers for one or more of said containers into a PC, and each said user can input an identifier for a targeted lifeform type, members of which are within one of more of said containers for which said user inputted individual identifiers, into said PC, where said PC is in operative communication with said comparison module;
said apparatus further comprising that said means by which each said user can input an identifier for a targeted lifeform type will communicate, and
said individual identifiers for said containers, and the identity of any lifeform type targeted for each container, inputted by said users to said comparison module;
said apparatus further comprising that said comparison module will import the optimal and tolerance ranges for the targeted lifeform types, members of which were identified by said users as being within said one or more containers, from said lifeform database;
said apparatus further comprising that said comparison module can compare the value of at least one measured parameter in the container with each individual identifier, measured by a detector in that said container, with the optimal and tolerance ranges for that measured parameter for lifeforms of a targeted lifeform type, members of which are within that said container, and if the value of one of said measured parameters inside any of said container is outside of the targeted lifeform type optimal or tolerance range for that measured parameter, members of which are within that said container, said comparison module is able to directly or indirectly send a command to a parameter influencer in that said container that influences that measured parameter, commanding said parameter influencer to move the value of that measured parameter within that said container to a value closer to, or within, said targeted lifeform type's optimal range or tolerance range, respectively, for that measured parameter,
said apparatus further comprising that then said parameter influencer moves the value of said measured parameter within that said container to a value closer to, or within, the optimal range or tolerance range, respectively, of that measured parameter for said targeted lifeform type, members of which are within that said container.

7. The apparatus of claim 1, said apparatus further comprising a means for inputting an identifier for a targeted lifeform type, members of which were identified by said user as being within said container, into a PC, where said PC is in operative communication with said comparison module,
said apparatus further comprising that said means for inputting an identifier for a targeted lifeform type will then communicate the identity of said targeted lifeform type to said comparison module;
said apparatus further comprising that said comparison module will then import the optimal and tolerance ranges for the targeted lifeform type, members of which were identified by said user as being within said container, from said lifeform database;
said apparatus further comprising that said comparison module can compare the value of at least one measured parameter in said container, measured by a detector in that said container, with the optimal and tolerance ranges for that measured parameter for lifeforms of a targeted lifeform type, members of which are within said container, and if the value of one of said compared measured parameters inside said container is outside of the optimal or tolerance range for that measured parameter, for the targeted lifeform type, members of which are within said container,
said comparison module is able to directly or indirectly send a command to a parameter influencer in said container that influences that measured parameter, commanding said parameter influencer to move the value of that measured parameter within said container to a value closer to, or within, the optimal range or tolerance range, respectively, for that measured parameter, for said targeted lifeform type, members of which are within said container,
said apparatus further comprising that said parameter influencer then moves the value of said measured parameter within said container to a value closer to, or within, the optimal range or tolerance range, respectively, of that measured parameter for said targeted lifeform type, members of which are within said container.

8. The apparatus of claim 1, said apparatus further comprising at least one of the following, inside one or more of said containers;
a. an air temperature control mechanism that is part of an air temperature parameter influencer inside said container, which is one of said parameter influencers, said air temperature control mechanism further comprising that said air temperature control mechanism can increase or decrease the air temperature within said container, when commanded by said faraway program to increase or decrease the air temperature within said container,
b. a water temperature control mechanism that is part of a water temperature parameter influencer inside said container, which is one of said parameter influencers, said water temperature control mechanism further comprising that said water temperature control mechanism can increase or decrease the water temperature within said container, when commanded by said faraway program to increase or decrease the water temperature within said container,
c. a Ph parameter influencer inside said container, which is one of said parameter influencers, said Ph parameter influencer further comprising that said Ph parameter influencer contains an amount of a compound or solution that can be released into said container to raise the Ph of the water in the container, when said Ph parameter influencer is commanded to release said compound or solution by said faraway program;
d. a Ph parameter influencer inside said container, which is one of said parameter influencers, said Ph parameter influencer further comprising that said Ph parameter influencer contains an amount of a compound or solution that can be released into said container to lower the Ph of the water in the container, when said Ph parameter influencer is commanded to release said compound or solution by said faraway program;
e. a salinity parameter influencer inside said container, which is one of said parameter influencers, said salinity parameter influencer further comprising that said salinity parameter influencer contains an amount of a compound or solution that can be released into said container to lower the salinity level of the water in the container, when said salinity parameter influencer is commanded to release said compound or solution by said faraway program;
f. a salinity parameter influencer inside said container, which is one of said parameter influencers said salinity parameter influencer further comprising that said salinity parameter influencer contains an amount of a compound or solution that can be released into said container to raise the salinity level of the water in the container, when said salinity parameter influencer is commanded to release said compound or solution by said faraway program;
g. a water oxygen level parameter influencer inside said container, said water oxygen parameter influencer further comprising a small air diffuser, or a small aerator, which, when commanded by said faraway program, has the ability to pump air into said container from outside said container;
h. a water oxygen level parameter influencer inside said container, said water oxygen parameter influencer further comprising a small air diffuser, or a small aerator, which, when commanded by said faraway program, has the ability to pump air out of said container from inside said container,
i. a water oxygen level parameter influencer including a pump that, when commanded by said faraway program to pump water into said container from outside said container, pumps water into said container from outside said container, and pumps an equal amount of water outside the container from inside the container,
j. a chlorine parameter influencer inside said container, that, when commanded by said faraway program, releases a solution or compound that dechlorinates water into the water in the container.

9. The apparatus of claim 1, said apparatus further comprising that one or more of said containers is a sectioned container.

10. The apparatus of claim 1, said apparatus further comprising that, inside said container, physically close to at least one detector, is a parameter influencer that influences the same measured parameter that is detected by said detector,
said apparatus further comprising that said parameter influencer physically close to the detector has a unique identifier, and said detector physically close to the parameter influencer has a unique identifier;
said apparatus further comprising that the unique identifier of the detector physically close to the parameter influencer and the unique identifier of the parameter influencer physically close to the detector are related, so that one of said two unique identifiers can be determined from the other of said two unique identifiers,
said apparatus further comprising that the wireless transmissions of the measured parameter values detected by said detector, include a unique identifier for the detector,
said apparatus further comprising that if the value of one of said compared measured parameters detected by said detector physically close to the parameter influencer is outside of the optimal or tolerance range for that measured parameter, for the targeted lifeform type, said comparison module is able to directly or indirectly send a command to the parameter influencer that influences that measured parameter, and that is physically close to the detector, and is in said container, commanding said parameter influencer to move the value of that measured parameter within the part of said container where said detector can detect said measured parameter to a value closer to, or within, said targeted lifeform type's optimal range or tolerance range, respectively, for that measured parameter,
said apparatus further comprising that then said parameter influencer moves the value of said measured parameter within the part of said container where said detector can detect said measured parameter to a value closer to, or within, said targeted lifeform type's optimal range or tolerance range, respectively, of that measured parameter.

11. The apparatus of claim 1, said apparatus further comprising that said comparison module is a central comparison module, and that said lifeform database is a central lifeform database, said apparatus further comprising that the faraway program includes a user interface operating on a user's PC, which is in operative communication with said central comparison module.

12. The apparatus of claim 11, further comprising that said central lifeform database receives and saves the optimal and tolerance ranges for measured parameters for additional lifeform types for which the central lifeform database did not previously include optimal or tolerance ranges, and updated optimal and tolerance ranges for measured parameters for lifeform types for which the central lifeform database previously included optimal or tolerance ranges.

13. The apparatus of claim 11, said apparatus further including that said wireless transmissions from said transmitter can be received by all user interfaces running on PCs that are capable of directly receiving wireless transmissions from said transmitter,
said apparatus further comprising that all user interfaces running on PCs that are capable of directly receiving wireless transmissions from said transmitter can display the measured parameter values inside said container.

14. The apparatus of claim 1, said apparatus further comprising that said lifeform database receives and then includes the optimal and tolerance ranges for measured parameters for additional lifeform types for which the lifeform database did not previously include optimal or tolerance ranges, and updated optimal and tolerance ranges for measured parameters for lifeform types for which the lifeform database previously included optimal or tolerance ranges.

15. The apparatus of claim 1, said apparatus further comprising that at least one measured parameter's average value in part or all of said targeted lifeform type species' natural range has been changed because of climate change,
said apparatus further comprising that members of said targeted lifeform type are placed within said container to allow said members of said targeted lifeform type to live outside of their natural habitat.

16. The apparatus of claim 1, said apparatus further comprising that, said lifeform database includes at least one measured parameter range which is a goal range for a specified goal for one or more of said plurality of lifeform types,
said apparatus further comprising that said faraway program includes a means by which the user may select an identifier for a lifeform type, members of which are within said container,
said apparatus further comprising that said means by which a user may select an identifier for a lifeform type directly or indirectly communicates the identifier for the lifeform type to said comparison module,
said apparatus further comprising that said lifeform database comprises the goal levels of the measured parameters influenced by the parameter influencers, for at least one lifeform type from said plurality of lifeform types,
said apparatus further comprising that said comparison module is able to retrieve the goal levels of the measured parameters influenced by the parameter influencers for at least one lifeform type in the lifeform database from said lifeform database,
said apparatus further comprising that said comparison module is able to compare the value of at least one measured parameter in said container, measured by a detector in said container, with the optimal and tolerance ranges for that measured parameter for lifeforms of a targeted lifeform type, members of which are within that container, and if the value of one of said compared measured parameters inside said container is outside of the optimal or tolerance range for that compared measured parameter, for said targeted lifeform type, said comparison module is able to directly or indirectly send a command to a parameter influencer in said container that influences that measured parameter, commanding said parameter influencer to move the value of that measured parameter within said container to a value closer to, or within, said goal range for said targeted lifeform type for that measured parameter,
said apparatus further comprising that then said parameter influencer moves said measured parameter's value within said container to a value closer to, or within, said goal range for said targeted lifeform type for that measured parameter.

17. The apparatus of claim 1, said apparatus further comprising that at least one auto-sensor;
and at least one processor operatively connected to said auto-sensor;
said apparatus further comprising that said processor is operatively connected to said transmitter;
said apparatus further comprising that said auto-sensor is able to send information that said auto-sensor detected to said processor;
and said apparatus further comprising that said processor is programmed to create automatic report from information that said auto-sensor sends to said processor;
said apparatus further comprising that said processor sends said automatic reports to said transmitter,
said apparatus further comprising that said transmitter wirelessly broadcasts said automatic reports;
said apparatus further comprising a computer program module, which receives said automatic reports and stores said automatic reports in a corpus,
said apparatus further comprising a second compute program module, which uses statistical analysis on the data included in said automatic reports to generate conclusions about which measured parameter value combinations are correlated to one or more categories of automatic reports;
said apparatus further comprising that said second computer program module updates the optimal and tolerance rage in said lifeform database to updated optimal and tolerance rage based on said conclusions,
and said apparatus further comprising that said comparison module thereafter compares the measured parameter values that said comparison module receives from said transmitter to said updated measured parameter values.

18. A method of protecting the wellbeing of lifeforms in containers,
said method comprising keeping said lifeforms in at least one container, wherein each said container includes at least one detector for a measured parameter and at least one parameter influencer each measured parameter for which there is a detector, and at least one transmitter and at least one receiver,
where said transmitter is operatively connected to said detectors and said receiver is operatively connected to said parameter influencers,
said method further comprising providing a a comparison module and a lifeform database, where said
lifeform database comprises the optimal and tolerance levels of the measured parameters measured by the detectors, for a plurality of lifeform types, and the optimal and tolerance levels of the measured parameters influenced by the parameter influencers, for the lifeform types in said plurality of lifeform types,
said method further comprising that said comparison module is able to retrieve the optimal and tolerance levels of the measured parameters influenced by the parameter influencers for lifeform types in the lifeform database from said lifeform database,
said method further comprising that each said detector in each container transmit the values of at least one measured parameter in that container to at least one transmitter in that container and said transmitters wirelessly transmit the values of measured parameters in that container that said transmitters have received to said comparison module;
said method further comprising that said comparison module compares the value of at least one measured parameter in said container, measured by a detector in said container, with the optimal and tolerance ranges for that measured parameter for lifeforms of a lifeform type, members of which are within that container, and if the value of one of said compared measured parameters inside said container is outside of the optimal or tolerance range for that measured parameter, for said lifeform type, said comparison module sends a command to a parameter influencer in said container that influences that measured parameter, commanding said parameter influencer to move the value of that measured parameter within said container to a value closer to, or within, said lifeform type's optimal range or tolerance range, respectively, for that measured parameter,
said method further comprising that then said parameter influencer moves the value of said measured parameter within said container to a value closer to, or within, said lifeform type's optimal range or tolerance range, respectively, for that measured parameter,
and said method further comprising that said lifeform database receives and then includes the optimal and tolerance rans for measured parameters for additional lifeform types for which the lifeform database did not previously include optimal or tolerance ranges, and updated optimal and tolerance ranges for measured parameters for lifeform types for which the lifeform database previously included optimal or tolerance rage.

19. The method of claim 18, said method further comprising that members of said targeted lifeform type inside said container are placed within said container to allow said individuals of said targeted lifeform type to live outside of their natural habitat in measured parameter value combinations that are optimal or tolerable for said individuals of said targeted lifeform type.

20. The method of claim 19, said method further comprising that said method is a means for providing a habitat for members of said lifeform type when climate change has caused the average value of at least one measured parameter, in part or all of said targeted lifeform type's natural habitat, to change, causing part or all of said targeted lifeform type's natural habitat to become less habitable to members of said lifeform type.

21. The method of claim 18, said method further comprising providing, attached to said container, at least one component that can also be temporarily attached to another object, thus allowing said container to be temporarily attached to said other object, or detached from said other object when desired by the user.

22. The method of claim 21, said method further comprising providing multiple said containers, each of which is attached to at least one said component that can be temporarily attached to another object, so that one of said components that can be temporarily attached to another object, can be attached to, and detached from, said container connection device, and then another of said components that can be temporarily attached to another object, can be attached to, and detached from, said container connection device.

23. The method of claim 18, said method further comprising providing a means for inputting a lifeform type identifier for a targeted lifeform type, members of which were identified by said user as being within said container, into a PC, where said PC is in operative communication with said comparison module;
said method further comprising that said lifeform database is programmed with one or more of a) goal ranges for specific goals, for measured parameters, for specific lifeform types, b) goal range combinations for specific goals, for measured parameters, for specific lifeform types, or c) goal ranges and goal range combinations for specific goals, for measured parameters, for one or more specific lifeform types,
said method further comprising providing a means, using a PC, for selecting one or more of any known goal ranges and goal range combinations, for said targeted lifeform type,
said method further comprising providing that said means for inputting a targeted lifeform type identifier will then directly or indirectly communicate the identity of said targeted lifeform type, to said comparison module;
and said method further comprising providing that said means for selecting one or more of any known goal ranges and goal range combinations, for said targeted lifeform type will then directly or indirectly communicate said selected goal ranges and goal range combinations for said targeted lifeform type to said comparison module;
said apparatus further comprising that said comparison module will then import the optimal and tolerance ranges and any selected goal ranges and goal range combinations for the targeted lifeform type, which said lifeform type identifier identifies, from said lifeform database;
said method further comprising that said comparison module compares the value of at least one measured parameter in said container, measured by a detector in that said container, with the optimal and tolerance ranges and any selected goal ranges, and any goal ranges within any selected goal range combinations, for that measured parameter for lifeforms of a targeted lifeform type, which said lifeform type identifier identifies, and if the value of one of said compared measured parameters inside said container is outside of said tolerance range, said selected goal range, the goal range within said selected goal range combination or said optimal range if said optimal range is within any said elected goal range or the goal range within said selected goal range combination, for that measured parameter, for the targeted lifeform type, which said lifeform type identifier identifies, said comparison module directly or indirectly sends a command to a parameter influencer in said container that influences that measured parameter, commanding said parameter influencer to move the value of that measured parameter within said container to a value closer to, or within, the optimal range or tolerance range, any selected goal range, the goal range within said selected goal range combination or the optimal range if the optimal range is within any selected goal range, or the goal range within said selected goal range combination, respectively, for that measured parameter, for said targeted lifeform type, which said lifeform type identifier identifies,
said method further comprising that said parameter influencer then moves the value of said measured parameter within said container to a value closer to, or within, the range which said parameter influencer was commanded to move the value of that measured parameter closer to, or within, among the optimal range, tolerance range, any selected goal range, the goal range within said selected goal range combination or the optimal range if the optimal range is within any selected goal range, or the goal range within said selected goal range combination, respectively, of that measured parameter for said targeted lifeform type.

24. The method of claim 18, said method further comprising that said lifeform database has the capability to be programmed with one or more of a) goal ranges for specific goals, for measured parameters, for specific lifeform types, b) goal range combinations for specific goals, for measured parameters, for specific lifeform types, or c) goal ranges and goal range combinations for specific goals, for measured parameters, for one or more specific lifeform types,
said method further comprising that said lifeform database is programmed with one or more of a) goal ranges for specific goals, for measured parameters, for specific lifeform types, b) goal range combinations for specific goals, for measured parameters, for specific lifeform types, or c) goal ranges and goal range combinations for specific goals, for measured parameters, for one or more specific lifeform types,
and said method further comprising providing a means for inputting into a PC, that is in operative communication with said comparison module, identifiers for multiple targeted lifeform types, that said user wishes to identify as being within said container,
said method further comprising providing a means for selecting goals relating to multiple said targeted lifeform types, for which said user inputted identifiers into said PC;
said method further comprising providing that said means for inputting identifiers for multiple targeted lifeform type will then communicate the identities of said targeted lifeform types to said comparison module, and said means for selecting goals relating to said targeted lifeform types will then communicate any selected goals related to said targeted lifeform types to said comparison module;
said method further comprising that said comparison module will then import from said lifeform database the optimal and tolerance ranges for each targeted lifeform type, for which an identifier was inputted into said PC by said user, and said comparison module will also import from said lifeform database each goal range and goal range combination for each selected goal related to any of said targeted lifeform types;
said method further comprising that, for each measured parameter, said comparison module will then identify any parts in common of
a) the optimal ranges that said comparison module has retrieved from said lifeform database for all said targeted lifeform types; and
b) the tolerance ranges that said comparison module has retrieved from said lifeform database for all said targeted lifeform types; and
c) the goal ranges, including goal ranges within goal range combinations, that said comparison module has retrieved from said lifeform database for all said targeted lifeform types;
and said comparison module will then select, for each measured parameter, a set of the parts in common of said optimal, tolerance, and selected goal ranges for all said targeted lifeform types, and said method further comprising that if the value of one of said compared measured parameters inside said container is outside of said set of the parts in common of said optimal, tolerance, and selected goal ranges for any of said targeted lifeform types, said comparison module directly or indirectly sends a command to a parameter influencer in said container that influences that measured parameter, commanding said parameter influencer to move the value of that measured parameter within said container to a value closer to, or within, said set of the parts in common of said optimal, tolerance, and selected goal ranges for said targeted lifeform types.

25. The method of claim 18, said method further comprising that some or all of the updated optimal and tolerance levels in said lifeform database are updated based on feedback that said lifeform database directly or indirectly receives from the one or more transmitters in said container.

26. The method of claim 18, said method further comprising making one or more of said containers available to each of multiple users,
said method further comprising providing, to each of said users, a means for inputting an individual identifier for each said container, and, associated with said individual identifier for each said container, an identifier for a targeted lifeform type, at least one member of which will be within that said container,
said method further comprising that each said identifier for a container, and each said identifier for a targeted lifeform type, at least one member of which will be within that said container, are transmitted to said comparison module;
said method further comprising that each detector in each container transmits the value of at least one measured parameter in that container to a transmitter in that container and said transmitters wirelessly transmit the values of measured parameters that said transmitters have received to said comparison module;
said method further comprising that said comparison module retrieves the optimal and tolerance levels of the measured parameters influenced by the parameter influencers in each said container, for each lifeform type for which a user has inputted an identifier, from said lifeform database,
said method further comprising that said comparison module compares the value of at least one measured parameter in each said container, measured by a detector in that said container, with the optimal and tolerance ranges for that measured parameter for lifeforms of the lifeform type, for which a user inputted the identifier for that lifeform type associated with the identifier for that said container, and if the value of one of said compared measured parameters inside that said container is outside of the optimal or tolerance range for that measured parameter, for the lifeform type for which a user has associated identifier, said comparison module sends a command to a parameter influencer in said container that influences that measured parameter, commanding said parameter influencer to move the value of that measured parameter within said container to a value closer to, or within, said lifeform type's optimal range or tolerance range, respectively, for that measured parameter,
said method further comprising that then said parameter influencer moves the value of said measured parameter within said container to a value closer to, or within, said lifeform type's optimal range or tolerance range, respectively, for that measured parameter.

27. The method of claim 18, said method further comprising data for inputs and the use of artificial neural network.

28. The method of claim 18, said method further comprising data for inputs and the Use of artificial neural network with text data gathered by users.

29. A plurality of containers, containing detectors and transmitters, detectors operatively connected to transmitters, where transmitters broadcast the measured parameter levels measured by the detectors, where research processing module saves measured parameter values in research database where the transmitters in the containers broadcast the plurality of online programs loaded on PCs, the online programs send info in online reports, a research processing module, a research database, where measured parameter values from each container are associated with online reports from that container, a language processing module that can do text analysis on the research processing database, and track text in research processing database against measured parameter values and combinations, a means of language processing module being commanded, and a means of displaying the results.

30. The method of claim 29, said method further comprising that the results are turned into numbers, and sent through an artificial neural network, and estimates of how much mp value changes in combination with other MP values or changes are made based on results of artificial neural network.
